(19) United States
(12) Patent Application Publication
(10) Pub. No.: US 2018/0343024 A1
(43) Pub. Date: Nov. 29, 2018

(54) PORTABLE ELECTRONIC DEVICE

(71) Applicant: Yodel Technologies Inc., West Vancouver (CA)

(72) Inventors: Daryoush Sahebjavaher, Vancouver (CA); Ramin Sahebjavaher, Vancouver (CA)

(21) Appl. No.: 15/777,923

(22) PCT Filed: Nov. 21, 2016
(86) PCT No.: PCT/CA2016/051360

§ 371 Date: May 22, 2018

Related U.S. Application Data
(60) Provisional application No. 62/260,249, filed on Nov. 26, 2015.

(51) Int. Cl. H04B 1/3827; H04M 1/02; H04M 1/18; H04M 1/725

(52) U.S. Cl. CPC H04B 1/385; H04M 1/7253; H04M 1/18; H04M 1/0202

(57) ABSTRACT

A portable electronic device comprising a housing with one or more buttons, sensors and a processor circuit, the housing configured to detachably attach to an item of apparel or another object and the processor circuit configured to receive input from the one or more buttons and sensors, and provide predetermined functionality in response to the input received from the one or more buttons and sensors.

### FIELD

This disclosure relates generally to the field of portable electronic devices and mobile devices.

### BACKGROUND

Mobile devices such as cell phones, smartphones, PDAs (Personal Digital Assistant) or music players, are increasingly used in outdoor and sports environments. These are often used in conjunction with headphones, and other accessories—including wearable technology—to perform functionalities such as hands-free calling, listening and skipping music tracks and monitoring athletic performance. In winter activities, such as skiing, a user typically secures their mobile device in a deep dry pocket of a jacket or pants, and wears winter gloves during the activity. When the user needs access to a typical mobile phone, they have to take their gloves off and reach into their pocket or awkwardly attempt to use the phone with their gloves which can be difficult if not impossible to do well. This is not only inconvenient for the user but comes at a risk of getting their phone wet causing water damage or the user losing their grip on the phone. In addition, mobile devices such as phones and tablets are inconvenient to access during winter activities, especially while performing sports such as snowboarding, skiing, snowmobiling, ice climbing, snowshoeing, winter canoeing, kiting and alike.

### SUMMARY

In accordance with one aspect, there is provided a wearable portable electronic device comprising:
(a) a housing configured to detachably attach to an item of apparel or another object, the housing comprising one or more buttons for user interaction, the one or more buttons being shaped, sized and positioned on the housing to facilitate user interaction with the portable electronic device while the housing is attached to the item of apparel or another object and the user is using a glove-enclosed hand to interact with and provide input via the buttons; and
(b) a processor circuit contained within the housing, the processor circuit configured to: (i) receive input from the one or more buttons; and (ii) provide predetermined functionality in response to the input received from the user, the processor circuit configured to facilitate the predetermined functionality in response to user interaction with the one or more buttons.

In accordance with one aspect, there is provided a wearable portable electronic device comprising:
(a) a housing configured to detachably attach to an item of apparel or another object, the housing comprising one or more sensors and one or more buttons for user interaction, the one or more buttons being shaped, sized and positioned on the housing to facilitate user interaction with the portable electronic device while the housing is attached to the item of apparel or another object and the user is using a glove-enclosed hand to interact with and provide input via the buttons; and
(b) a processor circuit contained within the housing, the processor circuit configured to: (i) receive input from the one or more buttons and sensors; and (ii) provide predetermined functionality in response to the input received from the user or the one or more sensors, the processor circuit configured to facilitate the predetermined functionality in response to user interaction with the one or more buttons or one or more sensors.

In various embodiments, the wearable portable electronic device may operably communicate with a mobile device situated separate and apart from the wearable portable electronic device but within communications range of the wearable portable electronic device.

In various embodiments, the portable electronic device may wirelessly communicate with a mobile device in proximity and facilitate the user to remotely control predetermined functionalities on the mobile device. In various embodiments, the wireless connection may be based on one or more wireless technologies: Bluetooth®, WiFi or another wireless technology.

In various embodiments, the predetermined functionality provided by the processor circuit may comprise controlling one or more applications on the mobile device.

In various embodiments, the portable electronic device may wirelessly communicate with an external device in proximity and facilitate the user to remotely control predetermined functionalities on the external device. In various embodiments, the wireless connection may be based on one or more wireless technologies: Bluetooth®, WiFi, Cellular or another wireless technology.

In various embodiments, the predetermined functionality provided by the processor circuit may comprise controlling one or more applications on the external device.

The processor circuit may be configured to control select functionality on the mobile device or the wearable device in response to at least one of the following:
(a) user interaction with the one or more physical input devices (e.g., button, knob);
(b) motion gestures by the user (e.g. accelerometer);
(c) movement by the user (e.g., global positioning system);
(d) user interaction with the touch screen (e.g., capacitive touch pad);
(e) user interaction with the proximity sensor (e.g., magnetic sensor);
(f) user interaction with one or more sensors supported by the portable electronic device (e.g., altimeter, humidity, infrared, or microphone); and
(g) user interaction with one or more sensors supported by mobile device (e.g., accelerometer, microphone, or GPS).

In various embodiments, the wearable portable electronic device may be configured to perform predetermined functionality provided by the processor circuit controlling at least one of:
(a) call functionality on the mobile device;
(b) remote control of media functionality on the mobile device;
(c) push-to-talk over cellular communications (PTT) on the mobile device;
(d) control applications on the mobile device;
(e) navigation functionality on the mobile device;
(f) friend-tracking functionality on the mobile device;
(g) radio frequency identification (RFID) functionality on the wearable device.
(h) voice control on the mobile device;
(i) text message functionality on the mobile device;
(j) over the air software update functionality on the wearable device;
(k) programmable button functionality on the wearable device;
(l) acquire various sensor data on the wearable device or the mobile device, and transfer the data between the wearable device and mobile device facilitated by a wired or wireless connection;
(m) hands-free PTT functionality on the mobile device;
(n) time functionality on the mobile device or wearable device; and
(o) notification functionality on the wearable device.

In various embodiments there is provided a universal attachment mechanism configured to detachably couple the portable electronic device to a user's garment or winter garment, belongings or object—examples include a glove, jacket, helmet, snowboard, ski pole, or snowmobile. In various embodiments, a strap may be detachably coupled to the portable electronic device and may be handled by the user while wearing gloves and winter garments. In various embodiments, the universal attachment mechanism may be configured to facilitate the following without the need of the user to remove their glove(s) using a single hand: wear the portable electronic device, adjust the position and orientation of the portable electronic device, adjust the grip strength of the attachment, and unhook a strap portion of the universal attachment to remove the portable electronic device.

In various embodiments, the portable electronic device may be configured to detachably couple or connect to a user's current equipment or apparel eliminating the need for purchasing an item the user already owns. In such cases, as winter garments such as gloves and jackets are replaced every few years, the user would be able to re-use portable electronic device on the replacement garments.

In various embodiments, the portable electronic device may be configured by a user to detachably couple to a preferred position on winter garments, equipment, belongings or objects. This facilitates the portable electronic device to be used in different winter activities or under different environmental or activity-based conditions. In one exemplary embodiment a user that may be snowboarding may prefer to wear the portable electronic device on their glove at wrist position while another user who is snowmobiling may prefer the device to be secured on the handlebar of their snowmobile.

In various embodiments, the portable electronic device or an associated universal attachment mechanism may be shaped to form a cavity at a bottom or lower portion to contain (and rest on top of) a glove's buckle, allowing the portable electronic device to be secured onto the wrist position of the glove and be comfortable for the user wearing it.

Push-to-talk over cellular or PTT is an existing communication technology that facilitates two or more individuals to communicate with each other supported by connected devices over the wireless data network (e.g. cellular or WiFi). Currently, PTT facilitates users to communicate using their mobile devices similar to a multi-way radio with a range limited only by cellular coverage provided by a commercial cellular network or other wireless network. A typical PTT provides near instant communication for a talk group. Users can download and run commercially available PTT applications (e.g., Twisted Pair, Wave, Voxer, Talko, Zello or the like) on their mobile phone to enable their mobile phone to support PTT.

Wearing winter gloves may significantly reduce the sense of touch and the ability to press small buttons. In various embodiments, the portable electronic device may include a large user interface that features large buttons and generous spacing between the buttons to facilitate easy operation while wearing gloves. In various embodiments, this facilitates the user to more readily perform a variety of functionalities such as switching between music tracks, adjusting audio volume, performing PTT or calling a friend during an outdoor winter activity. In various embodiments, the portable electronic device may include features on a user interface or buttons to facilitate a tactile feel while wearing gloves to allow a user to generally sense where the buttons are without looking at the portable electronic device.

In various embodiments, the portable electronic device may be configured for outdoor environments including but not limited to use in the rain, snow, high-moisture or cold or extreme cold temperature conditions. In this specification temperatures below about −15 degrees Celsius are treated as extreme low temperatures about −30 degrees Celsius. In various embodiments, a housing of the portable electronic device may be partially or fully waterproof preventing water or moisture ingress such that it may operate in wet and humid environments.

In various embodiments, the portable electronic device may be configured to be rugged and highly tolerant to shock and vibration forces expected in a winter activity such as snowboarding, skiing, ice climbing and the like.

In various embodiments, the portable electronic device is configured to allow a user to have access to their mobile device functionalities while comfortably wearing their glove(s) as they are performing an outdoor winter activity. In such embodiments, the user can secure their mobile device in a safe and dry location such as a jacket Pocket while performing the previously mentioned activities and functionalities via the portable electronic device that is in communication with the mobile device.

In various embodiments, the portable electronic device may wirelessly communicate with a mobile device in proximity and facilitate the user to remotely control a push-to-talk over cellular (PTT) functionality. In various embodiments, a push-to-talk over cellular (PTT) functionality on the portable electronic device may be configured to facilitate users to communicate using their mobile devices similar to a multi-way radio with a range limited only by cellular coverage provided by a commercial cellular network or another wireless network. The portable electronic device may facilitate communication via PTT with a second individual or a group of individuals with the push of a single or plurality of accessible buttons. In various embodiments, instant or near-instant communication via PTT may be supported. This may allow users to have a casual conversation without having to remove their glove(s) thus making group communication more immediate with a push of button(s), even when the user is wearing bulky gloves or other types of gloves that make conventional use of smartphones or other mobile devices difficult when such gloves are worn. In various embodiments, the portable electronic device can facilitate hands-free PTT via proximity detection, gesture recognition or a combination of both—thus, the user may not need to press any buttons to activate to deactivate PTT function. In various embodiments the portable electronic device can recognize a pre-defined gesture or set of gestures (e.g., one motion or a series of motions) to turn the PTT on, allowing a user to communicate via PTT without the need to touch or press a button. In various embodiments the portable electronic device may include a proximity detection system that activates the PTT functionality when a proximity actuator is within a predetermined range, allowing a user to communicate via PTT without the need to touch a button. This can help facilitate casual and effortless communication experience.

In various embodiments, the portable electronic device may facilitate effortless and casual communication over Push-to-talk over cellular (PTT). In various embodiment the PTT provides for a single person to reach an individual or group of individuals with a single button press; thus, the users would not need to make several phone calls to coordinate with a group. It is common for a plurality of people to perform outdoor winter activities together and communicate with one another. PTT performs a function similar to portable multi-way radios, where with the press of a button, a user can broadcast a message to a group of individuals. Various embodiments facilitate communication via PTT while a user is wearing winter gloves, promoting a generally immediate, effortless and casual conversation. Since PTT may be available via wireless data cellular network (including WiFi and other wireless technologies), users can generally communicate anywhere in the world with a data cellular connection. If the network connection is unavailable due to coverage or network failure, the messages may be stored on the portable electronic device, a remote server or user's phone and transmitted once the network connection is re-established.

In various embodiments the portable electronic device may be configured to facilitate hands-free PTT. In such cases, the portable electronic device can recognize a predetermined gesture or set of gestures that activate PTT thus allowing a user to communicate via PTT without the need to touch a button. A proximity detection system may be provided that turns the PTT on when a proximity actuator (may be situated separate from the portable electronic device and worn by the user, on the user's apparel, or on another object) is within a predetermined range (e.g., 10 cm) of the portable electronic device, allowing a user to communicate via PTT without the need to touch a button. When a user wishes to communicate via hands-free PTT, he or she can move the portable electronic device in close proximity (e.g., less than 10 cm) of the proximity actuator and start communicating by speaking into the microphone. When the user is finished communicating, he or she can turn the PTT functionality off by moving the device away from the proximity actuator (e.g., more than 10 cm). For example, in various embodiments the portable electronic device can be configured such that the PTT functionality is activated when the user positions portable electronic device close to their mouth (e.g. within a predetermined distance of a proximity actuator).

In various other embodiments, the portable electronic device may be configured to route audio through its internal microphone, its internal speaker, a mobile device's internal speaker, a mobile device's internal microphone, or mobile device audio accessories. The portable electronic device may route audio to and from any headphone, earphone, headset or speaker that is connected to the mobile device by wire or wirelessly.

In various embodiments, the portable electronic device may wirelessly communicate with a mobile device and allow a user to remotely control the mobile device's media functionality. For example, in such embodiments the user may be listening to music via headphones connected to a mobile device and utilize the portable electronic device to remotely switch tracks or adjust volume.

In various embodiments, the portable electronic device may facilitate the user to remotely perform phone functionalities such as making a call, answering a call, rejecting a call, speed-dialing or selecting and calling a phone contact.

In various other embodiments, the portable electronic device may be configured to route audio through its internal microphone, its internal speaker, a mobile device's internal speaker, a mobile device's internal microphone, or audio accessories connected to mobile device. For example, in such embodiments the user may listen to music via earphones connected to their mobile device; perform a PTT conversation via the portable electronic device's internal microphone and speaker; or have a phone call conversation utilizing the portable electronic device's internal microphone, and a speaker connected to the mobile device.

In various embodiments, the portable electronic device may be configured to detect and keep track of the user's location. In such embodiment, this information may be used to inform the user whether they are on their predetermined path. Furthermore, the portable electronic device may inform the user which way to travel to reach a predetermined target location. This functionality may depend on the global positioning system (GPS) integrated either on the user's mobile phone or inside the portable electronic device.

In various embodiments, the portable electronic device may be configured to support friend-tracking capability and may facilitate a user to follow the same path an individual or a group are traveling on. In an exemplary embodiment the portable electronic device may inform the user which way to travel to reach their friend who is further ahead on a path who just turned left. In various embodiments, the device can facilitate informing distance between two or more users.

In various embodiments, the portable electronic device may be configured to facilitate radio frequency identification (RFID) capability that facilitates convenient short-range communication between electronic devices. In one exemplary embodiment, such capability may be used for access control (e.g., opening gate). In such embodiment the user can be uniquely identified using the information transmitted to an RFID activated gate (e.g., chairlift) that may in turn open the gate if access is granted.

In one embodiment the RFID capability may be used for facilitating payment processing. In such embodiment when the user brings the portable electronic device within range of the RFID activated payment terminal, the payment information may be transmitted from the portable electronic device via RFID to the payment terminal, where payment is subsequently processed. Such embodiment may facilitate purchase of lift tickets for example without the user having to remove their gloves and reaching into their pocket.

In various embodiments, the portable electronic device may be configured to support time functionality. By way of example only, in such embodiment, the portable electronic device may display time.

In various embodiments, the portable electronic device may be configured to support voice control functionality, where it facilitates the user to activate predetermined functionalities on their mobile device (or wearable device).

In various embodiments, the portable electronic device may be configured to support control of external devices (e.g., cameras or drones). In various embodiments, the external device may be controlled (power on/off, or activate/deactivate predetermined functionality of the external device). In various embodiments, notifications form the external device may be indicated on the portable electronic device.

In various embodiments, the battery of the portable electronic device may be configured to support a wireless charging mechanism (e.g., Qi wireless charging) to facilitate wireless charging.

In various embodiments, the portable electronic device may be configured to receive and perform a system update that is known in the art as over the air (OTA) update. OTA facilitates the wearable device to update its computer-readable code (software). OTA provides the ability to modify the procedures (algorithms) and data inside the portable electronic device to be reconfigured to modify existing functionalities or add previously non-existing functionalities to the portable electronic device. The OTA functionality may be facilitated by a wired or wireless connection of the portable electronic device to a mobile phone or a computer.

In various embodiments, the portable electronic device may be configured to transfer any data to and from a connected device (such as a mobile device) using a wired or wireless (e.g., Bluetooth®) connection.

In various embodiments, the portable electronic device may be configured to acquire and store data from its various sensors and subsequently transfer this data to another connected device (such as a mobile device) using a wired or wireless connection. Similarly, in various embodiments the mobile device of a user may be configured to acquire and store the data from its various sensors and subsequently transferred this data to the portable electronic device using a wired or wireless connection. The data from the portable electronic device and the secondary connected device (e.g., mobile device) may be used in various ways to facilitated predetermined functionalities.

In various embodiments the portable electronic device may be configured to facilitate hands-free PTT. This functionality facilitates the user to activate various pre-determined functionalities of the portable electronic device without having to interact with a physical button. The hands-free PTT functionality is not limited to activating or deactivating PTT and may activate or deactivate other predetermined functionality. In various embodiment of the hands-free PTT, by way of example only, the friend tracking functionality may be activated when a user performs a sequence of motions and gestures while wearing the portable electronic device on their hand. In various embodiments, the hands-free PTT may activate the PTT communication functionality when the user performs a predetermined gesture or proximity (e.g., brings the portable electronic device within proximity of their face).

In various embodiments, the portable electronic device may be configured for enhanced user interaction by way of one or more of the following:

(a) Haptic
a. Buttons: in various embodiments the user may provide an input by pressing one or several buttons in one or more of the following ways: (i) short press and release, (ii) short double press and release, and (iii) long press and hold. In various embodiments the buttons may also be pressed in certain sequence to activate predetermined functionality. In various embodiment the buttons may be pressed or activated at generally the same time, in combination, to activated predetermined functionality. In various embodiments the predetermined functionality that the buttons may activate may be reassigned (programmable buttons); this may facilitate the user to specify via the portable electronic device (or their mobile device) what button may activate a predetermined functionality. In various embodiment of the buttons, the type of the buttons may not be limited to push buttons, and may facilitate user input by various physical input mechanisms including: rotary (e.g. angular encoder, rotary knob), toggle, capacitive or switch mechanisms or the like.
b. Touchscreen: in various embodiments the user may provide an input by interacting with a touch sensitive screen (touching, swiping, clicking, and the like) to activate predetermined functionality.

(b) Audio
a. Voice command: in various embodiments the wearable device may activate or control various functionality on the mobile device or wearable via voice command facilitated by a mobile device. A user may provide a voice command input by speaking into the microphone of the portable electronic device (or the microphone of their mobile connected accessory). In such embodiment the portable electronic device may support various voice commands wherein the user may articulate a command by voice mobile device will interpret. The commands can range from queries such as “what time is it?” to text message commands such as “text John Doe: Hey John, let's meet for lunch at the north peak at noon.”

(c) Movement
a. Motion gesture: in various embodiments the user may provide an input by making one or a series of motions with the portable electronic device. For example, in one such embodiment if the user swings their arm up and twists their forearm it may activate the PTT functionality.

In various embodiment of the outputs of the wearable device, the portable electronic device may be configured for enhanced user interaction by way of one or more of the following:

(a) Haptic
a. Vibration: in various embodiments the user may receive a notification in form of a vibration that may be palpable while wearing many layers of clothing and gloves.

(b) Audio
a. Speaker (or Buzzer): in various embodiments the user may receive a notification in form of an audible cue such a beep, melody or music, for example, when receiving a text message. In one such embodiments the speaker may be integrated in the portable electronic device, a user's mobile device or external wireless headphones (such as a helmet with integrated speakers). In various embodiments the speaker can also be used for the music and communication (call or PTT) functionality.
b. Voice: in various embodiments the user may receive notifications in form of an audible artificial voice (i.e., text to speech or TTS) that speaks to the user to notify them. In one exemplary embodiment the voice output may inform the user how fast they are traveling. In another exemplary embodiment the voice output read out a text message for the user. In yet another exemplary embodiment the voice output facilitate way finding (i.e. navigation) for the user.

(c) Visual
a. Status light: in various embodiments the user may receive a light notification that is turned on or off in a predetermined sequence, for example, to notify the user of an incoming message. In various embodiments the light may be a multi-colored Light Emitting Diode (LED).
b. Array of lights: in various embodiments an arrangement of a number of lights (LEDs) may be used in one or more of the following ways:
   i. In one exemplary embodiment the array of lights indicates the time of the day to user. By way of example, if the lights are arranged in a circular form with 12 LEDs then by turning on only one light to show the hour, and the other blinking LED to show the minute, the user can infer the time of the day.
   ii. In another exemplary embodiment the light array may indicate the traveling speed of the user. By way of example, turning on a consecutive series of the LEDs as a function of speed, the user may infer the approximate speed they are traveling at. For example in such an embodiment, at low speeds only one LED (LED 7) may be turned on, while at 30 km/h the first three LEDs (e.g., LED 7, 8 and 9) may be turned on.
   iii. In yet another exemplary embodiment the light array guide the direction a user would need to travel to face north, or to reach a friend. By way of example, a plurality of lights arranged in a generally circular may form an array of light to facilitate(e.g., 12 LEDs) the activation of a single LED in the direction of the predetermined target such that the user can determine which way to travel to. In such embodiment, if the target (or magnetic north) is approximately in North West, then the LED in position 10:00 or 11:00 (LED 11 or 12) would be activated (assuming numbering of a clock and 12 LEDs).
c. Display: in various embodiments the user may receive notification on graphical dot-matrix screen which facilitates display of various information. By way of example only, in various embodiment the display may show one or more of the following information to the user: text messages, active functionality, name of music title, time of the day, and the like.

In various embodiments, the portable electronic device may be configured to support a display capability, touch screen or graphical user interface to allow a user to view information and to interact with the portable electronic device or with the mobile device via the portable electronic device. In various embodiments, the portable electronic device may be configured to display information such as activity performance metrics, local weather condition, snow report, ski lift status, missed calls, battery status, or text messages.

In various embodiments, the portable electronic device may be configured to function as a stand-alone device. In such embodiments, the portable electronic device may support wireless communication to a cellular network or with one or more remote servers, without depending on a mobile device. In such embodiments the portable electronic device may provide at least one of the following functionalities:
(a) call functionality on the wearable device;
(b) carrying out various applications on the wearable device;
(c) notification functionality on the wearable device;
(d) text message functionality on the wearable device;
(e) push to talk over cellular (PTT) functionality on the wearable device;
(f) friend tracking functionality on the wearable device;
(g) navigation functionality on the wearable device;
(h) acquiring various sensor data on the wearable device and optionally storing this data in memory;
(i) over the air software update functionality on the wearable device;
(j) programmable button functionality on the wearable device;
(k) send and receive data from a remote server facilitated by a wireless connection;
(l) time functionality on wearable device;
(m) hands-free PTT functionality on the wearable device;
(n) notification functionality on the wearable device; and
(o) radio frequency identification (RFID) functionality on the wearable device.

More generally, the portable electronic device may include and execute its own stand-alone computer-readable codes or applications and need not be dependent on a mobile device. In various embodiments the stand-alone portable electronic device may be configured to perform any of the aforementioned pre-determined functionalities supported by the embodiment of the portable electronic device that depended on a mobile device, without a mobile device. In various embodiments, the stand-alone portable electronic device may contain all the components necessary to perform the predetermined functionalities, including but not limited to wireless connection to the cellular network (or other wireless networks)., to facilitated connectivity to a remote server.

In various embodiments, the portable electronic device may be configured to function as a stand-alone device and may support an expanded set of functionality when connected to a mobile device. In such embodiments, the wearable device may provide one or more of the aforementioned functionality mentioned in the various embodiments.

In various embodiments, a stand-alone portable electronic device may be configured to acquire and store data from its various sensors and subsequently transfer this data to another connected device (such as a mobile device) using a wired or wireless connection when in proximity.

In various embodiments, a stand-alone portable electronic device may be configured send and receive data to a remote server facilitated by a wireless connection. The wireless connection may be a cellular network or another wireless network such as WiFi.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 illustrates a perspective view of an exemplary embodiment of a wearable device;

FIG. 2 illustrates a perspective view of the wearable device of FIG. 1 detachably affixed to a glove;

FIG. 3 illustrates a top view of the portable electronic device of FIG. 1 touched by user wearing a glove;

FIG. 4 illustrates an exploded view of the wearable device of FIG. 1 according to one embodiment;

FIG. 5 shows a cross-sectional view of the portable electronic device of FIG. 1;

FIG. 6 illustrated a perspective bottom view of the base with universal attachment fitting of FIG. 4 according to one embodiment;

FIG. 7 illustrates a perspective top view of the base with universal attachment fitting of FIG. 4 according to one embodiment;

FIG. 8 illustrates a perspective view of a mounting adaptor for flat surfaces according to one embodiment;

FIG. 9 illustrates a side view of the mounting adaptor of FIG. 8 according to one embodiment;

FIG. 10 illustrates a perspective cross-sectional view of the mounting adaptor from FIG. 8 affixed to portable electronic device of FIG. 1;

FIG. 11 illustrates the method of detachably couple to the portable electronic device of FIG. 1 using an elastic strap;

FIG. 12 is a perspective view of the top side the elastic strap of FIG. 11;

FIG. 13 shows a cross-sectional view of a user wearing the portable electronic device of FIG. 1 using the elastic strap of FIG. 12;

FIG. 14 shows a side view of a mounting adaptor for cylindrical surfaces which can be detachably coupled to the portable electronic device from FIG. 1;

FIG. 15 shows a perspective view of a cylindrical surface mounting adaptor from FIG. 14 according to one embodiment;

FIG. 16 illustrates how the portable electronic device from FIG. 1 is attached on a glove that includes a buckle according to one embodiment;

FIG. 17 illustrates a schematic diagram illustrating various embodiments the portable electronic device, which is a generalized representation of the portable electronic device, with universal attachment mechanism;

FIG. 18 illustrates a schematic diagram of the sub-systems of the portable electronic device on FIG. 17 according to various embodiments;

FIG. 19 is a functional diagram of the machine-readable codes (software) included in the portable electronic device on FIG. 17 according to various embodiments;

FIG. 20 shows an illustrative flowchart of the computer-readable code included in the Power Management Module 272 according to one embodiment ;

FIG. 21 illustrates a flow chart of an embodiment of computer-readable code (software) which may be included in the Power Management Module to facilitate the estimation of battery level.;

FIG. 22 is a flow chart that illustrates an embodiment of the computer-readable code (software) included in the wearable device to facilitate the charging of battery in FIG. 18;

FIG. 23 illustrates a flowchart computer-readable code (software) executed by the user input module of FIG. 19 according to one embodiment;

FIG. 24 shows a top view representation of buttons included in an embodiment of the portable electronic device;

FIG. 25 is a table shows an exemplary table of various commands sent for various user input, wherein the command sent may activate or deactivate predestined depending on the status of the portable electronic device according to one embodiment;

FIG. 26 shows a top view representation of buttons included in an embodiment of the portable electronic device;

FIG. 27 shows a flowchart of the algorithm used for programmable inputs according to one embodiment;

FIG. 28 is an illustrative table showing various commands sent in response various user input wherein the command sent may activate or deactivate predestined depending on the status of the portable electronic device according to one embodiment;

FIG. 29 shows a simplified schematic for the hands-free PTT circuit that may be provided in the portable electronic device;

FIG. 30 illustrates a flow chart of the machine-readable code that may be included in the hands-free PTT module to facilitate the portable electronic device to perform a hands-free PTT functionality supported by magnetic proximity sensing according to one embodiment;

FIG. 31 illustrates a flow chart of the machine-readable code that may be included in the hands-free PTT module to facilitate the portable electronic device to perform a hands-free PTT functionality supported by gesture recognition according to one embodiment;

FIG. 32 illustrates a flow chart of the machine-readable code that may be included in the hands-free PTT module to facilitate the portable electronic device to perform a hands-free PTT functionality supported by magnetic proximity sensing and gesture recognition according to one embodiment;

FIG. 33 illustrates a flow chart of the machine-readable code that may be included in the hands-free PTT module to facilitate the portable electronic device to perform a hands-free PTT functionality supported by proximity sensing and voice recognition according to one embodiment;

FIG. 34 shows an illustrative embodiment of a wearable device with its local Cartesian coordinate system comprised of three axes, and center of gravity at its origin according to one embodiment;

FIG. 35 shows user performing hands-free PTT while performing sports;

FIG. 36 illustrates a perspective view of an embodiment of the portable electronic device, which contains tactile features that can be felt while wearing gloves;

FIG. 37 illustrates a top view of an embodiment of the portable electronic device configured with joystick functionality. In this figure the joystick is in neutral position. A corresponding cross-sectional view is also shown;

FIG. 38 shows the portable electronic device of FIG. 37 where the joystick shifted to the left of the page;

FIG. 39 shows the portable electronic device of FIG. 37 where the joystick in its neutral mode—this means that the joystick is in the center position and rotationally facing top of the page;

FIG. 40 shows the portable electronic device of FIG. 39, where the joystick is in the same center position but rotated clockwise;

FIG. 41 shows the portable electronic device of FIG. 39, where the joystick is not rotated but shifted to the right of the page;

FIG. 42 shows the portable electronic device of FIG. 39, where the joystick is both rotated clock-wise and shift to the top of the page;

FIG. 43 shows a perspective view of the portable electronic device of FIG. 39;

FIG. 44 is a perspective view of an alternate embodiment of the portable electronic device that contains rotating ring;

FIG. 45 shows the top view of an alternate embodiment illustrated in FIG. 44; the corresponding cross-sectional view and detailed view of an exemplary embodiment of the rotating ring feature are also shown;

FIG. 46 illustrates the components of the rotating ring feature shown in FIG. 44 and how it works according to one embodiment;

FIG. 47 illustrates the various layers of attachments to the portable electronic device according to various embodiments;

FIG. 48 illustrates a schematic diagram of the attachments connected to the portable electronic device according to various embodiments;

FIG. 49 shows the top view of an embodiment of the mounting adaptor (with its corresponding cross-sectional view), and contains: (i) a base capable in detachably attach to garment, and (ii) a rotary lock feature that connects to a portable electronic device;

FIG. 50 illustrates a detailed view of the cross-sectional view of FIG. 49, showing the components of the garment attachment before it is locked in with a garment;

FIG. 51 illustrates the garment attachment shown in FIG. 50 after it is locked in with garment;

FIG. 52 illustrates a top view of an alternate embodiment of the portable electronic device that contains a display;

FIG. 53 illustrates the back side of the an embodiment shown in FIG. 52 that contains a rotary lock mechanism;

FIG. 53 shows a perspective view of an embodiment of the mounting adaptor shown in FIG. 49;

FIG. 55 shows a perspective view of the combination of an embodiment of the mounting adaptor in FIG. 53 and an embodiment of the portable electronic device shown in FIG. 52;

FIG. 56 is a perspective view of an exemplary embodiment of the body cover;

FIG. 57 is a perspective view of the portable electronic device in accordance with another embodiment;

FIG. 58 shows a perspective view of the combination of an embodiment of the body cover (shown in FIG. 56) and an embodiment of the portable electronic device (shown in FIG. 57);

FIG. 59 shows the top view of an embodiment of the portable electronic device wherein a generally circular array of lights (LEDs) are integrated in the portable electronic device to provide the user with a visual indication of how fast they are moving;

FIG. 60 shows the top view of an embodiment of the portable electronic device wherein a generally circular array of lights (LEDs) are integrated in arranged in the portable electronic device to provide the user with a visual indication of which way to go (i.e., a “navigation” functionality);

FIG. 61 shows the top view of an embodiment of the portable electronic device wherein a generally circular array of lights (LEDs) are integrated in arranged in the portable electronic device to provide the user with a visual indication of the time of the day;

FIG. 62 is a perspective view of an exemplary embodiment of a proximity actuator;

FIG. 63 shows a cross-sectional view of the an exemplary embodiment of the proximity actuator in FIG. 62;

FIG. 64 shows an embodiment of the portable electronic device where a user activates the hands-free communication functionality of the portable electronic device by going through a sequence of motions and gestures.

### DETAILED DESCRIPTION

In accordance with one aspect, there is provided a portable electronic device comprising a housing with one or more buttons, one or more sensors and a processor circuit, the housing configured to detachably attach to an item of apparel or another object and the processor circuit configured to receive input from the one or more buttons and sensors, and provide predetermined functionality in response to the input received from the one or more buttons and sensors.

In accordance with another aspect, there is provided a wearable portable electronic device comprising:
(a) a housing configured to detachably attach to an item of apparel or another object, the housing comprising one or more buttons for user interaction, the one or more buttons being shaped, sized and positioned on the housing to facilitate user interaction with the portable electronic device while the housing is attached to the item of apparel or another object and the user is using a glove-enclosed hand to interact with and provide input via the buttons; and
(b) a processor circuit contained within the housing, the processor circuit configured to: (i) receive input from the one or more buttons; and (ii) provide predetermined functionality in response to the input received from the user, the processor circuit configured to facilitate the predetermined functionality in response to user interaction with the one or more buttons.

In accordance with another aspect, there is provided a portable electronic device comprising:
(a) a housing configured to detachably attach to an item of apparel or another object, the housing comprising one or more sensors and one or more buttons for user interaction, the one or more buttons being shaped, sized and positioned on the housing to facilitate user interaction with the portable electronic device while the housing is attached to the item of apparel or other object and the user is using a glove-enclosed hand to interact with and provide input via the buttons; and
(b) a processor circuit contained within the housing, the processor circuit configured to: (i) receive input from the one or more buttons; and (ii) provide predetermined functionality in response to the input received from the user or the one or more sensors, the processor circuit further configured to facilitate push-to-talk over cellular communications (PTT) via portable electronic device in response to activation of at least a portion of the predetermined functionality by the user via interaction with the one or more buttons.

The portable electronic device may operably communicate with a mobile device situated separate and apart from the portable electronic device but within communications range of the portable electronic device.

In various embodiments, the predetermined functionality provided by the processor circuit may comprise controlling one or more applications on the mobile device.

The processor circuit may be configured to control select functionality on the portable electronic device (or wearable device) in response to at least one of the following:
(a) user interaction with the one or more physical input devices (e.g., button, knob);
(b) motion gestures by the user (e.g. accelerometer);
(c) movement by the user (e.g., global positioning system);
(d) user interaction with the touch screen (e.g., capacitive touch pad);
(e) user interaction with the proximity sensor (e.g., magnetic sensor);
(f) user interaction with one or more sensors supported by the portable electronic device (e.g., altimeter, humidity, infrared, or microphone); and
(g) user interaction with one or more sensors supported by mobile device (e.g., accelerometer, microphone, or GPS).

In various embodiments, the audio input of the PTT communication functionality may be provided through the microphone inside the housing of the portable electronic device, or integrated microphone of the wired or wireless headphones connected to the user's mobile device.

In various embodiments, the audio output of the PTT communication functionality may be provided through the speaker inside the housing of the portable electronic device, or wired or wireless headphones connected to the user's mobile device.

In various embodiments the portable electronic device may be configured to receive notifications and alerts and provide status updates (e.g., missed calls, emails and notification from Applications running on a user's mobile phone). In one embodiment the notifications may be indicated to the user in response to user interaction with the one or more buttons. In various embodiments, the portable electronic device may be configured to indicate the notifications to the user in one or more of the following ways:
(a) display one or more of the notifications (status light, array of lights, or display screen);
(b) output one or more audible status notifications using a speaker or buzzer; and
(c) output one or more palpable status notifications using a mechanical vibration.

In various embodiments, the portable electronic device may be configured to function as a stand-alone device. In such embodiments, the portable electronic device may support wireless communication to a cellular network or with one or more remote servers, without depending on a mobile device. In such embodiments the portable electronic device may provide at least one of the following functionalities:
(a) call functionality on the wearable device;
(b) carrying out various applications on the wearable device including music player functionality;
(c) notification functionality on the wearable device;
(d) text message functionality on the wearable device;
(e) push to talk over cellular (PTT) functionality on the wearable device;
(f) friend tracking functionality on the wearable device;
(g) navigation functionality on the wearable device;
(h) acquiring various sensor data on the wearable device and optionally storing this data in memory;
(i) communication with a mobile device to send or receive data;
(j) over the air software update functionality on the wearable device;
(k) programmable button functionality on the wearable device;
(l) Send or receiving data to or from a remote server;
(m) time functionality on wearable device;
(n) hands-free PTT functionality on the wearable device;
(o) notification functionality on the wearable device; and
(p) radio frequency identification (RFID) functionality on the wearable device.

More generally, the portable electronic device may include and execute its own stand-alone computer-readable codes or applications and need not be dependent on a mobile device connection.

In various embodiments, the portable electronic device may be configured to function as a stand-alone device and may support an expanded set of functionality when connected to a mobile device. In such embodiments, the wearable device may provide one or more of the aforementioned functionality mentioned in the various embodiments.

In various embodiments, the portable electronic device may also contain a radio-based walkie-talkie that facilitates conventional walkie-talkie communication on dedicated frequency spectrums.

In various embodiments, the portable electronic device may comprise an attachment mechanism (or fastener mechanism) configured to fasten and unfasten the housing to and from the item of apparel or other object. In various embodiments the fastener mechanism may be a strap or an elastic strap.

In various embodiments, the housing comprises a top exterior generally circular edge and an exterior top face, which together provide a large user-interface area with a clearly tangible edge to allow the portable electronic device to be readily operated by the user via the gloved-enclosed hand.

In various embodiments there are provided a sealing ring and an elastic member, wherein the sealing ring and the elastic member are configured and connected to the housing to prevent water ingress into the portable electronic device.

In various embodiments, the portable electronic device comprises a base with universal attachment fitting connected to a lower portion of the housing, the base with universal attachment fitting configured to detachably attach to the item of apparel or other object. The base with universal attachment fitting may comprise an arched bottom surface shaped and sized to allow the portable electronic device to be securely and comfortably seated on a curved surface of the item of apparel or other object. In other embodiments, the base with universal attachment fitting may comprise an arched bottom surface shaped and sized to allow the portable electronic device to be securely and comfortably seated on a curved surface of a glove generally at wrist position.

In various embodiments the portable electronic device comprises a mounting adaptor configured to detachably couple to the portable electronic device via a snap fit feature, the mounting adaptor having a curved surface adapted to mate with the corresponding curvature of the arched bottom surface, the snap fit feature adapted to hook the base with universal attachment fitting to the housing.

In various embodiments, the housing comprises a bottom cavity shaped and sized to partially or fully contain a buckle when sitting on a glove generally at wrist position.

In various embodiments of the attachment mechanism, the attachment (e.g., strap) may be detachably attached/detached, repositioned, adjusted (position and grip strength) using only one hand while the user is wearing gloves.

In various embodiments of the attachment mechanism, the attachment (e.g., strap) may be such that the wearable device remains attached to a glove even when the user remove their hand from it.

In various embodiments, the housing and processor circuit may be configured to operate under outdoor winter conditions, including low (e.g. below zero degrees Celsius) or extreme low temperatures (for example about −15° to −40° Celsius or colder).

In various embodiments, the housing and processor circuit may be configured to operate in wet and humid environments, and operate underwater (up to 100 m deep).

In various embodiments, the housing and processor circuit may be configured to operate in environment where high mechanical forces (vibration and shock) are present.

In various embodiments, the predetermined functionality provided by the processor circuit may comprise controlling at least one of:

The portable electronic device may be configured to display a notification in response to user control of the select functionality on the mobile device via interaction with the one or more buttons on the portable electronic device.

The portable electronic device may comprise a display and wherein the portable electronic device is configured to display information on the display that is retrieved from the mobile device in response to user control of the select functionality on the mobile device via interaction with the one or more buttons on the portable electronic device.

In various embodiments, the one or more buttons comprise:
(a) a first button configured to toggle the power of the portable electronic device on and off;
(b) a second button configured to pick up an incoming call received by the portable electronic device in response to one mode of user input with the second button and configured to reject or decline the call in response to a second mode of user input with the second button; and
(c) a third button configured to turn on and off push-to-talk over cellular communications (PTT).

In various embodiments, the one or more buttons comprise:
(a) a first button configured to toggle the power of the portable electronic device on and off;
(b) a second button configured to pick up an incoming call received by the portable electronic device via the mobile device in response to one mode of user input with the second button and configured to reject or decline the call in response to a second mode of user input with the second button;
(c) a third button configured to turn on and off push-to-talk over cellular communications (PTT);
(d) a fourth button configured to cause a music track to be selected and played from the mobile device;
(e) a fifth button configured to cause the music track to be paused, rewound or fast forward, and to cause another music track to be played from the mobile device; and
(f) a sixth button configured to cause a mute mode to be activated.

In various embodiments the wearable device supports functionality that each button activates may be reassigned by the user using the input reassignment or input programming, allowing the function or functionality of a physical input, wireless input, gesture input, or hands-free PTT input to be changed. In various such embodiments, a user may specify what functionality one or more buttons or hands-free PTT gesture may activate.

In various embodiments, there is provided a portable electronic device for facilitating communications comprising:
(a) a housing configured to detachably connect to an item of apparel;
(b) a microphone connected to the housing; and
(c) a processor circuit contained within the housing, the processor circuit configured to: (i) receive audio input from the microphone; (ii) activate cellular communications via the portable electronic device in response to detecting that the portable electronic device is within a predetermined range of a proximity actuator; and (iii) deactivate the cellular communications in response to detecting that the portable electronic device is outside of the predetermined range.

In various embodiments the portable electronic device may be configured to monitor for signals from the proximity actuator when the proximity actuator is attached to an item of apparel, an object or the user so as to be located generally near the upper torso, neck or head of the user.

In various embodiments there is provided a wearable communications kit comprising the portable electronic device and the proximity actuator, with the proximity actuator configured to detachably attach to at least one of the item of apparel and the user.

In various embodiments the portable electronic device may facilitate one or more of the following for the music control functionality on user's phone:
(a) play an audio file;
(b) pause an audio file;
(c) mute a playing audio file;
(d) select and play the next audio file (i.e., “next”);
(e) select and play the previous audio file (i.e., “previous”);
(f) rewind (go back to the beginning) of an audio file;
(g) fast forward (jump forward) in an audio file; and
(h) adjust volume of audio output (higher or lower sound output).

In various embodiments the portable electronic device may facilitate one or more of the following for the call functionality on user's phone:
(a) answer an incoming call;
(b) reject an incoming call;
(c) put an incoming call on hold;
(d) mute an ongoing call;
(e) select a phone number from a list of contacts;
(f) dial a phone number;
(g) re-dial a phone number;
(h) speed dial a previously dialed phone number; and
(i) adjust volume of a call (higher or lower sound output).

In various embodiments, the portable electronic device may or may not be dependent on a mobile device for the call functionality and can be configured to operate completely stand-alone in various embodiments.

In various embodiments, there is provided a portable electronic device for facilitating friend-tracking functionality comprising:
(a) a housing configured to detachably connect to an item of apparel;
(b) an array of lights that are visible to the user and integrated in the wearable device; and
(c) a processor circuit contained within the housing, the processor circuit configured to: (i) receive information regarding the location and orientation of the user; (ii) receive information regarding the location of a second user; (iii) calculate the direction of the second user in relation to the first user; and (iv) activate the aforementioned lights to indicate the direction the user needs to travel to reach the second user.

In various embodiments, the lights in the portable electronic device may be arranged circularly on the outside edge of the housing of the portable electronic device. For example, in such embodiments the light may comprise of 12 light emitting diodes (LEDs) arranged such that LED 12 corresponds to 12 o'clock (or north, or in front) while LED 3 corresponds to 3 o'clock (or east, or to the right) and so on.

In various embodiments, a button on the portable electronic device may be configured to activate the friend-tracking functionality.

In various embodiments, the lights in the portable electronic device may be turned off after passage of a predetermined amount of time (e.g. 30 seconds) after initial activation of the time friend-tracking functionality.

In various embodiments, the friend-tracking information may be provided using audio (voice) through the speaker inside the housing of the portable electronic device or wired or wireless headphones connected to the user's mobile device.

In various embodiments, the friend-tracking functionality may provide information such as estimated time of arrival (ETA) information to the user using audio (voice). In various embodiments, there is provided a portable electronic device for facilitating the time functionality comprising:
(a) a housing configured to detachably connect to an item of apparel;
(b) an array of lights that are visible to the user and integrated in the portable electronic device; and
(c) a processor circuit contained within the housing, the processor circuit configured to: (i) receive information regarding time of the day or use internal clock of the processor; and (ii) activate the aforementioned lights to indicate the time of the day in response to press of a button.

In various embodiments, a button on the portable electronic device may be configured to activate the time functionality.

In various embodiments, the lights in the portable electronic device may be arranged circularly on the outside edge of the housing of the portable electronic device. For example, there light may be 12 light emitting diodes (LEDs) arrange such that LED 12 corresponds to 12 o'clock, LED 1 corresponds to 1 o'clock and so on.

In various embodiments, the time functionality in the portable electronic device may be configured such that the hour may be indicated by a continuous light output on the corresponding position of a clock. The minute may be indicated by a blinking light output (turned on for the first half of a certain period, followed by being turned off for the second half of the period). Alternatively, the minute can be indicated by turning on the corresponding light but with a lower brightness.

In various embodiments, the lights in the portable electronic device may be turned off after passage of certain time (e.g. 20 seconds) after initial activation of the time functionality.

In various embodiments, the time information may be provided using audio (voice) through the speaker inside the housing of the portable electronic device or wired or wireless headphones connected to the user's mobile device.

In various embodiments, there is provided a portable electronic device for facilitating voice command functionality comprising:
(a) a housing configured to detachably connect to an item of apparel;
(b) a microphone connected to the housing; and
(c) a processor circuit contained within the housing, the processor circuit configured to: (i) receive audio input from the microphone in response to press of a button; and (ii) activate voice command on user's mobile device 202 and send audio input to user's mobile device 202, or activate web-based voice command service (e.g. Amazon Alexa or Microsoft Cortana) via user's mobile device 202.

In various embodiments, a button on the portable electronic device may be configured to activate the voice-command functionality.

In various embodiments, the portable electronic device may await a response from the voice-command service (whether it is from user's phone or a web-based voice service) and activate certain functionality based on the response. For example, in such embodiment when a user asks for the time from the voice service, the portable electronic device forwards this query to the voice service. The voice service may respond with instructions to the portable electronic device to activate the time functionality. In such case, the portable electronic device may activate several light to indicate the hour and time of the day.

In various embodiments, the portable electronic device may have a speaker inside the housing of the portable electronic device. The speaker may be used for, for example, to output the audio response from the voice-command service.

In various embodiments, there is provided a portable electronic device for facilitating navigation functionality comprising:
(a) a housing configured to detachably connect to an item of apparel;
(b) an array of lights that are visible to the user and integrated in the portable electronic device; and
(c) a processor circuit contained within the housing, the processor circuit configured to: (i) receive information regarding the location and orientation of the user from the user's mobile device; (ii) receive information regarding where the user aims to travel to based on their response on the mobile phone; (iii) receive information regarding surrounding map and available tracks using the user's mobile device; (iv) calculate the direction the user needs to travel to stay on predetermined path (e.g., ski tracks), or a path that leads to desired destination; and (iv) activate the aforementioned lights to indicate the direction the user needs to travel to reach their destination in response to press of a button.

In various embodiments, the lights may be arranged in a circularly on the outside edge of the housing of the portable electronic device.

In various embodiments, a button on the portable electronic device may be configured to activate the navigation functionality.

In various embodiments, the lights in the portable electronic device may be turned off after passage of certain time (e.g. 30 seconds) after initial activation of the navigation functionality.

In various embodiments, navigation instructions may be provided using audio (voice) through the speaker inside the housing of the portable electronic device, or wired or wireless headphones connected to the user's mobile device.

In various embodiments, the navigation functionality may provide information such as estimated time of arrival (ETA) information to the user using an artificial voice (i.e., test to speech or TTS).

In various embodiments, there is provided a portable electronic device for facilitating control of external devices (other than user's mobile device) comprising:
(a) a housing configured to detachably connect to an item of apparel;
(b) a wired or wireless connection to an external device (such as stand-alone camera); and
(c) a processor circuit contained within the housing, the processor circuit configured to: (i) facilitate connection to the external device independently or using the user's mobile device; (ii) receive information from the external device regarding the status of the external device (such as power status, battery level, and alike) and notify the user, and (iii) send commands to the external device, for example to run it on or off, in response to press of a button.

In various embodiments, a button on the portable electronic device may be configured to send certain commands to a connected external device.

In various embodiments, the user may be notified of the status of the connected external device, for example, indicate whether a connected camera is recording or not. The user may be notified using one or more of the following ways: (i) one or several lights integrated in the portable electronic device may be turned on or off; (ii) an audio notification, for example a clearly noticeable sound from the buzzer or speaker integrated in the portable electronic device; and (iii) a tactile notification, such as a strong vibration of the portable electronic device.

In various embodiments, the status information of the connected external devices may be provided using audio (voice) through the speaker inside the housing of the portable electronic device or wired or wireless headphones connected to the user's mobile device.

In various embodiments, there is provided a portable electronic device for facilitating Radio-Frequency Identification functionality comprising:
(a) a housing configured to detachably connect to an item of apparel; and
(b) a RFID (radio frequency identification) tag integrated in the portable electronic device.

In various embodiments, the RFID tag integrated in the housing of the portable electronic device may be passive or actively powered.

In various embodiments, a RFID tag may be integrated in the housing of the portable electronic device or the strap to facilitate identification of a user wearing the wearable device using an external device that communicate wirelessly with the RFID tag. This information may be used to provide physical access to the user or facilitate a money transaction.

In various embodiments, the wearable portable electronic device may be configured to perform predetermined functionality provided by the processor circuit controlling at least one of:
(a) call functionality on the wearable device;
(b) carrying out various applications on the wearable device including music player functionality;
(c) notification functionality on the wearable device;
(d) text message functionality on the wearable device;
(e) push to talk over cellular (PTT) functionality on the wearable device;
(f) friend tracking functionality on the wearable device;
(g) navigation functionality on the wearable device;
(h) acquiring various sensor data on the wearable device and optionally storing this data in memory;
(i) over the air software update functionality on the wearable device;
(j) programmable button functionality on the wearable device;
(k) send and receive data from a remote server facilitated by a wireless connection;
(l) time functionality on wearable device;
(m) hands-free PTT functionality on the wearable device;
(n) notification functionality on the wearable device; and
(o) radio frequency identification (RFID) functionality on the wearable device.

In various embodiments, the portable electronic device may be configured to function as a stand-alone device. In such embodiments, the portable electronic device may support wireless communication to a cellular network or with one or more remote servers, without depending on a mobile device. In such embodiments the portable electronic device may provide at least one of the following functionalities

More generally, the portable electronic device may include and execute its own stand-alone computer-readable codes or applications and need not be dependent on a mobile device. In various embodiments the stand-alone portable electronic device may be configured to perform any of the aforementioned pre-determined functionalities supported by the embodiment of the portable electronic device that depended on a mobile device, without a mobile device. In various embodiments, the stand-alone portable electronic device may contain all the components necessary to perform the predetermined functionalities, including but not limited to wireless connection to the cellular network (or other wireless networks)., to facilitated connectivity to a remote server.

In various embodiments, the portable electronic device may be configured to function as a stand-alone device and may support an expanded set of functionality when connected to a mobile device. In such embodiments, the wearable device may provide one or more of the aforementioned functionality mentioned in the various embodiments.

In various embodiments, a stand-alone portable electronic device may be configured to acquire and store data from its various sensors and subsequently transfer this data to another connected device (such as a mobile device) using a wired or wireless connection when in proximity.

In various embodiments, a stand-alone portable electronic device may be configured send and receive data to a remote server facilitated by a wireless connection. The wireless connection may be a cellular network or another wireless network such as WiFi.

Various other embodiments, variations and features are set out in the remainder of this specification.

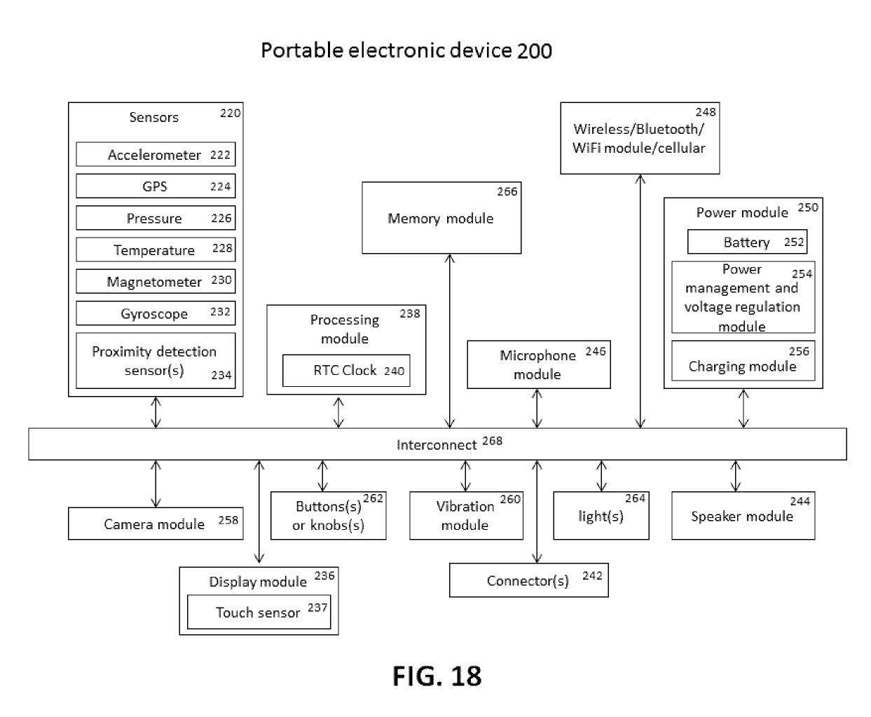

In this specification:
(a) a processor circuit includes at a minimum a processor, but in various embodiments may also include one or more additional components or modules; an illustrative processor circuit is shown in FIG. 18 (exemplary only, as not all modules shown are needed for basic functionality or for any intermediate form of processor circuit);
(b) detachably attaching has the same meaning as detachably affixing;
(c) references to coupled and connected are used interchangeably;
(d) references to voice control, voice activated, voice recognition and voice command are used interchangeably;
(e) references to light indicator and status light are used interchangeably;
(f) references to system update, and over the air update are used interchangeably;
(g) references to 3rd party device and external device are used interchangeably;
(h) references to algorithms, software, computer-readable code, app and applications are used to refer to machine-readable code;
(i) items of apparel may include various forms of garments in various embodiments;
(j) references to wearable device and wearable portable electronic device are used interchangeably;
(k) objects may include various forms of equipment and objects used by a user and that are attached to an item of apparel of the user or in general proximity of the user; and
(l) each of the terms “including”, “include” and “includes”, when used in this specification is not limiting whether non-limiting language (such as “without limitation” or “but not limited to” or words of similar import) is used with reference thereto.

Illustrative embodiments will now be described in detailed.

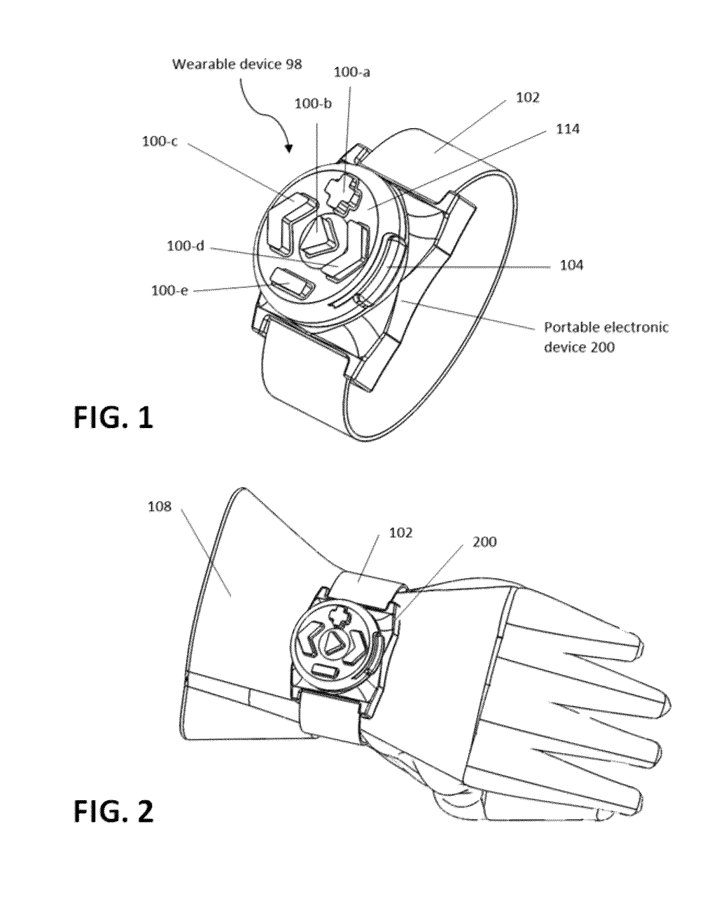

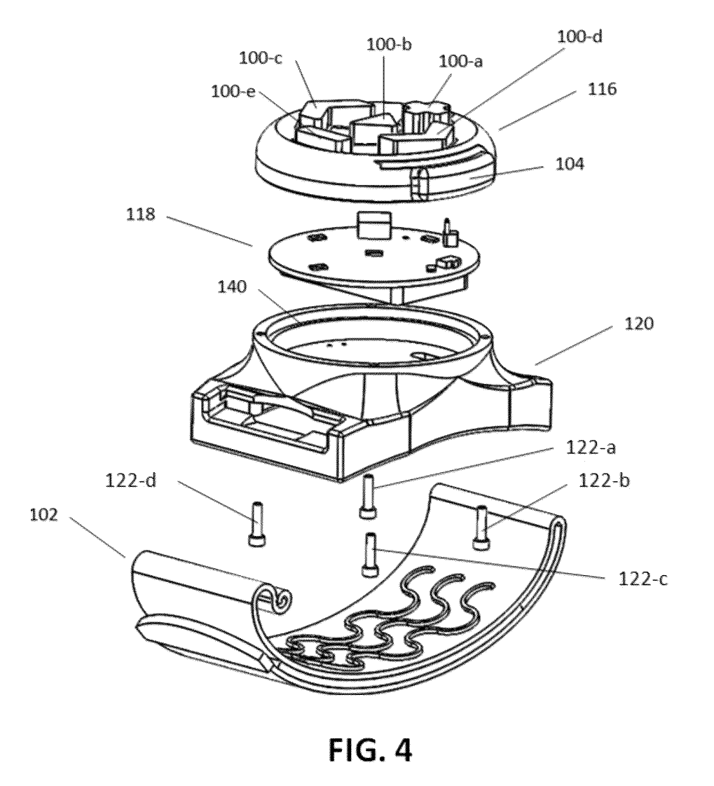

Referring to FIG. 1, in accordance with one embodiment, there is shown a wearable device 98 comprising a housing; a top assembly 116 and base with universal attachment fitting 120 (see FIG. 4) in combination form the housing which is configured to house top buttons 100-a, 100-b, 100-c, 100-d, 100-e and side button 104 on an exterior portion of the housing. The portable electronic device 200 is detachably connected or coupled to an elastic strap 102 (or various straps or various mounting adaptors) and in combination forms a wearable device 98. The wearable device 98 can be detachably affixed, connected or coupled to a glove 108 such as at the wrist or back of hand position as shown on FIG. 2. Alternatively, although not illustrated, the wearable device 98 can be detachably affixed, connected or coupled anywhere on the users' arm, on a piece of apparel, or an object such as a snowmobile.

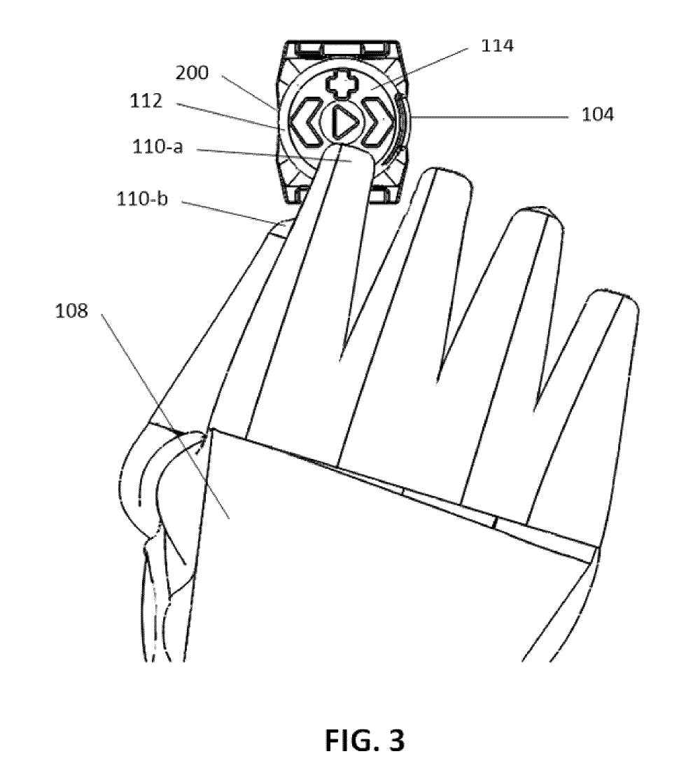

FIG. 3 illustrates a top view of one embodiment of the portable electronic device 200 being operated by a user 202 wearing a glove 108 with glove fingers 110 (110-a, 110-b, etc.) pressing one of the top buttons 100-a, 100-b, 100-c, 100-d and 100-e. Glove fingers 110 (110-a, 110-b, etc.) enlarge the users' fingers and reduce their sense of touch. In various embodiments, the portable electronic device 200 has a large exterior top face 114, large top buttons 100-a, 100-b, 100-c, 100-d, 100-e and side button 104 to allow easy operation by a user wearing glove 108. Each of the top buttons 100 and 104 can be easily accessed and pressed by a user wearing glove 108 and each button facilitates haptic feedback to the user. In various embodiments, buttons with a touchable surface area larger than about 1 cm² can offer superior ease of use, although smaller touchable surface areas on the buttons may be used. In the embodiment shown, the top exterior circular edge 112 and the exterior top face 114 provide a large user-interface area with a clearly tangible edge to allow the portable electronic device 200 (or wearable device 98) to be intuitively operated by a user wearing a glove 108. By touching the top exterior circular edge 112 through glove fingers 110 (110-a, 110-b, etc.), a user can sense the approximate orientation of the portable electronic device 200 and buttons relative to themselves. Thus, a user wearing gloves and the portable electronic device 200 (or wearable device 98), can intuitively find and operate the top buttons 100-a, 100-b, 100-c, 100-d, 100-e and side button 104 without having to look at the portable electronic device 200 (or wearable device 98).

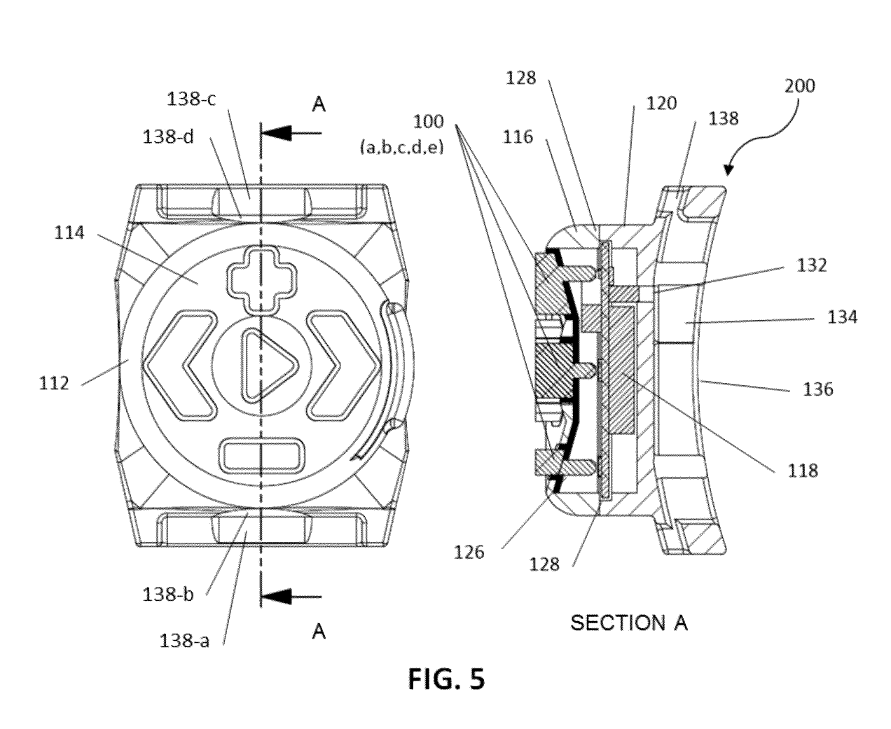

Referring to FIGS. 4 and 5, in the illustrative embodiment the wearable device 98 includes a top assembly 116, electronic circuit board assembly 118, base with universal attachment fitting 120 and a plurality of fasteners 122 (122-a, 122-b, 122-c, and 122-d). The top assembly 116 includes top buttons 100 (100-a, 100-b, 100-c, 100-d and 100-e) and side button 104 and may be made of a combination of rigid and flexible material. In various embodiments, the top assembly 116 housing, the top buttons 100 and side button 104 may be made of more rigid material. The top assembly 116 top buttons 100 are secured on an elastic member 126 in FIG. 5 which is connected to the top assembly 116 housing. An elastic sealing ring 128 surrounds the bottom surface of the top assembly 116. The electronic circuit board assembly 118 may contain all or substantially all of the electronics within portable electronic device 200 including tactile buttons that engage with top buttons 100 and the side button 104. The electronic circuit board assembly 118 fits inside the portable electronic device 200 and is sandwiched between top assembly 116 and base with universal attachment fitting 120. The sealing ring 128 and elastic member 126 provide a sealing structure to mitigate or prevent water ingress into the portable electronic device 200.

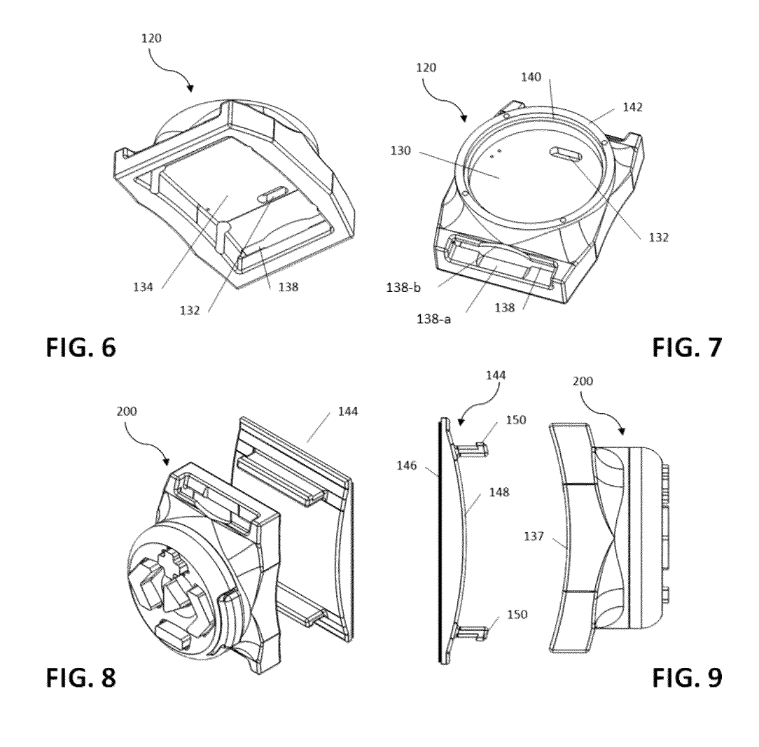

FIGS. 6 and 7 illustrate a perspective view of the base with universal attachment fitting 120 from generally bottom and top views respectively. The base with universal attachment fitting 120 may be made from rigid or generally rigid material and has a top cavity with a generally cylindrical wall 130 (or in other embodiments a wall or non-cylindrical wall) and step 140 to fit and hold the electronic circuit board assembly 118. The fasteners 122 (122-a, 122-b, 122-c, and 122-d) clamp or fasten the top assembly 116 onto the base with universal attachment fitting 120 and electronic circuit board assembly 118, securing them all in place. The base with universal attachment fitting 120 may contain an electrical connector hole 132 to provide a passageway to support an electrical connection to the electronic circuit board assembly 118. In various embodiments, the base with universal attachment fitting 120 may have an arched bottom surface 137 to allow the portable electronic device 200 be securely and comfortably seated on a curved surface such as a glove at wrist position. In various embodiments, the base with universal attachment fitting 120 includes a bottom cavity 134 which also forms a pair of slots 138 to create a mechanism to detachably couple or connect various mounting adaptors such as an elastic strap 102.

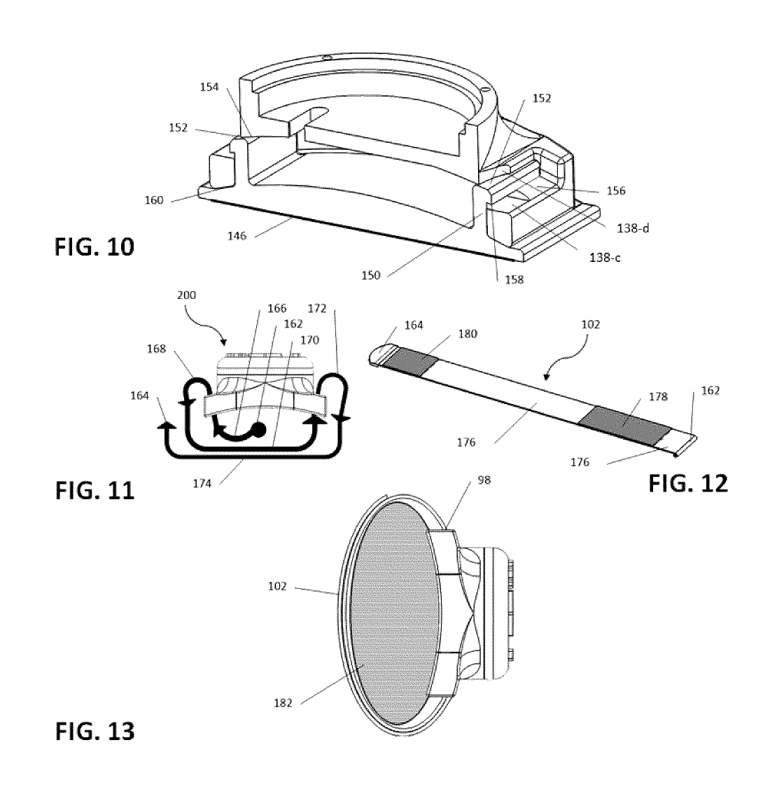

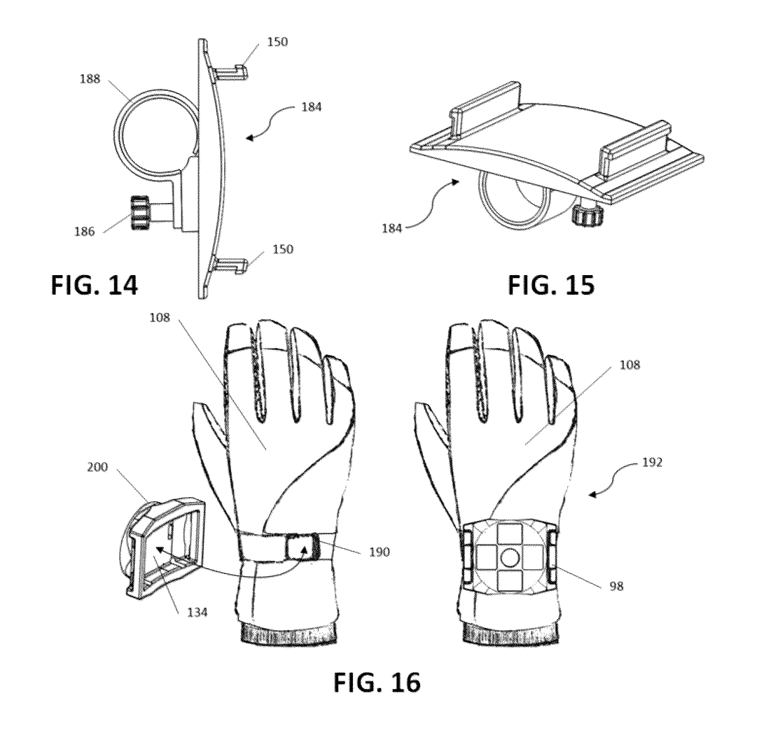

FIGS. 8, 9, 10, 11, 12, 13, 14 and 15 illustrate an arrangement and method of detachably coupling or connecting the portable electronic device 200 to various objects or various parts of a user according to various embodiments. The embodiments shown on FIGS. 8, 9 and 10 illustrate a flat surface mounting adaptor 144 and mechanism for detachably coupling or connecting the portable electronic device 200. In various embodiments, a method of detachably coupling and connecting to the portable electronic device 200 is facilitated by elastic strap 102 adaptor shown in FIGS. 11 and 12.A cross-sectional view of wearable device 98 worn by a user is shown in FIG. 13. FIGS. 14 and 15 illustrate a generally cylindrical surface mounting adaptor 184 and mechanism coupling or connecting to a portable electronic device 200. In various embodiments, the mounting adaptor 144 or 184 may detachably couple or connect with the portable electronic device 200 via a snap fit feature 150. In various embodiments, when coupled or connected, the curved surface 148 of the mounting adaptors 144 or 184 may mate with the corresponding curvature of the arched bottom surface 137, and the snap fit feature 150 may hook the universal attachment fitting 120 into the corresponding slots 138. In various embodiments, slots 138 may serve a dual function to facilitate (1) as the detachable coupling mechanism to various mounting adaptors 120 with snap fit feature 150, and (2) as a detachable coupling mechanism to a strap 102 as illustrated on FIG. 11. In one embodiment, to release the portable electronic device 200 from the mounting adaptors 144 or 184 the user may push the pair of snap fit features 150 inwards through the cavity feature 136 and slot 138. In one embodiment, a cavity feature 136 and the slot 138 are formed (see features 138-a and 138-b) to provide finger access to the pair of snap fit feature 150 for inward push in case a user wants to release the mounting adaptors 144 or 184 from the portable electronic device 200.

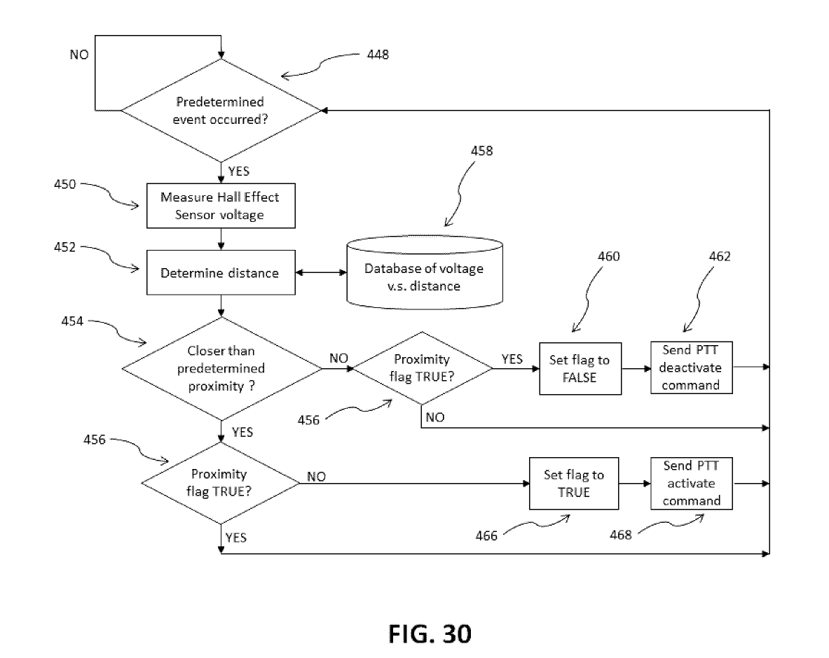

In various embodiments, the back surface 146 of the flat surface mounting adaptor 144 may be adhesive enabling it to be attached to a flat surface such as a user's helmet or a part of the user's jacket. In various embodiments, the back surface 146 may be flat as depicted in FIG. 9 or curved to better fit to garment or equipment. Referring to FIGS. 14 and 30, in the illustrative embodiment, cylindrical surface mounting adaptor 184 has a clamp with cylindrical element 188 and fastening mechanism 186. The cylindrical surface mounting adaptor 184 can be detachably mounted onto cylindrical objects such as snowmobile handle or a paddle.

FIG. 12 shows a perspective view of the top side of an embodiment of the elastic strap 102 adaptor which includes hook 178 and loop 180 fastener elements, elastic element 176, front end 164 and blocking end 162.

FIG. 11 illustrates a method of attaching the elastic strap 102 adaptor to the portable electronic device 200 according to various embodiments. The arrows show the maneuvering of the elastic strap 102 for attachment to the portable electronic device 200. As illustrated on FIG. 11, according to various embodiments, the first step 166 is to make the top side of the elastic strap 102 adaptor face the bottom side of the portable electronic device 200 and pass the front end 164 through slot 138 and pull until blocking end 162 is stopped behind slot 138. The second step 168, 170 and 172 is to wrap the elastic strap 102 adaptor around and pass the front end 164 through the opposing slot 138. At this time the user may wear the portable electronic device 200 on body covering (e.g. glove). The last step 174 is to wrap the elastic strap 102 adaptor around, pull until the portable electronic device 200 is secure on desired location, and engage the hook and loop elements 178 and 180. FIG. 13 shows a cross-sectional view of a user wearing the portable electronic device 200 using the elastic strap 102 adaptor, where the hatched area 182 represents the cross-section area of the user's wrist and garment. In various embodiments, when the wearable device 98 is attached on a glove, the portable electronic device 200 may remain secure on the glove whether the user is wearing the glove or not. This is due to the elastic nature of the elastic strap 102 adaptor that shrinks to a smaller size when the glove is taken off by the user. Thus, in various embodiments, once the wearable device 98 is securely setup on the glove, the user can easily take their gloves off or wear them again without the need to re-adjust elastic strap 102 or set up the wearable device 98. In various embodiments, to release the wearable device 98, the user may detach the hook and loop elements 178 and 180 and open the strap. This strap configuration facilitates one handed operation of the portable electronic device 200 while wearing a glove; for example, this may include wearing, positioning, fastening, adjustment and releasing of the wearable device 98 while wearing gloves. When opened, the elastic strap 102 may not be easily removed from the portable electronic device 200, so the wearable device 98 can be loosely attached to the user and glove 108 when the glove is worn by the user.

FIG. 16 illustrates an embodiments of the wearable device 98 and how it may rest on a glove 108 that may include a buckle 190. It is common for a winter glove 108 to have a strap and buckle 190 which introduce some volume at the wrist position. As shown on FIG. 16, the portable electronic device 200 may include a bottom cavity 134 according to various embodiments to partially or fully contain the buckle 190 when sitting on the glove 108 at wrist position. When buckle 190 is partially or fully contained in bottom cavity 134, the portable electronic device 200 (or wearable device 98) sits more comfortably and securely on the glove at wrist position. For different gloves and different users, the buckle may be at different positions. In various embodiments, the bottom cavity 134 is sufficiently large to allow for various buckle positions. In various mechanisms, the bottom cavity 134 can serve a dual-purpose functionality: it can provide a mechanism to detachably couple various mounting adaptors, and it also can provide a mechanism for the portable electronic device 200 to sit on the glove at wrist position securely and more comfortably.

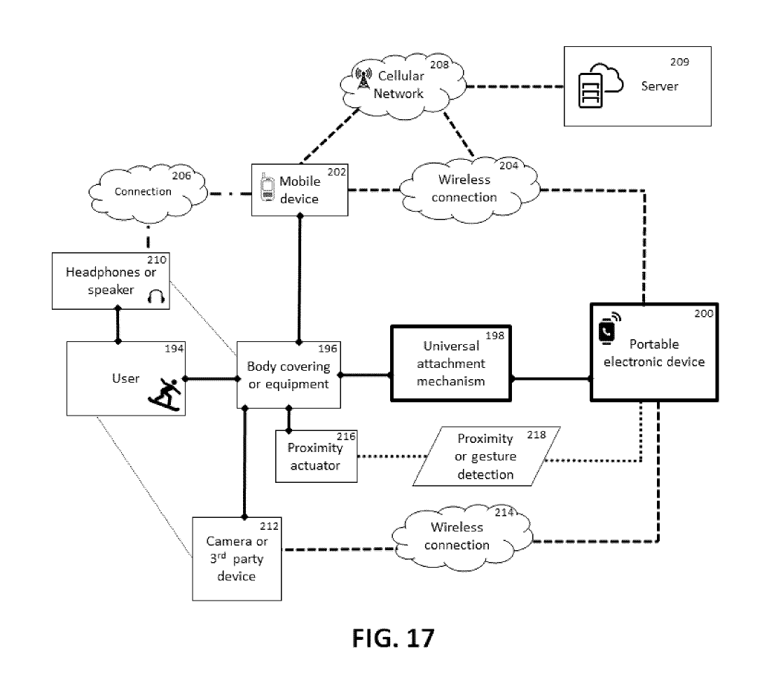

FIG. 17 is a schematic diagram illustrating various embodiments the portable electronic device 200, which is a generalized representation of the portable electronic device 200, with universal attachment mechanism 198. The user 194 maybe physically connected to a plurality of body coverings or equipment 196 or objects. By way of example only a body coverings or equipment 196 may be clothing in general or objects such as snow-pants, glove, hat, jacket, a helmet, backpack, snowboard, a snowmobile or the like that may be carried or operated by the user 194. In various embodiments, the universal attachment mechanism 198 facilitates coupling or connecting the portable electronic device 200 to the body covering and equipment 196 or objects. In various embodiments, the user 194 can secure the combination of the portable electronic device 200 and universal attachment mechanism 198 to a preferred position of the body covering or equipment 196. As shown on FIG. 17, the user 194 may wear headphones or speaker 210 which may be attached to a body covering or equipment 196 such as a backpack, helmet or snowboard. In various embodiments, the user 194 may carry a mobile device 202 which is secured to a body covering or equipment 196. By way of example only, the mobile device 202 could be secured in a jacket's pocket. The mobile device 202 may be small personal computing device or system such as a Smartphone, mobile phone, music player, Personal Digital Assistant (PDA) or the like. In various embodiments, the mobile device may be connected to a cellular network 208, or other wireless communication networks (not shown) allowing it to communicate with other mobile devices to send and receive voice or data. In various embodiments, the cellular network 208 may be connected to one or several remote server(s) 209 that may facilitate storage, processing and transmission of information to and from the portable electronic device 200. In various embodiments, the portable electronic device 200 may communicate with one or more servers 109 via a wireless connection 204 or 208 to send or receive data. In various embodiments, two or more portable electronic device 200 may communicate with each other by sending or receiving data to or from the remote servers 209 facilitated by wireless connection 204 or 208. In various embodiments, headphones or speaker 210 may be connected to mobile device 202 (or the portable electronic device 200) via a cable or wireless connection 206. In various embodiments, the user 194 may also optionally carry a camera or 3rd party device 212 or other external devices capable of wireless connection. In various embodiments, the portable electronic device 200 may communicate with the mobile device 202 via a wireless connection 204. For example, the wireless connection 204 can be established over Bluetooth®, WiFi or by any other wireless connectivity technology. The user 194 may utilize the portable electronic device 200 to control various functionalities of the mobile device. By way of example only:
A user 194 listening to music via headphones or speaker 210 can operate the portable electronic device 200 to pause, play, change volume or skip tracks.
A user 194 can operate the portable electronic device 200 to activate a call functionality such as making calls, answering calls or rejecting calls.
A user 194 can operate the portable electronic device 200 to perform PTT operation to communicate to a preferred group.
A user 194 can operate the portable electronic device 200 to remotely browse various computer-readable codes (e.g. software codes), applications or menus on their mobile device 202. This may include one or more of the following: (i) selecting and calling a phone contact; (ii) selecting a preferred group to communicate with over PTT; (iii) adjusting various settings; and (iv) selecting and launching a preferred music application.
A user 194 can operate the portable electronic device 200 to perform voice activated commands. A user 194 can receive notifications that alert the user or provide status updates. These indicators can be in the form of audio (buzzer or speaker), visual (light indicator or display), or haptic feedback.
A user 194 can operate the portable electronic device 200 to facilitate user identification for access control (e.g. at chair lift) or payment using integrated radio-frequency identification (RFID) technology
A user 194 can operate the portable electronic device 200 to use the navigation functionality for finding peers or way finding using visual indicator such as an array of LEDs.

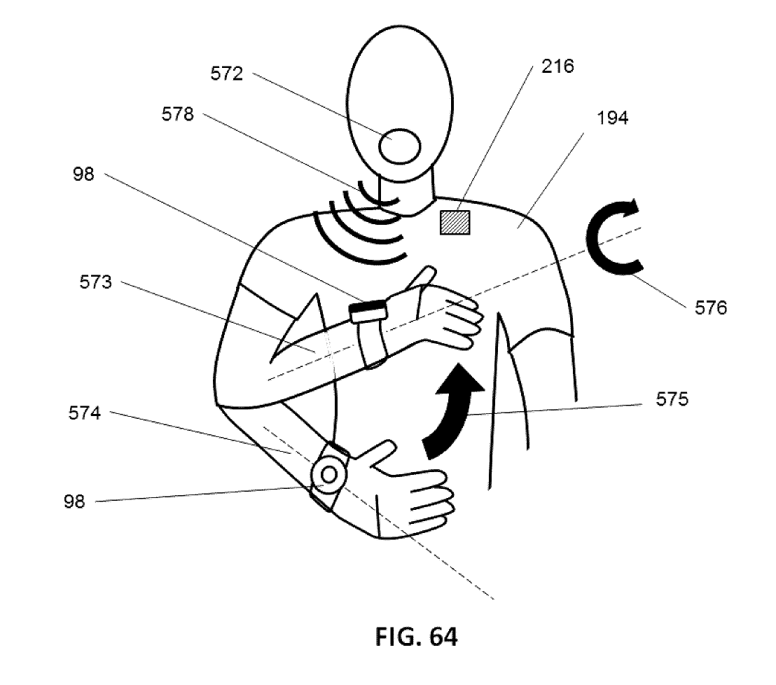

In various embodiments, the portable electronic device 200 may be configured to facilitate hands-free PTT. The hands-free functionality can allow a user 194 to activate PTT without the need to touch a button, allowing a user to communicate over PTT. In such embodiments, the portable electronic device 200 may be configured to facilitate hands-free PTT via proximity detection, gesture detection, or a combination of proximity and gesture detection. In other embodiments voice recognition may be used by portable electronic device 200 to facilitate hands-free PTT. This is illustrated in FIG. 64, where the user 194, who is wearing the wearable device 98 on their glove at wrist position (see FIG. 2), intends to activate the hands-free functionality by one or a combination of:
(a) moves their arm 575 from rest position 574 to an elevated arm position 573 so the wearable device 98 is close to the user's mouth 572,
(b) moves their arm in a rotary matter 576 at an elevated arm position 573 so the wearable device 98 is close to the user's mouth 572,
(c) moves the wearable device 98 within range of the proximity actuator 216, or
(d) starts speaking 578 into the wearable device 98.

In various embodiments, the portable electronic device 200 of the wearable device 98 may include a plurality of sensors that facilitate detection of the above mentioned gestures (and other gestures) and proximity detection 218. In various embodiments, when the portable electronic device 200 is within close proximity of the proximity actuator 216 the hands-free PTT functionality is turned activated, permitting user to talk and communicate over PTT. In various embodiments, the proximity actuator 216 may be separate and apart from the portable electronic device 200 and configured to: (i) detachably attach to an item of apparel of the user; or (ii) detachably attach to the user; or (iii) detachably attach to objects. In various embodiments the proximity actuator 216 may be configured to operate when attached to an item of apparel or the user so as to be located generally near the upper torso, neck or head of the user. In various embodiments, the proximity actuator 216 may be configured operate when attached to an object (such as a snowmobile fuel tank, seat or handlebar). The PTT function may be deactivated when the portable electronic device 200 and proximity actuator 216 are no longer in close proximity. The proximity actuator 216 may be detachably secured to a user's preferred position of a body covering or equipment 196. By way of example only, the proximity actuator 216 can be clipped or fastened to a jacket pocket edge, jacket collar, helmet, other item of apparel or to equipment such as a snowmobile. In one embodiment, a proximity actuator 216 may be shaped as a clip 500 is shown in FIG. 63. The proximity actuator 216 in such embodiment may be a flexural spring 500 with integrated teeth 552 such that it can be securely (and detachably) fastened to a jacket. In various embodiments the proximity actuator may be secured close to a user's mouth 572. In various embodiments, a permanent magnet 551 may be integrated within clip 500, and generates a small, but readily detectable, magnetic field 553 (<100 mT) within a few tens of centimeters (<100 cm) of the proximity actuator 216. This magnetic field 553 is detected by a sensor, such as a magnetic hall-effect sensor 432, inside the portable electronic device 200. The magnitude of this magnetic field 553 allows the portable electronic device 200 gauge how close it is to the proximity actuator 216 (and thus to the user's mouth 572). In various embodiments, when a user 194 wishes to communicate via hands-free PTT, he or she positions the portable electronic device 200 within a predetermined proximity of the proximity actuator 216 and starts speaking 578. When the user is finished communicating, he or she can deactivate the PTT functionality by moving the portable electronic device 200 away from close proximity of proximity actuator 216, which the portable electronic device 200 is configured to detect as a trigger to deactivate the PTT functionality.

In various embodiments, the portable electronic device 200 includes a plurality of sensors to allow detection of pre-defined gestures or a set of gestures which activate or deactivate the PTT function. In various embodiments, when a user 194 is wearing the portable electronic device 200 (or wearable device 98) on their glove at wrist position, a preferred gesture (sequence of movements or events) may have one or a combination of the following steps:
1. User 194 moves their hand 575 with the portable electronic device 200 towards their mouth 572;
2. User 194 positions their hand such that the top surface of the portable electronic device 200 faces the user's face and is in close proximity to the user's face. This will turn the hands-free PTT functionality on and the user 194 can start communicating via voice 578;
3. User 194 moves their hand away from close proximity of their face, or turns their hand such that the top surface of the portable electronic device 200 and user's face to only somewhat face one another or no longer face one another. This will turn the hands-free PTT off.

In various embodiments, the portable electronic device 200 may also connected to a camera or 3rd party device 212 via a wireless connection 214. The portable electronic device 200 may be capable of wirelessly (or via wired communication—not shown in the figures) controlling various functionalities of the camera or 3rd party device 212. For example, the user 194 can operate the portable electronic device 200 to take pictures or videos.

As illustrated on FIG. 18, in various embodiments the portable electronic device 200 may include a plurality of sub-systems, electronic components and circuits. In various embodiments the list of electronic sub-systems and components are illustrative only. In addition, not all the sub-systems and components shown are required for various embodiments or to support various functionality. The processing module 238 may include a plurality of microprocessors or processors which interacts with other sub-systems and modules. The Real Time Clock (RTC) 240 may provide a mechanism for the processing module 238 to be informed of the current time. The power module 250 may facilitate power to all sub-systems and may support various power related functions. The battery 252 may be rechargeable and functions properly even in cold or extreme cold temperatures. The power management and voltage regulation module 254 may report power-status information to the processing module 238, regulate the power, and follow various commands from the processing module 238. For example, in such an embodiment the power management and voltage regulation module 254 may inform the processing module 238 that battery is low and may use this information to trigger power saving features. The charging module 256 may facilitate the charging of the battery 252 when the portable electronic device 200 is connected to a power source via connector 242. The charging module may include a wireless charging capability based on inductive charging where switched currents on a coil in the base of the charger induce opposing current in the coils inside the charging module 256. In various embodiments, the battery 252 may be charged using a wireless charging mechanism (e.g. magnetic induction). In various embodiments, a connector 242 allows the portable electronic device 200 to be connected to a power source or a computer to charge the battery 252 or to update the processing module's computer-readable codes (e.g. software codes). In various embodiments, a display module 236 communicates with the processing module 238 to display various information. The display module 236 may include a touch screen module (not shown) to allow touch-screen input capability. The wireless module 248 allows the portable electronic device 200 to establish a connection and exchange data communicate with external devices such as a mobile device 202 or a camera or 3rd party device 212 via the wireless module 248. In various embodiments, the wireless module 248 may include various components such as Bluetooth® (e.g., Bluetooth® Low energy), WiFi (e.g., 802.11n), Cellular (e.g., LTE, CDMA, GSM/GPRS, UMTS/HSPA, 2G, 3G, or 4G), NFC (e.g. NFCIP-2 or GSMA), RFID transceiver, or antennas to facilitate wireless communication between the portable electronic device 200 and an external entity. By way of example only, external entities the portable electronic device 200 can communicate with include one or more of the following: mobile phones, PDAs, the cellular network, point of sale devices, security gates at ski lifts, 3rd party devices such as a camera. In various embodiments the wireless module 248 may include a passive RFID tag to allow the detection or identification of the portable electronic device 200 by an external entity. In various embodiments, the portable electronic device 200 may include various buttons or knobs 262 as well as a touch-screen to allow a user 194 to operate the portable electronic device 200. In various embodiments, a vibration module 260 may provide a user 194 with haptic feedback or notifications. In various embodiments, a plurality of status lights 264 may provide a user with various notifications. In various embodiments, the portable electronic device 200 may include one or more status lights 264, or an array of lights 264 capable of producing one or more colors. The portable electronic device 200 may include camera module 258 which is capable of capturing and storing pictures or videos. In various embodiments, the portable electronic device 200 can exchange pictures and videos or stream videos to a mobile device 202 over wireless connection 204 via wireless module 248.

In various embodiments, the portable electronic device 200 includes a speaker module 244 and a microphone module 246. A microphone module 246 may contain one or more than one microphone (spatially separated) which may help minimize interfering background noise. In various embodiments, a speaker module 244 may include audio transducers such as speaker, buzzer, piezoelectric actuators, beeper, driver circuit, filtering circuit to facilitate the portable electronic device 200 to generate sound. By communicating with the mobile device 202, the portable electronic device 200 determines whether the mobile device 202 is connected to a headphone or speaker 210 and whether the headphone or speaker 210 includes a microphone. Knowing this information, the portable electronic device 200 will activate or deactivate the speaker module 244 and a microphone module 246. For example, in such embodiment the speaker module 244 and a microphone module 246 are utilized when the mobile device 202 is not connected to headphone or speaker 210. When the mobile device 202 is connected to a headphone or speaker 210 that does not include a microphone, the speaker module 244 is deactivated and microphone module 246 is utilized. When the mobile device 202 is connected to a headphone or speaker 210 that does include a microphone, the speaker module 244 and microphone module 246 are both deactivated. The user 194 can also manually activate or deactivate the microphone module 246 or speaker module 244. This allows the portable electronic device 200 to work with any headphone or speaker 210 and even without it. The portable electronic device 200 can form independent audio channels with mobile device 202 via wireless connection 204 and the wireless module 248 to send or receive audio. For example, in such embodiment the microphone module 246 can transmit audio to mobile device 202 via the wireless module 248 when the touch free PTT functionality is on, allowing user 194 to broadcast their voice to another user or a group of users. Similarly, when the user's 194 mobile device 202 receives audio from PTT it can route the voice audio through wireless connection 204 and broadcast it using speaker module 244.

In various embodiments the speaker module 244 may contain a circuit component dedicated for the text-to-speech (TTS) functionality (such as NLP-5x chip by Sensory Inc.) which facilitates synthesis of language recognizable by a user (in form of audio). The TTS module is activated and controlled by the processing module 238, which may send a text data (an array of machine-readable ASCII codes) over standard data bus (such as 12C), and may subsequently generate an audio output in form of a speech. In one exemplary embodiment, in response to a press of a button by the user the processing module 238 may inform the user of the time of the day; in such embodiment, the TTS module may receive a string of ASCII codes of the current time from the processing module 238 (read from the real-time clock 240) and synthesize the audio output which may then be sent to the audio amplifier and integrated speaker.

In various embodiments, the portable electronic device 200 may be configured to facilitate voice control functionality. In one embodiment of the voice control functionality the audio from the user 194 may be received by the microphone module 246 and sent to the processing module 238 in response to press of a button (e.g., side button 104). The processing module 238 may then choose one or more of the following options:
(a) process the audio data using (i) a voice recognition algorithm inside the processing module 238 of the portable electronic device 200, or (ii) a secondary voice processing module (not shown) that may contain a chip (such as NLP-5x chip by Sensory Inc.) to recognize which predetermined functionality the user wants to activate;
(b) send the audio data to the processor inside the user's mobile device 202 via the wireless connection (e.g., Bluetooth®). The processor inside the user's mobile device 202 may then choose one or more of the following options:
   a. process the audio data using a voice recognition algorithm inside the processor of the user's mobile device 202 to recognize the predetermined functionality the user want to activate and may send a corresponding command back to the processing module of the portable electronic device 200; or,
   b. send the audio data to a remote server 209 using the wireless cellular network connection 208 capability of the user's mobile device 202 to activate a web-based voice recognition service (e.g. custom algorithm or commercial service such as Amazon Alexa). The recognized voice command may then be sent back from the remote server 209 to the user's mobile device and subsequently to the portable electronic device with a corresponding command to activate the recognized predetermined functionality.

By way of example, in various embodiment of the voice control functionality, the user may articulate a command by voice such as “YodelUP, what time is it?” which the portable electronic device 200 may recognize and may subsequently activate the light array 542 to indicate the time of the day to the user. In another example of the various embodiments of the voice control functionality the user may articulate a text message command such as “YodelUP, text John Doe: Hey John, let's meet for lunch at the north peak at noon.” which the portable electronic device 200 may recognize the command and first send the text message data to the user's mobile device 202 that may then send a text message “Hey John, let's meet for lunch at the north peak at noon.” To John via the cellular network connection 208 of the user's mobile device 202.

In various embodiments, the portable electronic device 200 may include a plurality of sensors 220 to allow one or more functionalities such as GPS location and time sensing, compass sensing, altitude sensing, temperature sensing, speed sensing, proximity detection, orientation sensing or gesture recognition. The processing module 238 may aggregate and process the data from sensors 220 to support the aforementioned functionalities.

In various embodiments, the sensors 220 may include one or more of the following: accelerometer 222 which may provide three-dimensional acceleration information, GPS 224 which may provide real-time location and time information, Pressure sensor 226 which may provide altitude information, temperature sensor 228, Magnetometer 230 which may provide magnetic field direction information, Gyroscope 232 sensor which may provide angular rate information, and proximity sensors 234 which may provide proximity detection for hands-free PTT functionality.

In accordance with one embodiment, various aspects and features may be realized in hardware and software or a combination of hardware and software and not limited to methods described. The electronics may include other modules than specified on FIG. 18 and in writing. For example, in such embodiments the speaker module 244, microphone module 246, camera module 258, gyroscope 232 sensor, accelerometer 222, or display module may not be included in the portable electronic device 200. Furthermore, the hardware may include additional electronics such as a transceiver, display or avalanche reflector.

Proximity detection for hands-free PTT can be facilitated with one or more of the following:
1. A magnetic proximity system where the proximity actuator 216 includes a small magnet, and proximity detection 234 is a magnetic field sensor;
2. An Inductive proximity system, where the proximity actuator 216 includes a conductive loop, and proximity detection 234 is inductance sensor;
3. A Radio Frequency Identification Systems (RFID), where the proximity actuator 216 includes a RFID tag, and proximity detection sensor 234 is a RFID reader;
4. An Infrared proximity detection system, where the proximity detection sensor 234 is an infrared proximity sensor.

Gesture detection for hands-free PTT can be facilitated in various ways. In various embodiments, gesture detection may be facilitated using an Infrared proximity detection system, an Accelerometer 222, a Gyroscope 232 and a Magnetometer 230. In such embodiments, the infrared proximity detection system senses whether the portable electronic device 200 is in close proximity to a surface such as the user's face. In such embodiments, the Accelerometer 222, a Gyroscope 232 and a Magnetometer 230 are utilized to determine the orientation of the portable electronic device 200 relative to the user 194. In one embodiment, a hands-free PTT functionality may be activated when the portable electronic device 200 is in close proximity to a surface and the orientation may suggest that the portable electronic device 200 is facing the user's face. If the portable electronic device 200 is in close proximity to a surface and the portable electronic device 200 orientation indicates that it is not facing the user, the PTT functionality may not activated. If the portable electronic device 200 is not in close proximity to a surface, the PTT functionality may be deactivated.

In various embodiments, the processing module 238 may aggregate or exchange data with mobile device 202 via wireless module 248 to support additional functionalities. The mobile device 202 has access to data from cellular network 208, its internal sensors and other devices which may be connected to it. In various embodiments, exemplary additional functionalities may include one or more of the following: displaying weather information, displaying time information, displaying ski lift status information, heart rate monitoring, displaying location on a map and navigation, sharing location with contacts, displaying location of contacts that have shared their location or displaying battery status information.

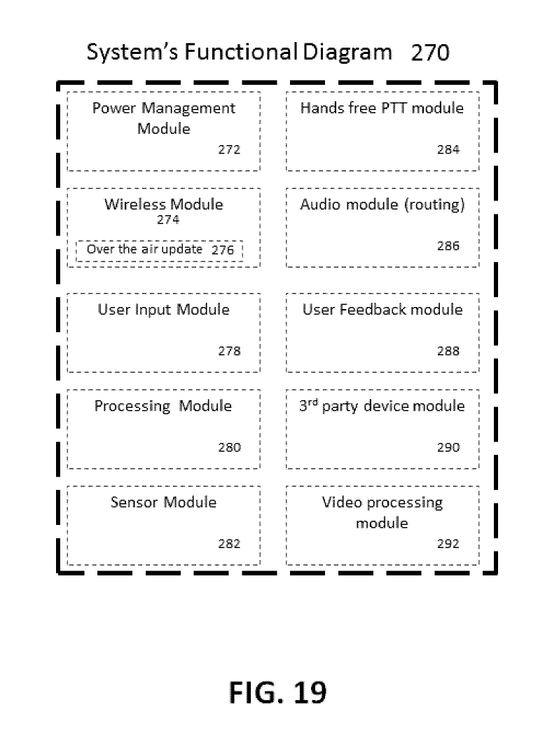

The system's functional diagram 270, shown in FIG. 19, illustrates the software (machine-readable code) embodiment included in the portable electronic device 200 according to various embodiments. In various embodiments, the computer-readable codes (e.g. software codes) may be stored in the memory 266 and executed by the processor module 238. Said computer-readable codes may include and represent a plurality of modules including Power Management Module 272, Wireless Module 274, Over the Air Update Module 276, User Input Module 278, Processing Module 280, Sensor Module 282, Hands-free PTT Module 284, Audio Module 286, User Feedback Module 288, 3rd Party Device Module 290 and Camera Module 292. In various embodiments, each of aforementioned modules may be responsible for at least one procedure or functionality and in combination with other modules in the system's functional diagram allows the portable electronic device 200 to perform various capabilities described. In various embodiments the list of modules are not limited to the ones illustrated on FIG. 19. In addition, in various embodiments not all the modules are required as part of the portable electronic device 200.

More generally, in various embodiments, the portable electronic device 200 may include and execute its own stand-alone computer-readable codes and need not be dependent on a mobile device 202 connection (wired or wireless). In various embodiments, the portable electronic device 200 may perform various stand-alone functions. In various embodiments, when connected to a mobile device 202 the portable electronic device 200 may perform an expanded set of functionalities. In addition, in various embodiments a portion of the aforementioned computer-readable codes may be loaded and executed on the mobile device 202 instead of on the portable electronic device 200. For example, in such embodiment a portion of the PTT software may be loaded and executed on the portable electronic device 200, and another portion of the PTT software may be loaded and executed on the mobile device 202 when the mobile device 202 is in communication with the portable electronic device 200.

In various embodiments, the Power Management Module 272 may control power to all or substantially all subsystems and electronic components illustrated on FIG. 18 and may provide the majority of operations associated with power operations. In various embodiments, the electronic components or subsystems may have various configurable power states, wherein the power states may configure the components or subsystems to consume a predetermined amount of power. By way of example only, in one embodiment, the power states may include one or more of the following:
Power off state: The subsystem or electronic component consumes no power
Hibernate state: The subsystem or electronic component may consume generally minute amount power (less than sleep state 1)
Sleep state 1: The subsystem or electronic component may consume generally little amount power (generally less than sleep state 2, but generally more than hibernate state)
Sleep state 2: The subsystem or electronic component may consume little amount power (generally more than sleep state 1, but generally less than active state 1)Active state 1: The subsystem or electronic component may consume generally medium amount of power (generally more than sleep state 2, but generally less than active state 2)
Active state 2: The subsystem or electronic component may consume generally high amount of power (generally more than active state 1, but generally less than active state 3)
Active state 3: The subsystem or electronic component may consume generally a very high amount of power (generally more than active state 2)

In various embodiments, the Power Management Module 272 may manipulate power states of subsystems or components. In various embodiments, the Power Management Module 272 may configure the system power state (e.g. power state of the portable electronic device 200) by manipulating a plurality of subsystem or electronic component power states.

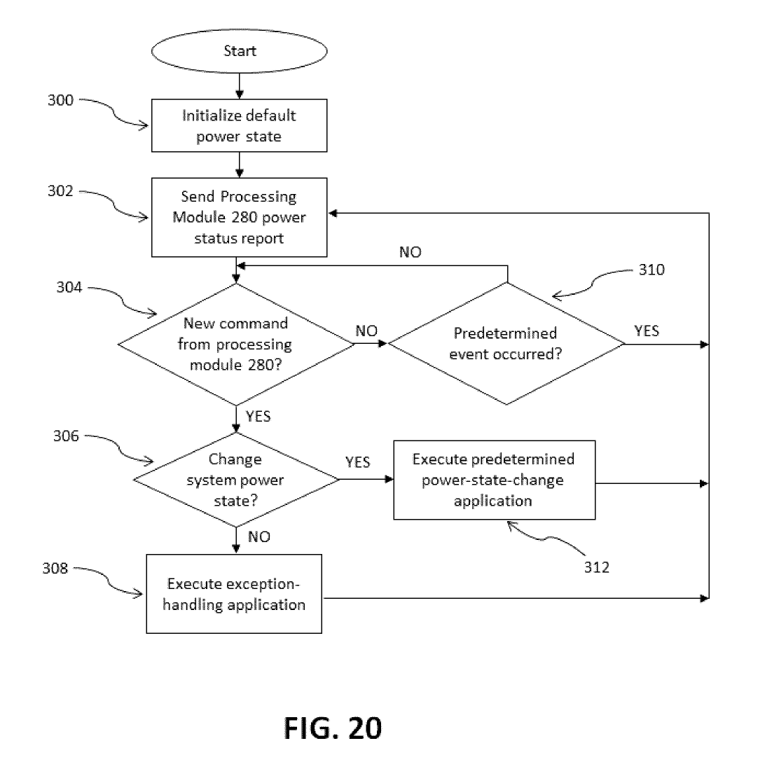

Referring to FIG. 20, in accordance with one embodiment, there is shown an illustrative flowchart of the tasks and procedure (via computer-readable codes such as software codes) which may be executed by Power Management Module 272. When the task or procedure starts (e.g. when the portable electronic device 200 is powered on), the system may be initialized to a predetermined system power state 300—where the power of subsystems and electronics components are configured to a predetermined power state.

The power status report 302 of system power state, list of component power states, battery level, charging status, overall system power status (e.g. “power good” status) may be sent to the processing module 280. In this specification, battery level indicated an estimated value on how much remaining energy may be contained in battery 252. In this specification, charging status indicates whether the battery is currently being charged, is fully changed, or if it is not being charged. For example, the “power good” status indicates that the power module 250 is operating as expected with regards to powering the electronic components and subsystems of the portable electronic device 200.

In various embodiments, the Power Management Module 272 may check if a command from processing module 280 has been received (304). If multiple commands have been received, they are queued and processed one by one. If a command has been received from the processing module 280, then the Power Management Module 272 checks whether the command is intended to change the system power state 306, component or subsystem power states. In the condition that a power state change command is received, the power-state-change application 312 is executed, where the Power Management Module 272 configures the system or subsystem, or electronic component power state to what the power state change command indicates. The power-state-change application 312 includes a list of predetermined system power states and executes the procedure to configure a plurality of subsystems and electronics components of the portable electronic device 200 to power states requested. By way of example only, predetermined system power states may include one or more of the following:
System Power Off State: All subsystem or electronic component are configured to System Power Off State
System Hibernate State: The subsystem or electronic component may consume generally minute amount power (generally less than System Sleep State)
System Sleep State: The subsystem or electronic component may consume generally little amount power (generally less than System Active State 1, but generally more than System Hibernate State)
System Active State 1: The subsystem or electronic component may consume generally some amount power (generally less than System Active State 2, but generally more than System Sleep State)
System Active State 2: The subsystem or electronic component may consume generally high amount power (generally more than System Active State 1)

Once the requested power state change has been completed, a power status report 302 may be sent to processing module 280 to update the system. If the command from processing module 280 is not a power state change request, then the exception-handling application may be executed 308. In one embodiment, the exception-handling application accept and executes various commands including one or more of the following:
Power Management firmware update: This may be executed in the special case that the machine-readable codes (e.g. software codes) of the portable electronic device 200 is being updated either by way of over the air update 276 or via connectors 242
Power failure: In case one or more electronic component or subsystem experience power failure this procedure may be executed to detect the problem and take appropriate action.
Running tests: This procedure may be executed to perform a test related to power. This may include tests on portable electronic device 200 components such as the battery 252 or subsystems such as the sensor module 250. The test may be passed if all electronic component and subsystems of FIG. 12 operate within the expected limits for each power state.
Error handling: In case of certain type of errors some modules are restarted or shut down and error are logged and stored in memory module 256.

In case no new command is received (304), then the Power Management Module 272 checks if a predetermined event 310 has occurred. An exemplary predetermined event may be: a predetermined amount of time has passed (e.g. one second). Another example of a predetermined event may be: the power state of a plurality of component or subsystems of the portable electronic device 200 has changed. In the case no predetermined event 310 occurs, the Power Management Module 272 may check for new commands that may have been received 304. In case a predetermined event has occurred, the Power Management Module 272 updates the power status report (not shown on diagram) and sends the power status report to processing module 280.

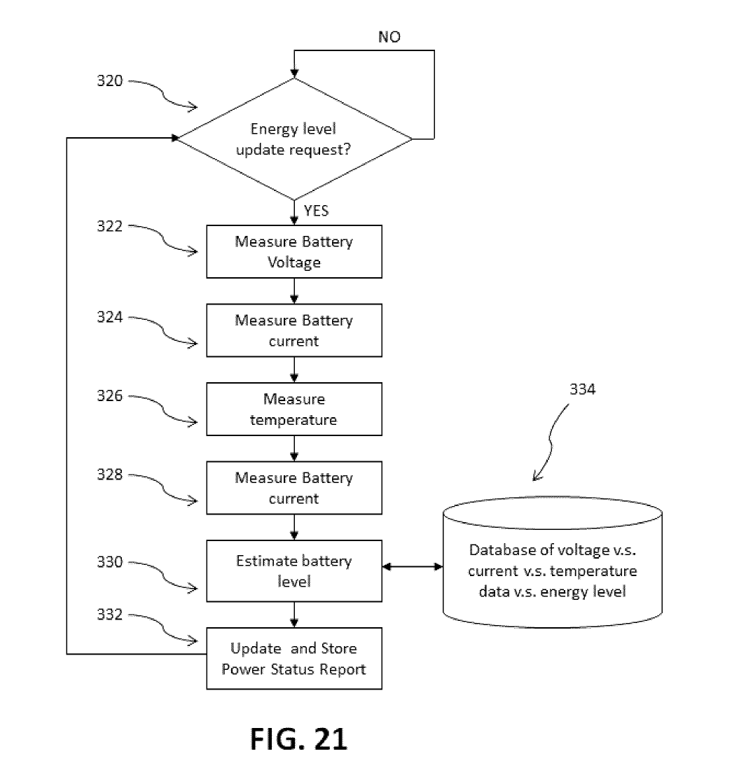

In various embodiments, the Power Management Module 272 may be capable of estimating the battery level. Battery level, in this specification, refers to the amount of extractable energy left in the battery 252. A battery level may typically change with temperature or the amount of current draws from them. Since the portable electronic device 200 may be configured for operation in cold or extreme cold temperatures, in various embodiments it is preferred that it accurately estimate battery level. FIG. 21 illustrates a flow chart of an embodiment of tasks and procedures (software) executed by the Power Management Module 272 to facilitate the estimation of battery level. In one embodiment, when an energy level update 320 is requested by the Power Management Module 272, first the battery voltage 322 is measured and stored in memory 266. Next, the output current of the battery 324 is measured and stored in memory 266. Next, the temperature at a location of predetermined proximity to the battery is measured 326 and stored in memory 266. The Power Management Module may include a database 334 of previously tested and measured battery data 334. The database 334 may contain data regarding what the energy level is for a given voltage, current and temperature. The battery energy level may be estimated 330 by comparing the database data 334 and measured voltage 322, current 324 and temperature 326. Once the battery level estimation 330 is complete, the power status report may be updated and stored in memory 266.

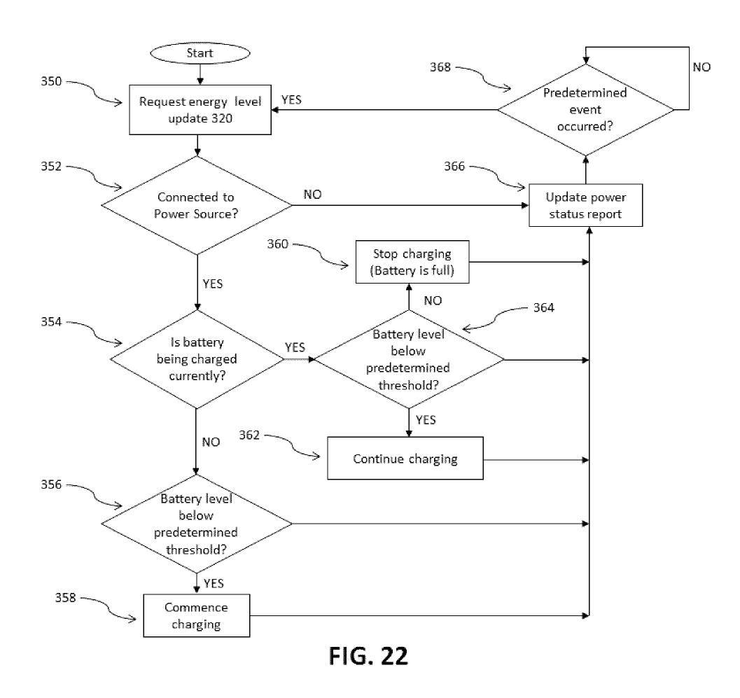

In various embodiments, the Power Management Module 272 facilitates the charging of battery 252. FIG. 22 is a flow chart that illustrates an embodiment of the procedures and tasks (software) executed to facilitate the charging of battery 252. In one embodiment, the Power Management Module 272 may first request an energy level update 320, 350. Next, the portable electronic device 200 may check whether the portable electronic device 200 is connected or coupled to a power source 352 via connector 242 or a wireless charging station that coupled or connected to a wireless charging unit in 256. If the portable electronic device 200 is not coupled or connected to a power source, then the power status report 366 may be updated and stored in memory 266. Next, the Power Management Module 272 may wait until a predetermined event 368 occurs. An exemplary predetermined event may be based on time (e.g. if a predetermined amount of time passes). Another example of a predetermined event may be: the power state of a plurality of predetermined component or subsystems of the portable electronic device 200 changes. Another example of a predetermined event may be: a new command is received from processing module 280. In the case a predetermined event 310 occurs the system may check energy level update 320 and 350.

In case the portable electronic device 200 is connected to a power source, the Power Management Module 272 may check whether the battery is currently being charged—i.e. the power status report 366 indicates that the battery 252 is being charged. If the battery 252 is not being charged and has a battery level below a predetermined threshold 356 (by way of example only, a predetermined threshold may be 95 percent battery level according to one embodiment), then the charging application 358 may be executed. The charging application 258 detects the type of power source connection and reads the current battery level from power status report 322, 366 stored in memory 266 to charge the battery at a predetermined appropriate voltage and current (e.g. 3.2 Volts at 100 milliamps). Next, the power status report 366 may be updated to indicate that the battery is charging and then stored in memory 266. Next, The Power Management Module 272 waits until a predetermined event 368 occurs. In the case a predetermined event 310 has occurred the system will check an energy level update 320 and 350.

In one embodiment, in case that the portable electronic device 200 is coupled or connected to a power source 352 and the power status report indicates that the battery is currently being charged 354, the battery level is checked 364 to see if it is below a predetermined threshold (by way of example only, a predetermined threshold may be 95 percent according to one embodiment). In the case that the battery is below the predetermined threshold 364 (by way of example only, a predetermined threshold may be 99 percent according to one embodiment), the charging application will continue charging 362 the battery 252. Then, the power status report 366 is updated to indicate that the battery is charging and then stored in memory 266. Next, The Power Management Module 272 wait until a predetermined event 368 occurs. In the case a predetermined event 310 has occurred the system will check an energy level update 320,350.

In one embodiment, in the case that the battery is not below the predetermined threshold 364, the charging application will stop charging 360 the battery 252 in case it has not been previously stopped. The Power Management Module 272 also stops executing the charging application in case it has not been previously stopped. Next, then the power status report 366 is updated to indicate that the battery is full and not charging and then stored in memory 266. Then, The Power Management Module 272 wait until a predetermined event 368 occurs. In the case a predetermined event 310 occurs the system will check an energy level update 320 and 350.

In various embodiments, the wireless module 274 may execute tasks and procedures (computer-readable codes such as software codes) to support wireless communication and may be responsible for the following:
Establishing connection between the portable electronic device 200 and an external entity (or entities) to communicate with them wirelessly via connection 204 or 214. Examples of external entities the portable electronic device 200 can communicate with include one or more of the following: mobile phones, PDAs, the cellular network, point of sale devices, security gates at ski lifts, 3rd party devices such as a camera or drone. The wireless data transmission, reception and exchange may be by way of a Bluetooth®, near-field communication (NFC), radio frequency identification (RFID), WiFi, or Cellular connection type or another wireless form of communication. It is common practice for those skilled in the art that each connection type follows a communication protocols and standard well-known in the art (usually based on the Open Systems Interconnection model (OSI model)). In various embodiments, the wireless module 274 executes the procedure to facilitate the portable electronic device 200 to conform with one or more of these standard communication protocols to facilitate connection and communication with external entities using the same connection type.
The wireless module 274 receives data from the wireless connection 204 or 214 and forwards it to the one or more modules in the system's functional diagram 270. For example, audio data may be forwarded to in such embodiment the audio module 286, data from a 3rd party device may be forwarded to the 3rd party device module 290, user input data from a mobile device 202 may be forwarded to the user input module 278, and data indicating incoming call on mobile phone may be forwarded to processing module.
The wireless module 274 may accept and execute commands received from the processing modules 280. Commands from the processing module 280 may include, but not limited to one or more of the following:
   Requesting the wireless module 274 to discover nearby Bluetooth® devices, WiFi network or cellular network;
   Requesting the wireless module 274 to connect or disconnect from nearby Bluetooth® devices, WiFi network or cellular network;
   Requesting the wireless module 274 to send predetermined data via a specific communication protocol. By way of example only, if connected via Bluetooth®, the processing module 280 may request the wireless module 274 to send the “next track” data via the Bluetooth® HID Profile (a standard communication protocol). In another illustrative example, if connected via Bluetooth®, the processing module 280 may request the wireless module 274 to send predetermined data via the Bluetooth® Serial Port Profile (a standard communication protocol). In another illustrative example, if connected via Bluetooth®, the processing module 280 may request the wireless module 274 to send “answer call” data via the Bluetooth® hands-free Profile (a standard communication protocol) and to receive audio data from the audio module 286.
The wireless module 274 may receive data from module in the system's functional diagram 270 and send the data to the external entity via a wireless connection 204 or 214. By way of example only, in such embodiment the audio data may be received from the audio module 286 and forwarded to an external entity, or 3rd party data may be received from the 3rd party device module 290 and forwarded to an external entity.
The wireless module 274 accepts and executes power state change commands received from the processing power management module 272. For example, upon request from the power management module 274, the wireless module 274 may change the state of the WiFi transceiver to Sleep State 2 or reduce the transmission power of the Bluetooth® transceiver.

In various embodiments, the wireless module 274 may receive software update data or system software update data from a wireless connection. The software update may be for one or more or all the modules in the system functional diagram 270 and may be completely or partially transferred and stored in memory 266. The wireless module 274 executes the update procedure such that the portable electronic device 200 software (or computer-readable codes) is replaced with the version downloaded via a wireless connection. The processing module 280 may assist the wireless module 274 in executing the update procedure. This is common practice for those skilled in the art and is referred to as “over the air update.”

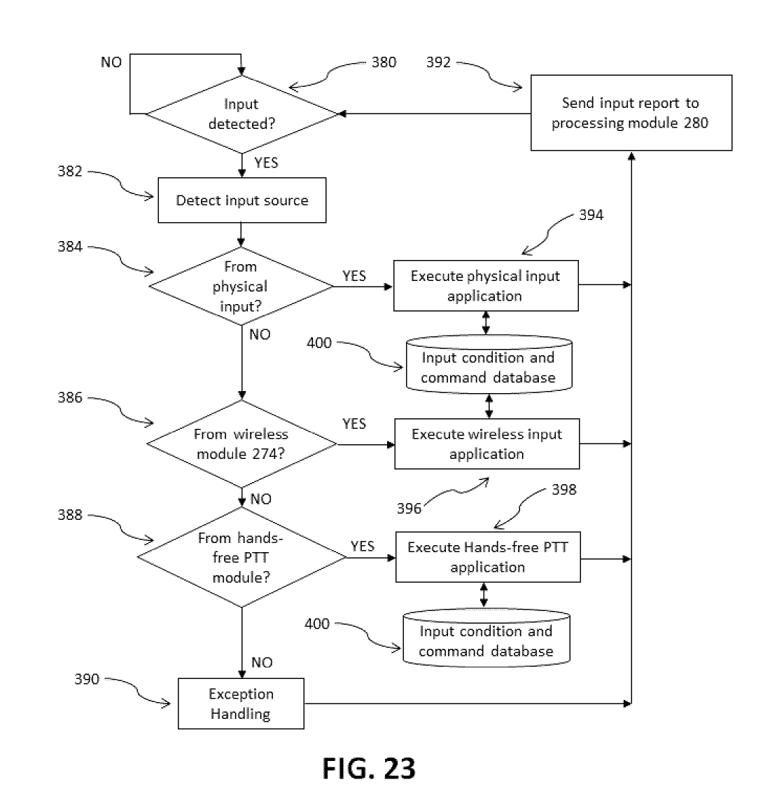

In various embodiments, the portable electronic device 200 may accept user inputs via one or more various mechanisms including one or more of the following: knobs, rotational input mechanisms, joystick, touch screen, capacitive touch, pressure sensitive buttons, touch free PTT, gesture recognition and input from external entity via wireless module 274. FIG. 23 illustrates a flowchart of tasks and procedures (software) executed by the user input module 278 in various embodiment to facilitate processing of user inputs, generating input reports 392 and sending the input reports 392 to the processing module 280.

In various embodiments, the input module 278 waits for an input to be detected 380. An input may be detected in one or more ways including:
Upon a button press or knob movement, the input voltage at one of the processing module 238 input pins changes and an interrupt occurs. The interrupt informs the input module that an input was detected;
Upon receiving a command from the wireless module 274; or
Upon receiving a command from the Hands-free PTT module 284.

When an input is detected 380, the input module 278 checks the source of the input 382 and stores this information in memory 266. In case of a physical input (bottom, knob, switch, slider, touch screen), the physical input application is executed 394. In case the input is from the wireless module 386 the wireless input application is executed 396. By way of example only, when a user presses a button, touch screen or a similar input mechanism on mobile device 202 or 3rd party device 212, the mobile device 202 or 3rd party device 212 may inform the portable electronic device 200 about the user input over connection 204 or 214. In case the input is from the hands-free PTT module 388, the hands-free PTT application is executed. The physical input application 394, stores and queues all physical input events in memory 266 including the occurrence time. The physical application 394 processes the input(s) and determines what type of predetermined physical input event has occurred. Exemplary physical input events may include one or more of the following:
Single click
Double click
Triple click
Short hold (pressed down for 3 seconds)
Medium hold (pressed down for 5 seconds)
Long hold (pressed down for 10 seconds)
Pressed
Released
Rotated clockwise 2 degrees
Rotated counter clockwise 2 degrees
Touch-screen touch (includes position information)
Touch-screen swiping (includes position information)
Touch-screen clicking (includes position information)

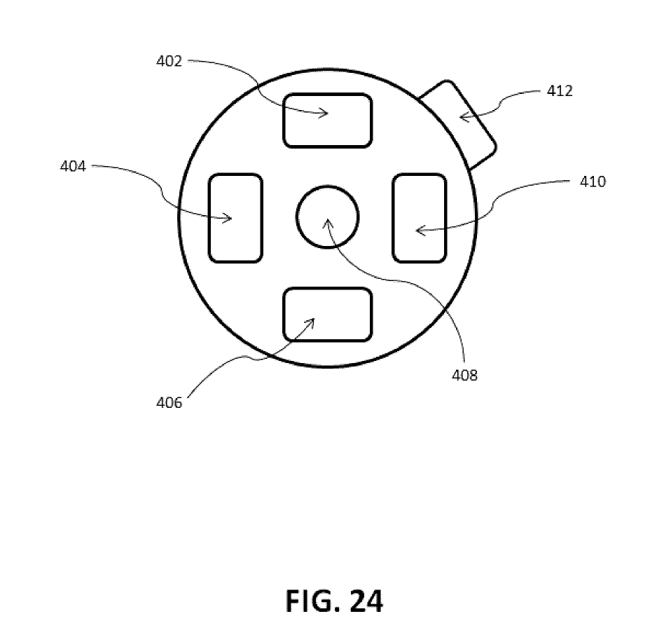

FIG. 24 illustrates a top view representation of buttons included in one embodiment of the portable electronic device 200 which includes top buttons 402, 404, 406, 408 and 410; and side button 412. By way of example only, when button 408 is clicked once (e.g. single click) by the user, a physical input event of single click for button 408 is recorded along with the time of occurrence. By way of example only, a single click event may be defined as a press and release of a button within a predetermined amount of time (e.g. 0.7 second).

Next, the physical input application 394 may communicate with the command database 400 to determine and store information to be included in the input report 392.

The input condition and command database 400 may contain information regarding what data is to be included in the input report 392 under various input conditions. FIG. 24 shows an embodiment of a table included in the input condition and command database 400. In one embodiment, each row of the table may include information on the input conditions 418, portable electronic device status 220 and command send 422. By way of example only, each row of the input condition 418 column may include information regarding a predetermined condition regarding the physical input events such as:
Single click button 408: A single click event has occurred at button 408
Button 408 and 412 and pressed together and medium held (pressed down for 5 seconds before release)
A knob has rotated 32 degrees clockwise within 2 seconds

The physical input application 394 determines if one or more input conditions 418 are true. If the input condition 418 of row is determined to be true by the physical input application 394, the information in the row (i.e. portable electronic device status 220 and command send 422) will be included in the input report 392. The physical input application 394 stores the input report 392 in memory 266 and process 392 sends the input report to processing module 280.

The processing module 280 analyses the information in the input report 392 to determine on what commands to execute. The processing module 280 may check if the conditions stated in the portable electronic device status 220 are true before it executes the predetermined actions stated in the command sent 422.

By way of example only, in the event that the user clicks on button 408 once while they are receiving a call (assuming the portable electronic device 200 is connected to the user's mobile phone over the wireless connection 204), the physical input application will send information included in row 4 and row 5 to the processing module 280 via the input report 392. The processing module 280 will execute the task requested in command sent 422 of row 5 which in this exemplary case is to answer the call.

In the case that the wireless input application is executed 396, the source and type of wireless input is identified, compared to the input condition and command database 400 and an input report 392 is generated and stored. By way of example only, when a user receives a call on a mobile phone, the user input module 274 of portable electronic device 200 may receive an input from wireless module 274 through Bluetooth® hands-free profile standard communication protocol (assuming the portable electronic device 200 is connected to the user's mobile phone over the wireless connection 204); The user input module 274 executes the wireless input application 396 and checks conditions set in the input condition and command database 400 to generate and input report 392; the input report 292 may contain command sent 422 and portable electronic device status 220 conditions for activating the vibration module 260.

In various embodiments, in the case that the hands-free PTT application 398 is executed, the application determines what PTT input events have occurred and may store this information in memory 266. In various embodiments, Hands-free PTT events may include one or more of the following:
Proximity sensor activated (i.e. the magnetic sensor is in proximity)
Hands-free gesture recognized and activated
Hands-free gesture ended and deactivated

In various embodiments, the hands-free PTT application 398 may be informed about physical input events by having access to memory 266 (as the physical input application stores evens and input reports in memory 266). Similar to the physical input application 394, the hands-free PTT application communicates with the input condition and command database 400 to determine and store information to be include in the input report 392. The hands-free PTT application 398 determines if one or more input conditions 418 are true. By way of example only, input conditions may include:
Hands-free PTT active event occurred (i.e. the user preformed the gesture illustrated in FIG. 64) and button 412 was held for more than 3 seconds.
Button 412 was pressed before hands-free PTT active event occurred and released within a predetermined amount of time.

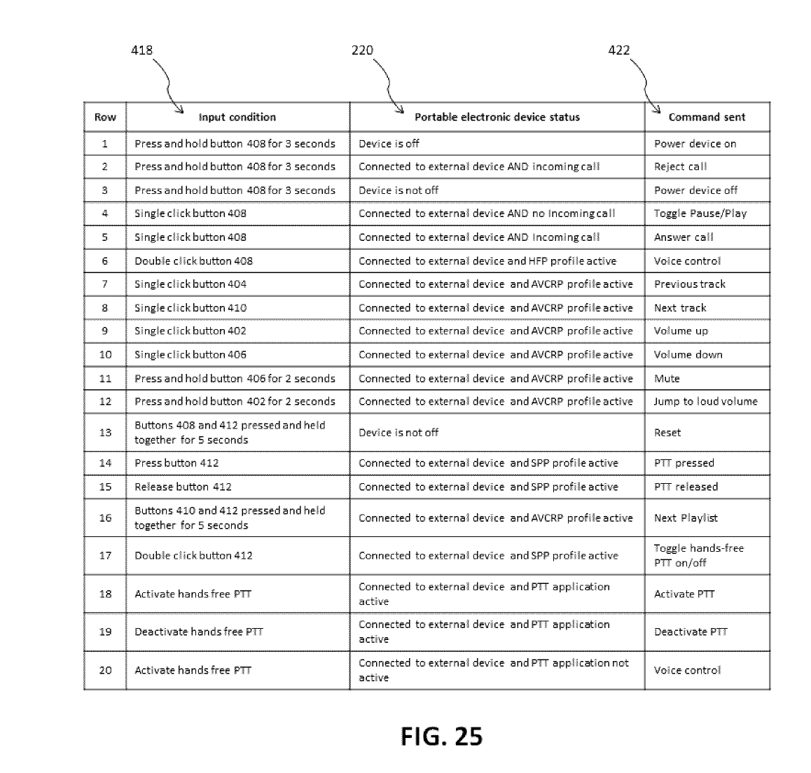

In various embodiments, if the input condition 418 of row is determined to be true, the information in the row (i.e. portable electronic device status 220 and command send 422) will be included in an input report 392. The physical input application 394 stores the input report 392 in memory 266 and process 392 sends the input report to processing module 280. For example, in such embodiment if an activate hands-free PTT event occurs (i.e. the user performs hands-free PTT gesture), information of Row 18 and 20 of the table depicted on FIG. 25 will be send to the processing module 280 via the input report 294. The processing module 280 will execute the task requested in command sent 422 of row 18 if the PTT application is active (condition stated on portable electronic device status 220 of row 18 is true).

In various embodiments, in case the input is detected 380 but not recognized by the user input module 278, an exception handling 390 procedure may be executed to generate an input report 280 that indicates the error.

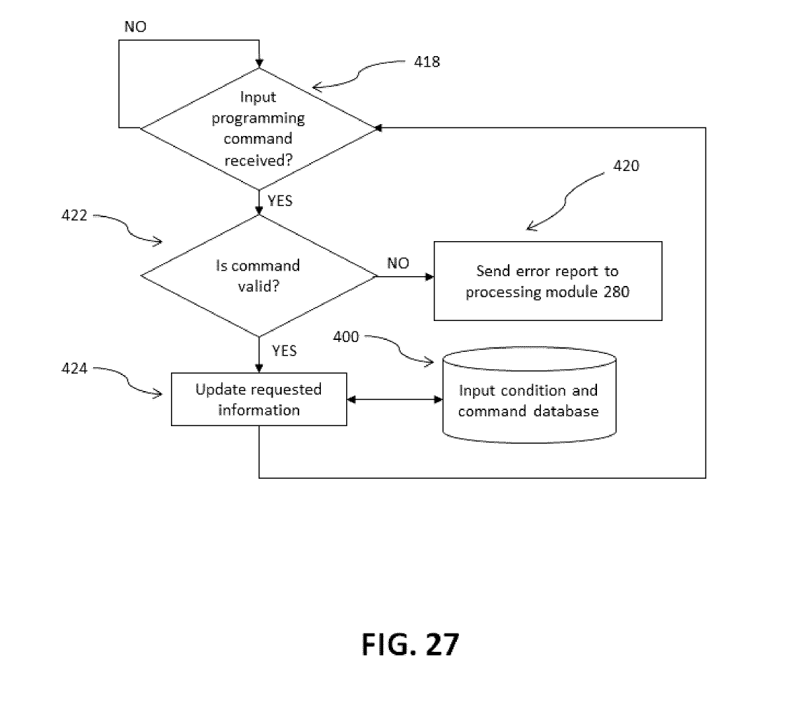

In this specification input reassignment or input programming refers to reprogramming, programming, changing or updating the computer-readable codes software code of the portable electronic device 200 to facilitate change to one or more functionalities of physical input, wireless input, gesture input, hands-free PTT input or other portable electronic device 200 input mechanisms. In various embodiments, the user input module 278 may accept commands from the processing module 280 or wireless module 274 to facilitate the reassignment or programming of various functionality to various input mechanisms (physical input, wireless input, or hands-free PTT input) of portable electronic device 200. By way of example only, in such embodiment the physical input button 402 may be reassigned to perform a skip to “next playlist” function instead of a “volume up” function—where a single click of button 402 will result the external device to skip to the next playlist and not to increase the volume. FIG. 27 illustrates a flowchart of the procedures and tasks (software code) executed by the input module 278 in various embodiments to facilitate input reprogramming or input reassignment. When an input programming command 418 is received from the processing module 280, the received command may be evaluated to ensure it is a valid command 422. The input programming command is expected to conform with a predetermined format (e.g. command is complete, input condition 418 data, command sent 422 data, requested row to be programmed), and in case the input programming command is invalid, and error report is sent to the processing module 280. In case the programming input command is valid, the requested data in the input condition and command database 400 will be updated with data included in the input programming command. This allows processing module 380 to change the data in the input condition and command database 400 and thereby program, reassign or define new input conditions 418, portable electronic status 220 and command sent 220. In various embodiments input programming or input reassignment may facilitate hands-free PTT to activate functionalities other than PTT; by way of example only, hands-free PTT input may be programmed to activate the voice control functionality instead of PTT such that when a user performs a hands-free PTT gesture, the voice control functionality is activated.

In various embodiments, the portable electronic device 200 facilitates programmable inputs or reassigning inputs via an over the air update 276. The computer-readable codes (e.g. software codes) of the input module 278 may be updated (along with other modules included in the system's functional diagram 270) via the over the air update 276 functionality facilitated by the wireless connection 204; this may include reprogramming the computer-readable codes (or software codes) to reprogram the functionality of the physical input, wireless input, hands-free PTT input of portable electronic device 200, algorithms, procedures and data explained on FIGS. 23, 25, 27, and 28 to modify various functionalities of physical, wireless or hands-free PTT input. In various embodiments, by updating the computer-readable codes (e.g. software codes) of the portable electronic device 200, the user may configure the input mechanisms (which by way of example only may include knobs, rotational input mechanisms, joystick, switch, touch screen, capacitive touch, pressure sensitive buttons, touch free PTT, gesture recognition and input from external entity via wireless module 274) to perform various functionalities.

In various embodiments, programmable inputs may facilitate the user to customize the functionality of each physical, wireless, or hands-free PTT input (i.e. button, knob, gesture, and the like) to better suit his or her preference. In various embodiments, the user may request the change in a button's functionality from an application (machine readable code) that is executing on the user's mobile device 202 with a user interface (not shown) by mapping one or more input conditions to one or more functionalities, where the input conditions and command sent may be selected from a predetermined list. By way of example only, the user may select an input condition 418 from a first drop down menu and assign a functionality from a second drop down menu (i.e. command sent 422), where the first drop down menu includes a list of inputs input condition 418 and the second menu includes a list of functionalities (i.e. command sent). The mobile device 202 may send commands to the wearable device 98 via connection 204, where the wireless module 274 may forward the command to the user input module 278 to facilitate input programming or input reassignment.

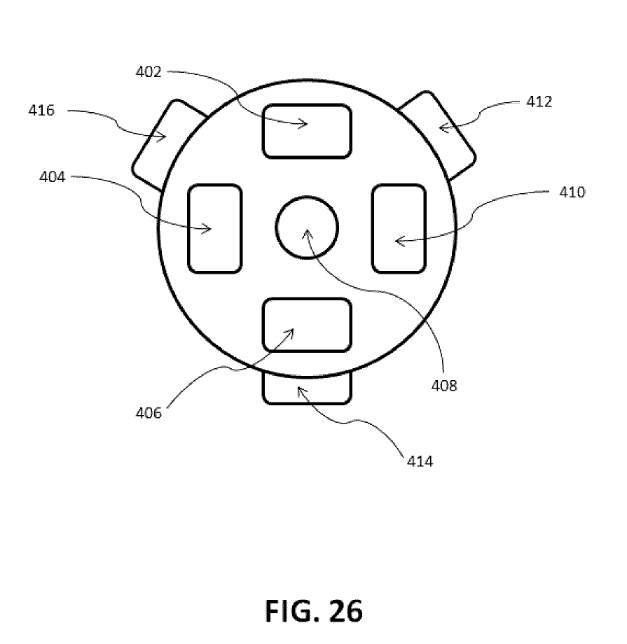

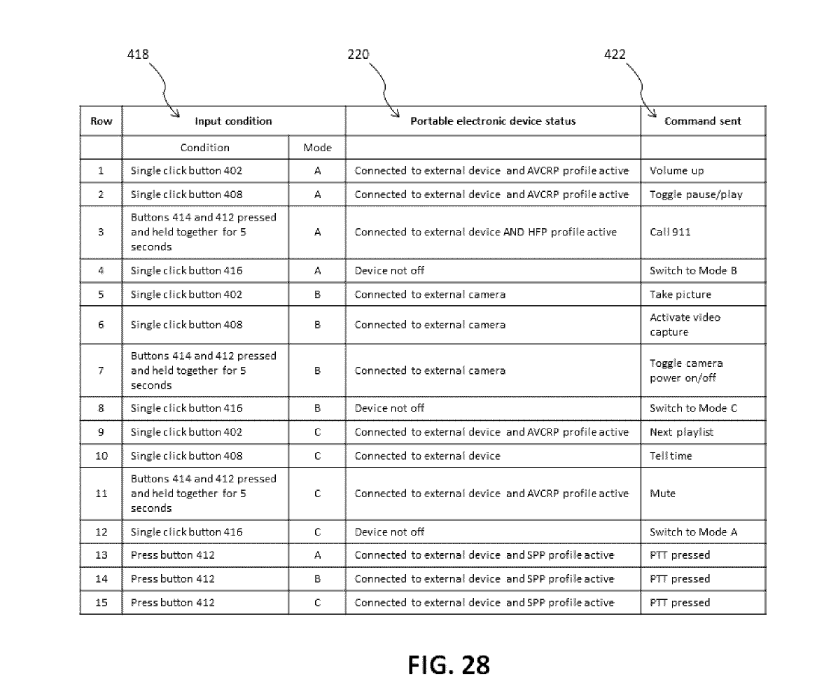

FIG. 26 illustrates a top view representation of buttons included in one embodiment of the portable electronic device 200, wherein the embodiment includes. Various embodiments may include top buttons 402, 404, 406, 408 and 410; and side buttons 412, 414, 416. FIG. 28 illustrates an example table included in the input conditions and command database 400. The input condition 418 also includes modes (in this example mode A, mode B or mode C). For each mode, the same buttons may perform a different function. In this example, a single click event for button 416, when the portable electronic device 200 is not powered off, will switch the mode: to mode B if in mode A, to mode C if in mode B and to mode A if in mode C. Pressing button 412 will result in the same portable electronic device status 220 and command sent 422 data to be included in the input report 392. Single clicking button 402, single clicking button 408, or holding button 414 and 412 together for 5 seconds will result in the different portable electronic device status 220 and command sent 422 data to be included in the input report 392 depending on the mode. If the user single clicks on button 408 while in mode C, the portable electronic device 200 will announce the time through speaker module 244 (row 10). If the user single clicks on button 408 while in mode B, the portable electronic device 200 command the external camera or 3^{rd} party device 212 to start recording a video (row 6). If the user single clicks on button 408 while in mode A, the portable electronic device 200 command the connected external device to toggle pause/play (row 2).

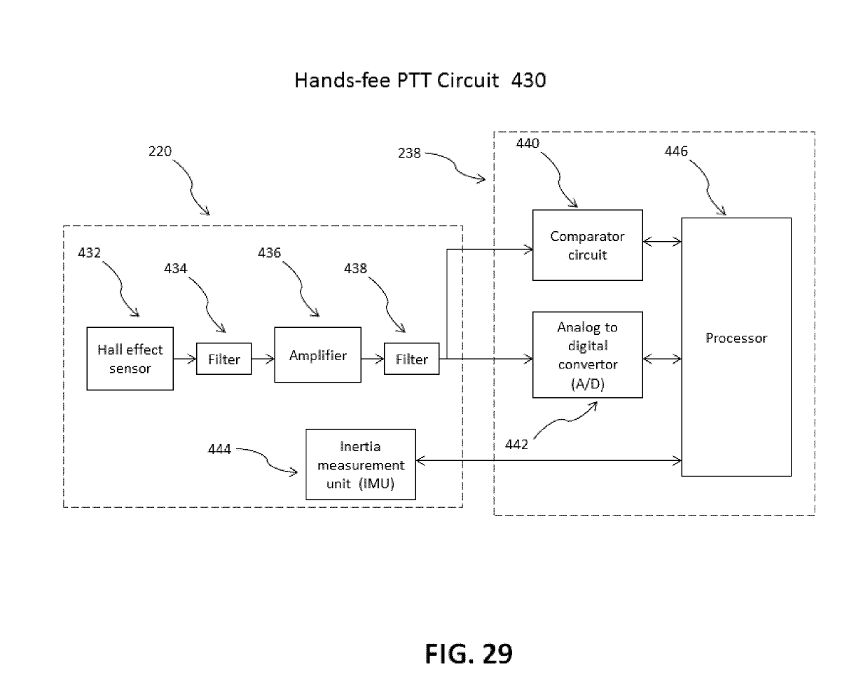

In various embodiments, the hands-free PTT module 284 executes tasks and procedures (software code) to facilitate hands-free PTT functionality. FIG. 29 illustrates an embodiment of a simplified schematic for the hands-free PTT circuit 430 which may be provided in various embodiments of the portable electronic device 200. The hall-effect sensor 432, filter 434, amplifier 436, filter 438 and an Inertia measurement unit (IMU) 444 may be included in sensors module 220. The Schmitt Trigger circuit 440, Analog to Digital convertor 442 and processor 446 may be included in the processing module 238. In various embodiments, the processor 446 may include a Schmitt Trigger circuit 440 or Analog to Digital convertor 442. It will be appreciated that the components shown are for illustrative embodiments only, and are not meant to be limiting. For instance, not all components shown in FIG. 29 are required to facilitate basic hands-free PTT functionality or various extension to such functionality as described in other parts of this specification.

In various embodiments, A Hall-effect sensor 432 (or magnetic field sensor) may sense magnetic fields 553 from proximity actuator 216 (which includes a magnet 551). A Hall-effect sensor 432 may produce an output signal voltage that corresponds to its distance from the magnet 551. The stronger a magnetic field 551 (i.e. the less the distance between Hall effect sensor and the magnet), the higher the output voltage generated. The output signal may be conditioned via filter 434, amplifier 436 and filter 438. Filter 434 may be a low pass filter to filter out undesired higher frequency noise. The amplifier may have a predetermined gain (e.g. gain of 3.25) and may be programmable by the processor 446 (e.g. the gain can be programmable). Filter 438 may be a low pass filter with a different cut off frequency than filter 434. The filters 434, 438 and amplifier 436 may condition a signal to have a higher signal to noise ratio. The Analog to digital convertor 442 converts the voltage value of the signal to digital data facilitating processor 446 to interpret the signal voltage value. The cut off frequency of low pass filter 484 may be at least 5 times below the Nyquist frequency of the Analog to digital convertor 442 to minimize aliasing. The comparator circuit 440 compares the voltage of its input signal to that of a predetermined value (e.g. 1.5 Volts). As an example the comparator circuit may be a Schmitt Trigger circuit. If the input signal is below the predetermined threshold value (e.g. 1.5 Volts), the comparator circuit 440 produces a digital 0 output (e.g. Output voltage below 0.4 Volts). If the input signal is above the predetermined threshold value, the comparator circuit 440 produces a digital 1 output (e.g. 3.3 Volts). In various embodiments, the processor 446 may have an interrupt-enabled input connected to the comparator output such that an interrupt is produced when the output signal of filter 438 is above said comparator's threshold. In various embodiments, the comparator circuit 440 threshold may be programmable by the processor 446. In various embodiments, the amplifier 436 gain and comparator circuit 440 threshold may be set to predetermined values such that an interrupt at processor 446 occurs when the proximity actuator 216 is within a predetermined proximity. In various embodiments, an Inertia Measurement Unit 444 may include a 3-axis accelerometer, 3-axis gyroscope, and 3-axis compass (i.e. Invensense MEMS electronic chips) to facilitate processor 446 to perform three-directional motion tracking. The processor 446 may interpret the data from the accelerometer, gyroscope, or compass included in the IMU 444 to determine when a Hans-free PTT gesture occurs.

FIG. 30 illustrates a flow chart of an embodiment of hands-free PTT module 284 that may execute the tasks and procedure (computer-readable code) to facilitate hands-free PTT functionality of the portable electronic device 200. A In various embodiments, Hands-free PTT gesture may be detected via proximity detection facilitated by magnetic field 553 detection (thus an IMU 444 may not be included in circuit 430). As illustrated on FIG. 30, the hands-free PTT module 284 may wait for a predetermined event to occurs 448. A predetermined event may occur in one or more of the following circumstances:
When a predetermined amount of time passes;
When a PTT interrupt event occurs—where the comparator circuit 440 causes an interrupt to occur at the processor 446 in case the hall effect sensor 432 is within a predetermined proximity of the proximity actuator 216;
When a predetermined amount of time passes or interrupt event occurs;
As long as the comparator circuit 440 produces a logical high;
In case the comparator circuit's 440 output changes logic state (i.e. changes from high to low; or from low to high);
A combination of the above predetermined event occurs and satisfies predetermined condition.

When a predetermined event 448 occurs, the Hall-effect sensor's 432 conditioned signal voltage may be acquired via Analog to digital convertor 442 and stored in memory 266 via processor 446. Next, the distance between the Hall-effect sensor 432 and the proximity actuator 216 is determined 452. The database of voltage versus distance 458 may include previously tested and measured data of acquired voltage level versus distance between the proximity actuator and the portable electronic device 200. The distance 452 may be determined by comparing the acquired voltage level to the data in database 458. If the distance is closer that a predetermined amount, then the portable electronic device 200 and proximity actuator 216 are within predetermined proximity 454 (e.g. 15 cm).

The proximity flag 456 is a Boolean value (i.e. either TRUE or FALSE) stored in memory 266 and is initially set to FALSE. The proximity flag indicates if the hands-free PTT gesture has been previously activated and currently in progress (i.e. previously activated but not deactivated yet).

The first time it is determined that the portable electronic device 200 is within predetermined proximity 454, since the proximity flag is FALSE, it will be set to TRUE 466 and a PTT active command is sent to the user input module 278. Next, the hands-free PTT module 284 waits for a predetermined event 448 to occur.

In case a predetermined event 448 occurs (e.g. a predetermined amount of time passes) and the portable electronic device 200 and proximity actuator 216 are within predetermined proximity 454, the hands-free PTT module 284 decides to wait for a predetermined event 448 to occur.

In case a predetermined event 448 occurs (e.g. a predetermined amount of time passes) and the portable electronic device 200 and proximity actuator 216 is not within predetermined proximity 454:
If the proximity flag is TRUE, the hands-free PTT module 284 sets the proximity flag to FALSE and sends a PTT deactivate command to the user input module 278.
If the proximity flag is FALSE, the hands-free PTT module 284 waits for a predetermined event 448 to occur.

When the user input module 278 receives a PTT activate command 468, it may send an input report 392 to the processing module 280. Upon receiving an input report, the processing module 280 may activate the Hands-free PTT functionality to facilitate group communication.

When the user input module 278 receives a PTT deactivate command 468, it may send an input report 392 to the processing module 280. Upon receiving input report 392, the processing module 280 may deactivate the Hands-free PTT functionality.

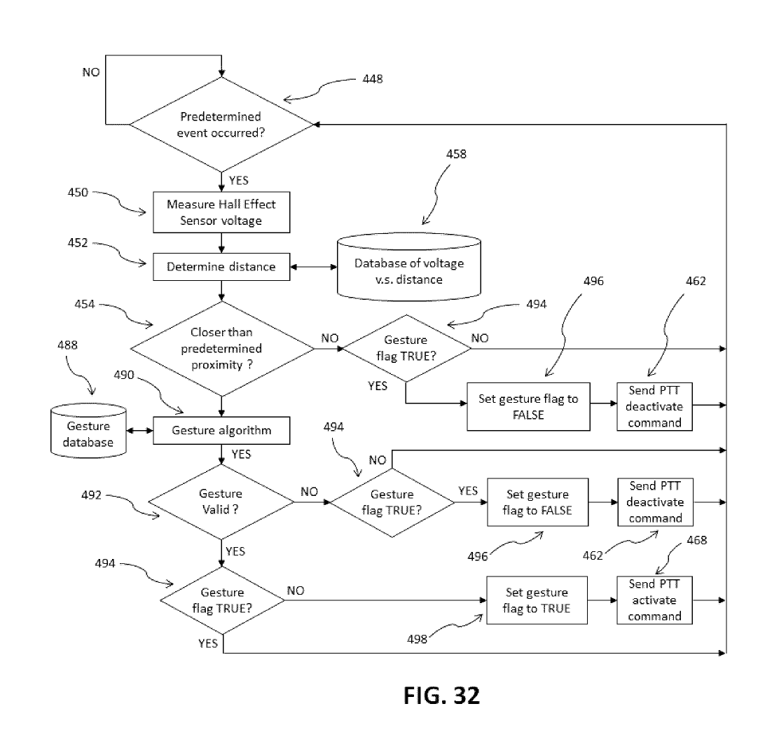

FIG. 32 illustrates a flow charts of an embodiment of tasks and procedures (computer-readable code) executed by the hands-free PTT module 284 to facilitate the portable electronic device 200 to perform a hands-free PTT functionality. In various embodiments, the module 284 may detect hands-free PTT gesture by a combination of proximity detection (e.g. by measuring magnetic fields 553) and gesture detection (by measuring and analyzing motion of the portable electronic device 200). Gesture detection may be performed by supporting a motion sensor (IMU 444, accelerometer, gyroscope or magnetometer) to monitor the movement of the user (i.e. user's arm position, velocity, acceleration, rotation or rate of rotation). A combination of proximity detection and gesture recognition enhances the performance of hands-free PTT functionality by increasing accuracy (less number of false positives), being more responsive (requiring less time to recognize a PTT gesture) and being more power efficient (increasing battery life). In the embodiment presented on FIG. 32, the procedures 448, 450, 452, 458 and 454 are the same as FIG. 30. In case the portable electronic device 200 and the proximity actuator 216 are closer than predetermined range 454 (e.g. the user is positioning the portable electronic device 200 closer than 15 cm to proximity actuator 216), the gesture recognition algorithm 490 (computer-readable code) is executed.

Upon execution of the gesture recognition algorithm 490, the motion sensor may be activated to measure and store motion sensor data. The gesture recognition algorithm 490 may facilitate the detection of a hands-free PTT gesture by comparing the identified gesture or set of gestures with previously stored reference data in gesture database 448. those of ordinary skill in the art understand there are many methods that could be used to identify gestures and to identify them more accurately. By way of example only, the gesture recognition algorithm 490 may support a Kalman Filter for sensor fusion to:
Use three axis acceleration data;
Include gyroscope data to perform rotation correction for more accurate rotation monitoring;
Include gyroscope and magnetometer data to perform rotation correction for more accurate rotation monitoring;
Include a gravity filter, to identify only acceleration of the wearable device 98 caused by the user's gesture;
It may standardize the acceleration or rotation data so it is independent of strength or speed of user's gestures;
Invalidate the gesture if saturation in sensors data occurs (e.g. accelerometer or gyroscope values exceed a predetermined threshold);
Separate the rotation of the user's arm 576 from the movement of the portable electronic device 200;
Invalidate data of acceleration measurement or gyroscope measurement if its value exceeds a predetermined threshold (i.e. saturated);
Invalidate data of acceleration measurement or gyroscope measurement if its value is below a predetermined threshold (i.e. insignificant);
Invalidate gesture if its duration is shorter than a predetermined amount of time.

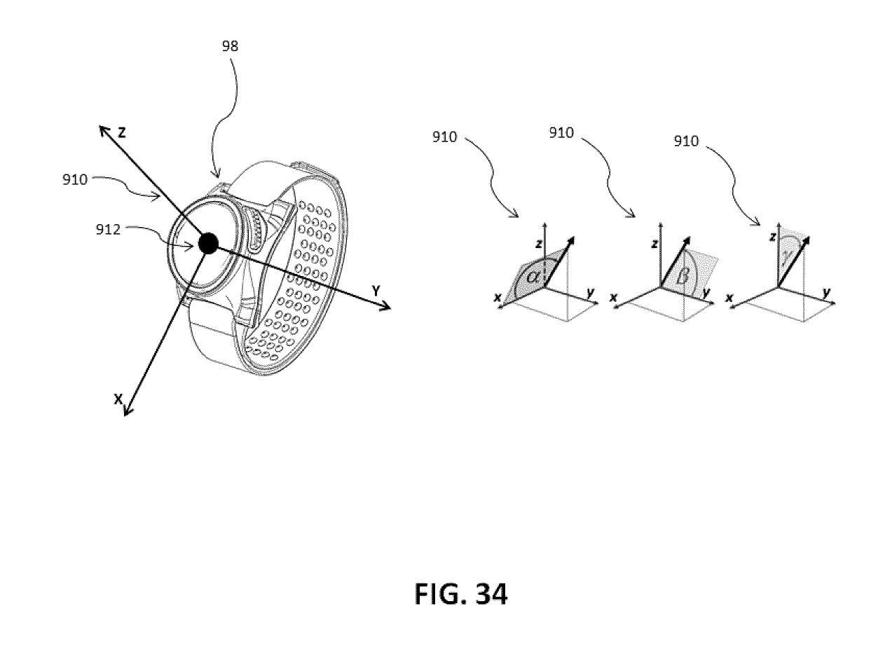

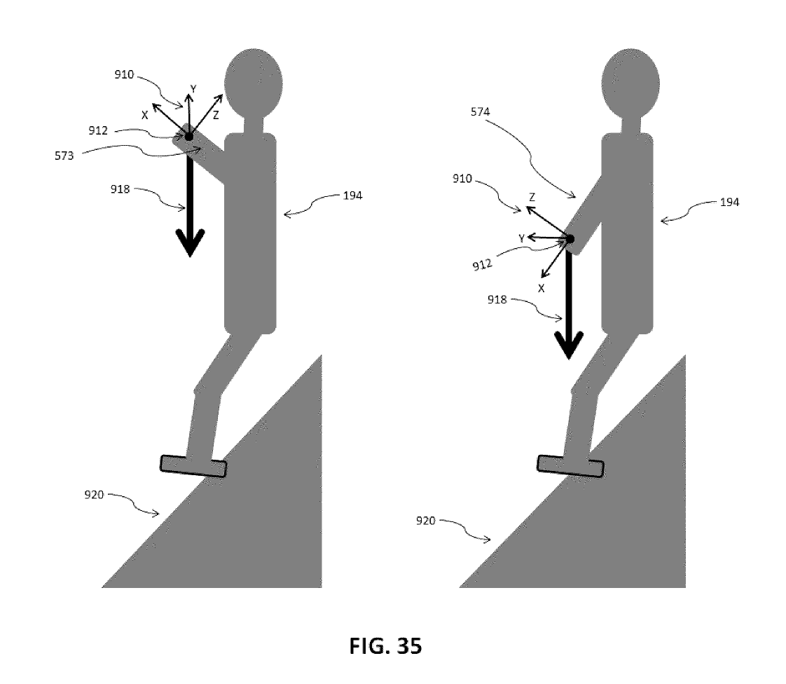

Alternatively, the gesture recognition algorithm 490, may facilitate the identification of the hands-free PTT gesture by analyzing the three-dimensional direction gravity vector 918 data relative to the wearable device 98. FIG. 34, illustrates the wearable device 98 with its local Cartesian coordinate system 910 comprised of three axes X, Y and Z; and center of gravity 912 at its origin. As illustrated in FIG. 34, a vector will have angle a from X axis, angle β from Y axis, and angle y from Z axis. FIG. 35, illustrates a user 194 wearing the wearable device 98 (not shown) performing hands-free PTT while performing sports. Vector 918 represents a three-dimensional gravity force vector. A surface 920 illustrates the surface a user 194 may be performing an activity on (e.g. snowboarding on a sloped mountain). A center of center of gravity 912 and local coordinate system 910 of the wearable device 98 is shown, where a user's 914 arm moves 575 from initial position 574 to position 573. A user may carry out rotation 576 during or after movement 575. The orientation of the local coordinate system 910 changes relative to the gravity vector 918 during the hands-free PTT gesture (i.e. movement 575 and/or rotation 576); thus, the gravity vector 918 angle a from X axis, angle β from Y axis, and angle y from Z axis may change accordingly. The gesture recognition algorithm 490 may facilitate the measurement of angles α, β, and γ from gravity vector 918 relative to local coordinate system 910 (via accelerometer or IMU 444); store aforementioned angular data in memory 266; and process aforementioned angles to identify a hands-free PTT gesture. To facilitate the identification of a hands-free PTT gesture, the gesture recognition algorithm 490 may:
Activate accelerometer;
Store three axis acceleration data and identify gravity vector;
Apply a filter such as a low pass filter on the gravity vector;
Standardize the gravity vector 918 to normalize its amplitude;
Invalidate if gravity vector 918 magnitude is above a predetermined threshold (i.e. saturation event);
Invalidate if gravity vector 918 magnitude is below a predetermined threshold;
Measure the earth's magnetic field data via a magnetometer for more accurate gravity vector 918 monitoring;
Include gyroscope data for more accurate gravity vector 918 monitoring;
Use gyroscope data and/or magnetometer data to separate acceleration caused by user 194 activity from acceleration due to gravity to more accurately determine gravity vector 918;
Determine angles α, β, and γ based on identified gravity vector 918;
Determine Hands-free PTT gesture by comparing the identified angles α, β, and γ with previously stored reference angles in gesture database 448;
Determine the Hands-free PTT gesture by checking whether angles α, β, and γ of gravity vector 918 satisfy a predetermined condition. For example, in such embodiment the predetermined conditions may require the following to be satisfied:
   Angle γ is less than 270 degrees and more than 180 degrees
   Angle β is less than 120 degrees and more than 70 degrees
   Angle α is less than 350 degrees and more than 290 degrees
   The above angle ranges satisfied for at least 0.3 seconds
Apply estimation s (such as a Kalman filter) for more accurate identification of Hands-free PTT gesture (less number of false positives);
Here, those of ordinary skill in the art understand there are many methods that could be used to identify gestures based on gravity vector 918 and to identify them more accurately.

The gesture flag 494 is a Boolean value (i.e. either TRUE; or FALSE) stored in memory 266 and is initially set to FALSE. The gesture flag 494 indicates if the hands-free PTT gesture has been previously activated and currently in progress (i.e. previously activated but not deactivated yet).

If the Hands-free PTT gesture is valid 494:
In case the gesture flag is not TRUE 494: The gesture flag 466 will be set to TRUE 498 and a PTT active command 468 is sent to the user input module 278. Next, the hands-free PTT module 284 waits for a predetermined event 448 to occur.
In case the gesture flag is True 494: The hands-free PTT module 284 waits for a predetermined event 448 to occur.

If the Hands-free PTT gesture is not valid 494:
In case the gesture flag is TRUE 494: The gesture flag 466 will be set to FALSE 496 and a PTT deactivate command 462 is sent to the user input module 278. Next, the hands-free PTT module 284 waits for a predetermined event 448 to occur.
In case the gesture flag is not TRUE 494: the hands-free PTT module 284 waits for a predetermined event 448 to occur.

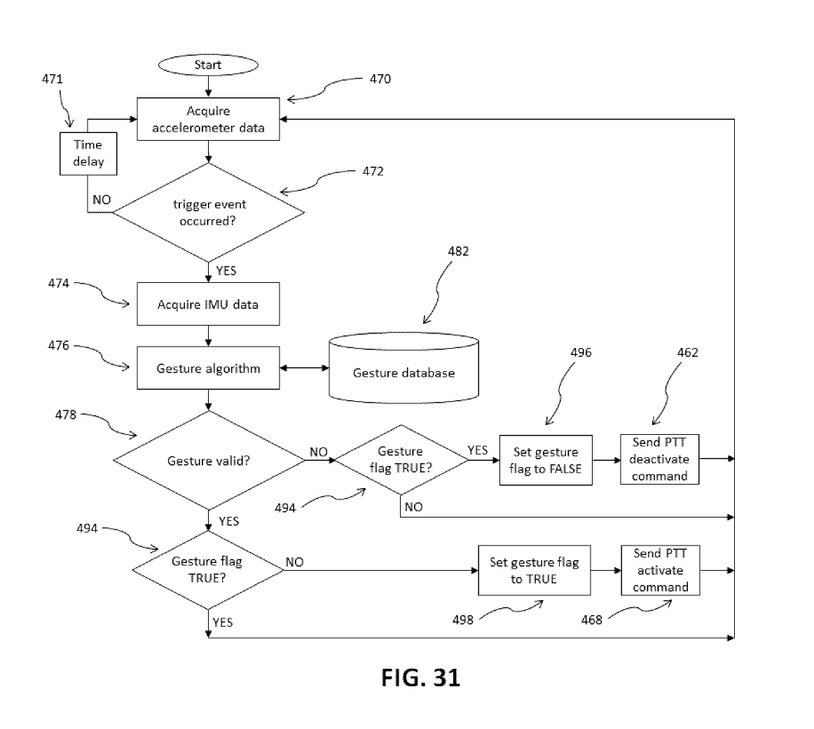

FIG. 31 illustrates a flow chart of an embodiment of tasks and procedures (computer-readable code) that may be executed by the hands-free PTT module 284 to facilitate the portable electronic device 200 to perform a hands-free PTT detection. The algorithm in module 284 facilitates the detection of hands-free PTT by gesture detection (by measuring and analyzing motion of the portable electronic device 200). In various embodiments, gesture detection may be performed by utilizing a motion sensor (IMU 444) to monitor the movement of the user (i.e. user's arm position, velocity, acceleration, rotation or rate of rotation). First, the acceleration 470 applied to the wearable device 98 which includes the gravity vector 918 is measured. Next, the hands-free PTT module 284 checks if a predetermined trigger event 472 has occurred. In various embodiments, the trigger event 474 check facilitates reduction to power consumption of the wearable device 98 by only executing power consuming processes such as 474, 476, 478 only when there is a strong indication that a hands-free PTT gesture is commencing. A trigger event occurs if angles α, β, and γ are each within a predetermined range. In case the trigger event has not occurred, the accelerometer data is measured 470 after a predetermined time delay 471. In the case that the trigger event has occurred 472, the hands-free PTT module 284 acquired and stored IMU 144 data 474, and executed the gesture algorithm 476. The gesture algorithm 476 may facilitate the activation of the IMU 444 sensor, and may measure and store its magnetometer, gyroscope and accelerometer data. The gesture algorithm 476, may determine Hands-free PTT gesture by comparing the identified gesture with previously stored reference data in gesture database 482. Here, those of ordinary skill in the art understand there are many methods that could be used to identify gestures and to identify them more accurately. The gesture flag 494 is a Boolean value (i.e. either TRUE or FALSE) stored in memory 266 and is initially set to FALSE. Next, in the case the gesture is valid 478:
In case the gesture flag is not TRUE 494: The gesture flag 466 will be set to TRUE 498 and a PTT active command 468 is sent to the user input module 278. Next, the hands-free PTT module 284 acquires accelerometer data 470.
In case the gesture flag is True 494: The hands-free PTT module 284 acquires accelerometer data 470.

In the case the gesture is not valid 478:
In case the gesture flag is TRUE 494: The gesture flag 466 will be set to FALSE 496. Next, the hands-free PTT module 284 acquires accelerometer data 470.
In case the gesture flag is not TRUE 494: The hands-free PTT module 284 acquires accelerometer data 470.

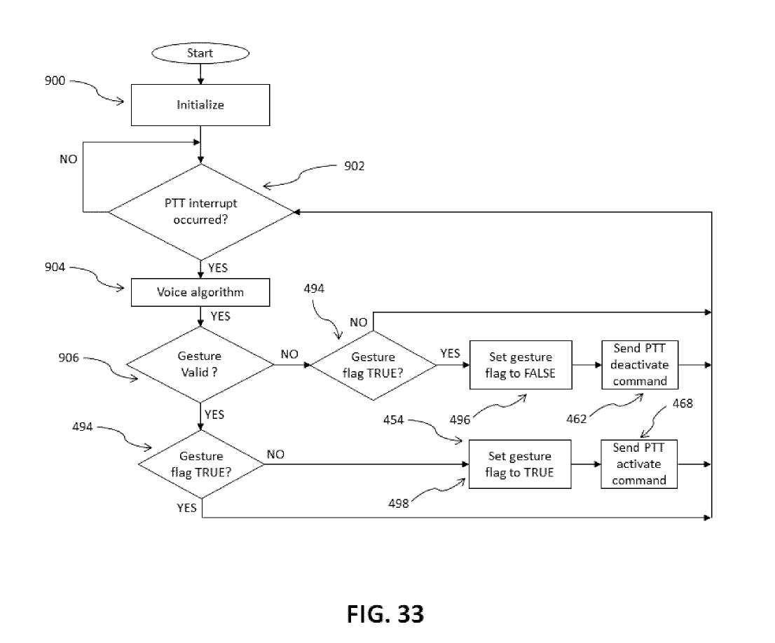

FIG. 33 illustrates a flow chart of an embodiment of tasks and procedures (computer-readable code) that may be executed by the hands-free PTT module 284 to facilitate the portable electronic device 200 to perform a hands-free PTT detection. The algorithm facilitates detection of hands-free gesture by supporting proximity detection via magnetic fields 553, and voice activation via user's voice 578. In various embodiments, the Hall-effect sensor 432, filter 434, filter 438, amplifier 436 and comparator circuit 440 (shown on FIG. 29) may be programmable by the processor (not shown). The hands-free PTT circuit 430 may not include IMU 444 or A/D convertor 442. In one embodiment, first, the initialize 900 various portable electronic device 200 components may be initialized 900, including the Hall-effect 432 sensor sensitivity value, filter (438 or 434) cut-off frequencies value, amplifier 436 gain value and comparator circuit 440 threshold value. The initialization 900 values are adjusted such that the PTT interrupt event occurs if the distance between the wearable device 98 and the proximity actuator 216 is less than a predetermined amount. In the case that the hall effect sensor 432 is within a predetermined proximity of the proximity actuator 216, the comparator circuit 440 causes an interrupt to occur at the processor 446 and the PTT module 284 detects that a PTT interrupt has occurred 902. In the case that a PTT interrupt 902 occurs, the voice algorithm 902 is executed. The voice algorithm 902 facilitates the activation of the microphone module 246, reads and storing of audio data (generated by user's 194 voice 578) in memory 266. The voice algorithm 904 may perform one or more of the following to facilitate the identification of a user 194 speaking into the wearable device 98:
Determine if the amplitude (i.e. loudness) of audio data is above a predetermined threshold;
Determine if the amplitude (i.e. loudness) of audio data has changed more than a predetermined amount within a predetermined amount of time—e.g. Average amplitude difference read from microphone module 246 within 0.4 seconds is above 1.2 Volts;
Determine if the amplitude (i.e. loudness) of audio data is above a predetermined threshold for longer than a predetermined amount of time;
Determine if the audio data is from a human voice—estimation algorithm (i.e. Kalman filter, or detection of Spectral peaks of vowel sounds in a Fast Fortier Transform algorithm);
Determine if the amplitude (i.e. loudness) of audio data is lower than a predetermined threshold;
Determine if the amplitude (i.e. loudness) of audio data is less a predetermined threshold for longer than a predetermined amount of time.

The hands-free PTT module 284 may indicate the hands-free PTT gesture is valid 906 if:
The voice algorithm indicates that user 194 is speaking into the wearable device 98—e.g. The voice 578 amplitude measured at the microphone 246 is above a predetermined threshold and is human voice;
And, the wearable device 98 is within the predetermined distance of the proximity actuator 216.

The embodiments represented on FIGS. 30, 32 and 33 may require proximity actuator 216 facilitate the portable electronic device 200 performing a hands-free PTT functionality, but the embodiments on FIG. 31 does not require a proximity actuator 216 facilitate the portable electronic device 200; however, the embodiment represented on FIG. 31 may generally have a higher power consumption. Hall effect sensors can be more power efficient and thus can generally have a lower power consumption compared to accelerometer or IMU 444. A false positive event may occur when the user does not intend to activate the hands-free PTT gesture of the portable electronic device 200, but unintentionally activates the hands-free PTT (e.g. the user intends to adjust their hat but unintentionally activates the hands-free PTT). The embodiment represented on FIG. 30 may produce an increased number of false positive events. The embodiment represented on FIG. 31 may produce less false positive events, than the embodiment represented on FIG. 30, but since the gesture algorithm has higher computational complexity, the embodiment represented on FIG. 31 may not be as responsive and the user experiences some delay (e.g. 0.5 seconds) from the time they perform the hands-free PTT gesture and PTT activation. The embodiment represented on FIGS. 32 and 66 may have the lower number of false positive events and facilitate enhanced responsiveness (and the user experiences some delay (e.g. 0.1 seconds) from the time they perform the hands-free PTT gesture and PTT activation).

In various embodiments, proximity sensing may also be performed by mechanisms other than magnetic sensing (e.g. Hall effect sensor) and may include RFID sensors (or RFID transceiver) or Infrared proximity sensor. In various embodiments the proximity actuator 216 may include RFID tags instead of magnets.

In various embodiments, The Sensor Module 280 executes tasks and procedures (software) provided to sensors 220 included in the portable electronic device 200. The sensor module facilitates: communication with each sensor; initialization and/or calibration of each sensor; storing of raw sensor data; processing of raw data and converting it to meaningful data (i.e. by performing signal conditioning via filtering, or defining saturation cut offs, gain adjustment, averaging, statistical calculations); receiving commands from the processing module 280 and executing requested procedures; sending of meaningful sensor data reports to the processing module 280 upon request or upon predetermined events (i.e. predetermined time intervals, or interrupt events).

In various embodiments, the user feedback module 288 executes tasks and procedures (software) related to output devices or mechanisms in the portable electronic device 200 including status lights 264, vibration module 260, display module 236 and speaker module 244. In various embodiments, the user feedback module may facilitate r: communication with each output module to; initialization and/or calibration of each module; receiving commands from the processing module 280 and executing requested action (see example below); sending of reports about the status of the output modules to the processing module 280 upon request or upon predetermined events (i.e. predetermined time intervals, or interrupt events). In various embodiments, the status light module 264 may include a light driver circuit, and may communicate with the processing module 266. In various embodiments, the user feedback module 288 (software) executes procedures on the processing module 266 or local processor included in status light module 264 to manipulate the status lights 264. By way of example only, in various embodiments, the user feedback module may facilitate one or more of the following actions in response to receiving commands from the processing module 280:
Turning each or a plurality of status lights 264 on or off, changing their color, or changing their intensity (brightness), changing frequency of blinking;
Execute a pre-programmed status lights 264 pattern—by way of example only an array of lights 264 (LEDs) shown on FIG. 60 may facilitate visual indication of navigation direction;
Making predetermined notification sounds (e.g. beeping sound, melody or a pre-recorded sound on memory 266 such as music) via speaker module 244 (which may include buzzer or speaker);
Facilitating control of one or more haptic feedback mechanisms (Piezoelectric actuator, buzzer or vibration motor) included in the vibration module 260, their intensity of vibration, and pattern of vibration;
Displaying information on the display module 236, to update the graphics or image displayed on the display module 236, or to change the display module 236 screen brightness.

By way of example only, in various embodiments, the display module may receive data from the processing module 280 to display time, text, image, video, graphics or the like. In various embodiments, a mobile device 202 may send display data (time, text, image, video, graphics or the like) over wireless connection 204 via the standard Bluetooth® Serial Port Profile facilitated by wireless module 248 (hardware) and wireless module 274 (software). The tasks and procedures (the computer-readable code) facilitating the display of aforementioned display data on the display module 236 may be executed on the processing module 238. The display data may be forwarded from the wireless module 274 to the user input module 274 which may send the processing module 280 a predetermined input report 392; The processing module 280 may receive the input report 392 containing the display data, and the processing module 280 may send commands to the user feedback module 288 to facilitate the display on the display module 266.

In various embodiments, the 3rd party device module 290 executes tasks and procedures (computer-readable code) to facilitate communication with external device or 3rd party device 212 (such as camera or drone), identification of the external device and may include a knowledge base of commands that can be sent to or received from the external device or 3rd party 212 device. In various embodiments, when the wireless module 274 intends to facilitate connection to a new unknown external device, it communicates with the 3rd party module 290 to identify the external device and to determine connection procedure. Once, the wearable device 98 is wirelessly connected to a camera or 3rd party device 212, the 3rd party device module 290 may be notified of the connection, and may forward the received commands from the external device to the processing module 380, or may forward the received commands from the processing module 380 to the external device via the wireless module 274. A wearable device 98 system update or over the air update may also update the 3rd party module to support additional external devices (additional knowledge of procedures and command exchange data base) or to remove support for 3rd party modules that are no longer needed.

In various embodiments, the video processing module 292 executes the tasks and procedures (computer-readable code) provided to the camera module 258 to facilitate the capturing, storing, processing or routing of video (sequence of images). In various embodiments, part of the video processing module 292 may be executed on a local graphics processor. In various embodiments, a compression algorithm may reduce the size of the video data. There are various standard compression algorithms which vary in terms of quality, compression amount and resulting power consumption. In various embodiments, the video processing module 292 may facilitate the initialization of the camera module 258 and may receive a command from the processing module 280 to capture video. The processing module 280 may facilitate the reading of the video module 258 data, compression of the video data to a format requested by the processing module 280 and storing of the compressed data in memory 266.

In various embodiments, the processing module 280 executes the tasks and procedures (computer-readable code) to facilitate receiving of reports or data from all or substantially all the modules shown in the system's functional diagram 270, processing the collected information, determining the status of the portable electronic device 200, and sends commands to modules shown in the system's functional diagram 270 to support various functionality with the portable electronic device 200. By way of example only:
In the case the power module 272 reports that the battery level is low, the processing module may enable a “power saving” mode where it sends a command to the power module 272 to change the power state of a plurality of components to off or sleep.
In the case that a mobile device 202 is requesting to establish a connection via the wireless module 274, the wireless module 274 will inform the processing module about the request. The report may include information such as connection request type, external device capabilities, wireless signal strength. The processing module 280 receives said information, determines if the external device is asking for a valid connection and may send a command the wireless module 274 of to accept or deny the connection request.
In case the processing module receives an input report 392 from the user input module, it checks if the portable electronic status 220 is satisfied, and may decide to execute the command sent 442. By way of example only, if button 408 is pressed and held for 3 seconds and the portable electronic device 200 power state is not in hibernate or off power state (indicated by received power status report 302), the processing module will send a command to the power module 272 to change the power state of most components to off and to change the power state of some components to hibernate.

In case the hands-free PTT gesture is detected, the processing module 280 receives a report that is sent from the hands-free PTT module and user input module 278. The processing module 280 may check if a connection to the cellular network 208 is established (via the wireless module 274 supported by mobile device 202 or wireless connection 204). The processing module 280 may send a command to the audio module 286 to establish audio channel connection. The processing module 280 may send a command to the user feedback module 288 to activate a status light and to make a predetermined (e.g. beeping sounds) speaker sound. The processing module may send a command to request the wireless module 274 to establish a PTT connection. The processing module 280 may send a command to the audio module 286 to acquire the microphone data, compress the data and to send the data to wireless module 274.

In various embodiments, the audio module 286 executes tasks and procedures (software) to facilitate audio data encoding, audio data processing, audio routing, reading or storing audio data, or communication with one or more modules presented on the system's functional diagram 270 to support:
Audio output via speaker module 244
Audio output on mobile device 202 via connection 204 or 214 (facilitated by wireless module 272);
Audio input via microphone module 246;
Audio input via mobile device via connection 204 or 214 (facilitated by wireless module 272).

By way of example, when performing outdoor winter activities, a user may detachably couple the portable electronic device 200 to objects such as their garment, belongings or equipment. For example:
A user who enjoys snowmobiling can secure the cylindrical surface mounting adaptor 184 to their snowmobile's handle bar. The user can detachably couple or connect the portable electronic device 200 to the mounting adaptor 184 and utilize it while snowmobiling.
A user who enjoys snowboarding can detachably couple or connect the portable electronic device 200 to the wrist position of their glove 108 via an elastic strap 102 mounting adaptor 184. This facilitates the user to wear the portable electronic device 200 and utilize it while snowmobiling.
A user who enjoys white-water kayaking can secure a flat surface mounting adaptor 144 to the deck surface of their kayak. The user can detachably couple or connect the portable electronic device 200 to the mounting adaptor and utilize it while white-water kayaking.

In various embodiments a user can readily detach the portable electronic device 200 from one mounting adaptor 184 and attach to another mounting adaptor 184. In one exemplary embodiment the user may detach the portable electronic device 200 from their snowmobile and attach it to their glove 108.

In various embodiments, the portable electronic device 200 may be designed to be utilized in winter environments where wet conditions or cold or extreme cold temperatures are typical. In various embodiments, the portable electronic device 200 may be designed to be robust to withstand high impact forces and vibrations.

In various embodiments a user may utilize their mobile device 202 to connect to the portable electronic device 200. In such embodiment when the wireless connection 204 is established the user may set up and launch various applications on their mobile device 202. In one exemplary embodiment the user may launch their favorite media player application on their mobile device 202. In another exemplary embodiment the user may launch the PTT application on their mobile device 202 and set up the group they wish to be communicating with via the PTT functionality. The user may secure their mobile device 202 in a safe and dry location such as a jacket pocket and commence their activity.

In various embodiments the user can operate the portable electronic device 200 without the need to take their gloves off. In various embodiments, the large user interface and buttons facilitate the user to more readily operate the portable electronic device 200. In one embodiment, there may be five top buttons 100 (100-a, 100-b, 100-c, 100-d, and 100-e) and a side button 104 on the portable electronic device 200 each performing a set of predetermined functionalities. In various embodiments pressing and holding middle button 100-e may toggle the power of the portable electronic device 200 on or off In various embodiments if there is an incoming call, the user may pick up by pressing the middle button 100-e once. In various embodiments if there is an incoming call, the user may reject the call by pressing and holding the middle button 100-e. In various embodiments pressing the side button 104 once may toggle the PTT functionality on or off. In various embodiments pressing and holding the side button 104 once may toggle the PTT functionality on or off. In various embodiments pressing the top button 100-d once may skip the music track forward. In various embodiments pressing the top button 100-c once may jump to the previous music track. In various embodiments pressing and holding the top button 100-c may activate the redial functionality. In various embodiments pressing the top button 100-a once or multiple times may decrease the volume. In various embodiments pressing and holding the top button 100-e once may mute the volume. In various embodiments pressing top button 100-a once or multiple times may increase the volume. In various embodiments pressing and holding the top button 100-b may switch the audio routing between three modes:
Mode 1: input and output audio may be routed through a headphone or the speaker 210;
Mode 2: the output audio may be routed through a headphone or the speaker 210, and the input audio (user's voice) may be routed through the microphone module 246; and
Mode 3: the output audio may be routed through the speaker module 244, and the input audio (user's voice) may be routed through the microphone module 246.

In various embodiments if no headphone or speaker 210 is connected to the mobile device 202 and user opts Mode 1 or Mode 2, the audio routes to the mobile device's 202 internal speaker or microphone.

In various embodiments the user may utilize the hands-free PTT functionality as previously described. In various embodiments the user may receive various audio notifications such as: (i) ringing when they receive a call, (ii) beeping when battery is low, or (iii) two-way radio like sounds effects for the PTT functionality. In various embodiments a predetermined blinking sequence or color of the status light may also serve as a notification. In one exemplary embodiment a blinking red-colored light may indicate that the battery is low. In such case the user may charge the battery 252 by connecting the portable electronic device 200 to a power source via the connector 242.

While the foregoing description provides various illustrative embodiments, one of ordinary skill appreciate the existence of variations combinations, and equivalents of the specific embodiments, methods, and examples herein. The invention should therefore not be limited by the above described embodiments, methods, and examples. By way of example only, the shape of the portable electronic device 200 can be of a different shape and have different number of buttons that the previously specified embodiments. Examples of some of the alternate embodiments are described next.

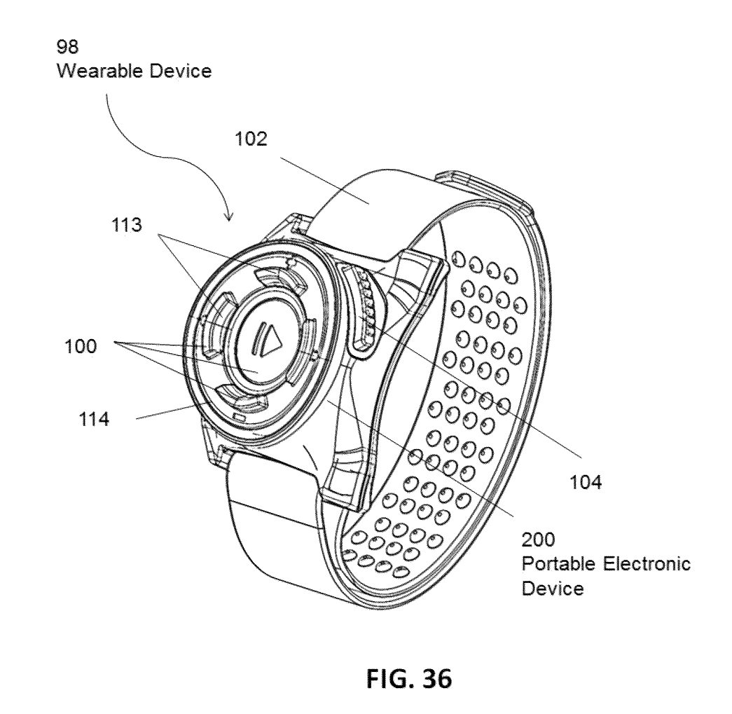

In various embodiments, the wearable device 98 can use a plurality of alternative user input mechanisms for the portable electronic device 200. One such alternate embodiment is shown in FIG. 36, where the top face 114 and buttons 100 and 104 may include features, such as the ridges 113, that may be easily palpable by glove fingers 110 (110-a, 110-b, etc.). The user 194 may, without having to look at the wearable device 98, easily find the middle button 100 on the portable electronic device 200 by touching the top face 114 then subsequently feel the ridges 113 over their glove 108. Thus, the user can sense the approximate orientation of the portable electronic device 200 and buttons relative to themselves. The ridges 113 can be physically connected to the top buttons 100 (or even act directly as the buttons), so a user that intends to press a desired button simply presses on the easily felt ridges 113. Thus, a user wearing gloves and portable electronic device 200, can intuitively find and operate the top buttons 100 and 104 without even having to look at the portable electronic device 200. Each of the top buttons 100 and 104 can be easily accessed and pressed by a user wearing glove 108 and each button facilitates haptic feedback to the user.

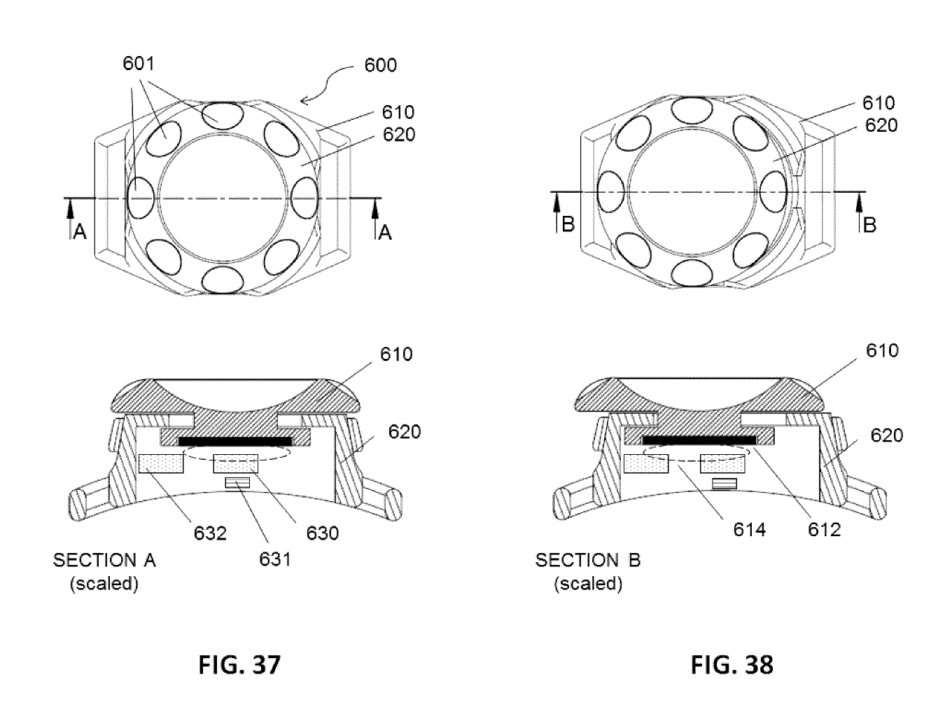

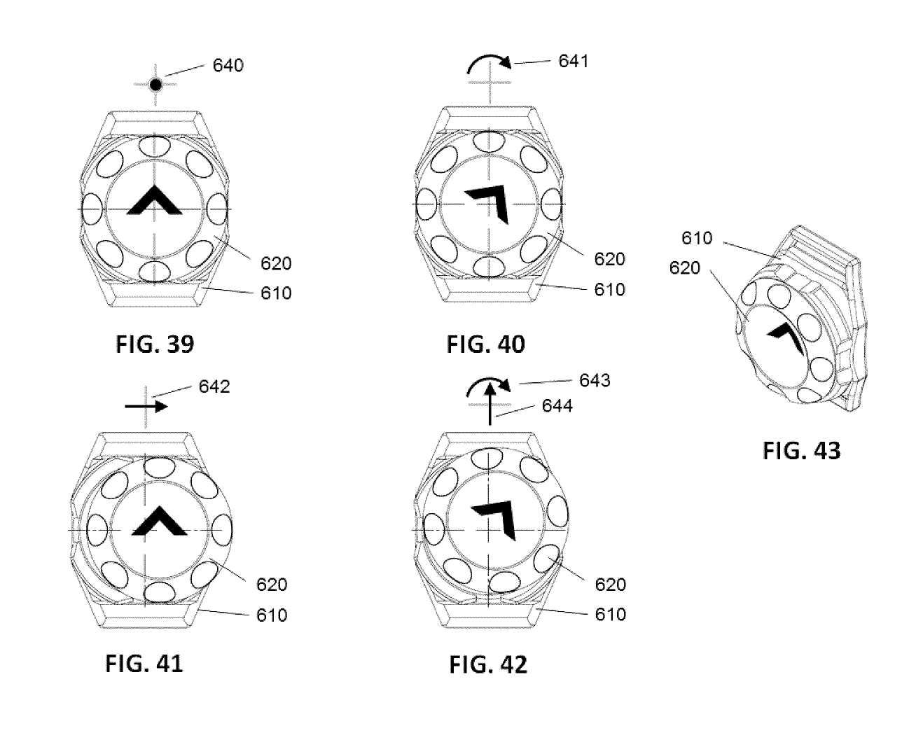

Another alternate embodiment of the user input mechanism is shown in FIG. 37 which is referred to as the joystick input mechanism 600. A perspective view of the joystick input mechanism 600 is shown in FIG. 43. In various embodiments the joystick input mechanism 600 comprises of a moving top 620 that may be integrated in the body 610 of the portable electronic device 200, as shown in the scaled cross-sectional view in FIG. 37. The moving top 620 may have a large cavity that the user can put their gloved fingers 110 (110-a, 110-b, etc.) on and move it in desired direction. Furthermore, a user with gloved fingers 110 (110-a, 110-b, etc.) can rotate the moving top 620 by placing their gloved fingers 110 (110-a, 110-b, etc.) on the outside edge of the moving top 620 that has several grip features 601. The moving top 620 may be generally centered with respect to the body 610 of the portable electronic device 200 using a spring or magnetic force (not shown). The moving top 620 can be moved from its neutral (center) position 640 as shown in FIG. 39 to any (i) in-plane translational position (moved right 642 in FIG. 41, for example) and (ii) in-plane rotary position (rotated clockwise 641 as shown in FIG. 40). As shown in FIG. 42, the rotary 643 and translation 644 motion can be applied to the moving top 620 simultaneously. In various embodiments the orientation of the moving top 610, can be sensed using known optical sensing mechanisms or using magnetic sensing for example. In one such embodiments the magnetic sensing method may be as shown in the cross-sectional view in FIGS. 37 and 38, where a permanent magnet 612 may be integrated in bottom side of the moving top 620 that may generate a magnetic field 614 as shown. The magnitude and direction of the magnetic field 614 may be sensed using one or several magnetic field sensors 630 and 632 (e.g. hall effect sensors). In one exemplary embodiment, when the moving top 620 is in generally neural position as in FIG. 37, the magnetic field 614 may be stronger in the middle sensor 630 compared to the side sensor 632, thus the differential signal may be large. However, in such embodiment when the moving top 620 is moved to the left of the page as in FIG. 38, the magnetic field may be weaker in the middle sensor 630 but stronger in the side sensor 632 resulting in a smaller differential signal. In another embodiment a similar technique known to those skilled in the art can be used to detect the rotational angle of the moving top (see angle 641 in FIG. 40 for example) using the differential signal of two side magnetic sensors. Another advantage of the magnetic system may be that it can generate a self-centering force that moves (and rotates) the moving top 620 to the neural position; this can be achieved by placing a ferromagnetic material of certain shape in proximity of the magnet that may facilitate the magnet to snap into the desired position and angle. The motion and rotation of the moving top 620 can be used as an input from the user (similar to press of a button). By way of example in such an embodiment, rotating the moving top 620 may be recognized by the processing module 238 to increase the volume of the speaker.

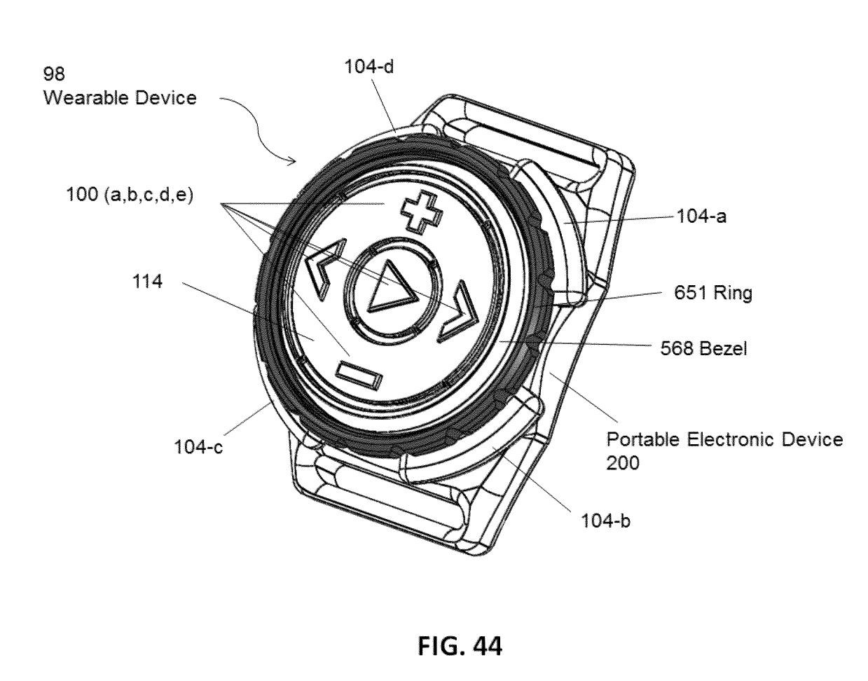

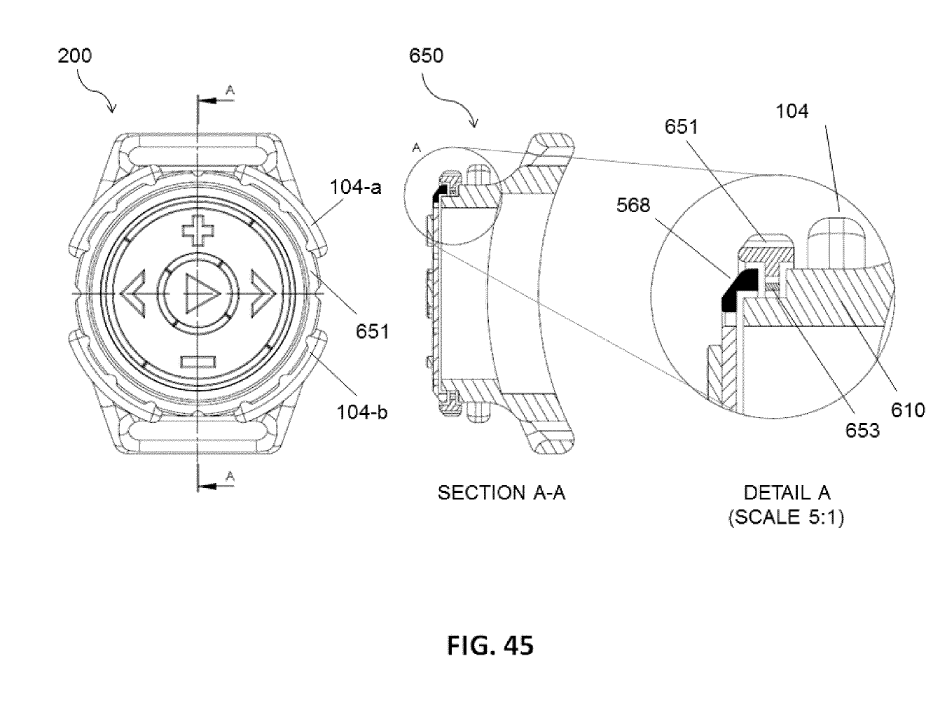

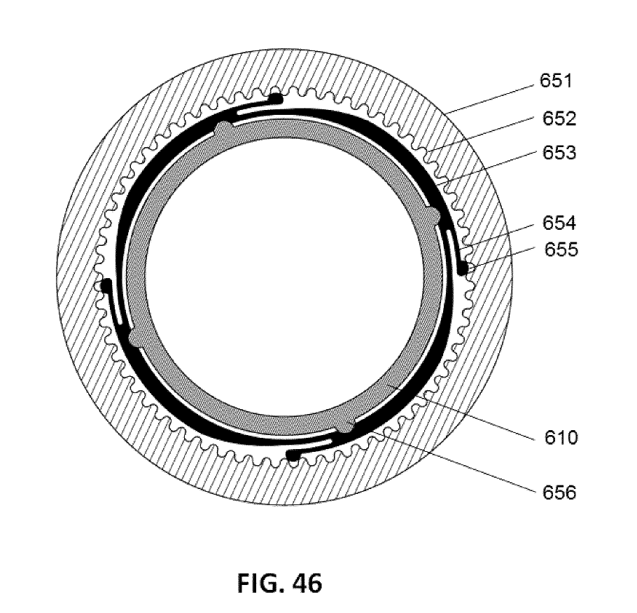

In various embodiments the user input mechanism may be as shown in FIG. 44 that may have a rotating ring 651 on the top of the portable electronic device 200 (or wearable device 98). In various embodiments, the rotating ring 651 may have several ridges that make it easily palpable by glove fingers 110 (110-a, 110-b, etc.). In various embodiment the portable electronic device may include one or more of the following: (i) top buttons 100 on the top face 114 of the portable electronic device 200; (ii) side buttons 104 (104-a, 104-b, 104-c, and 104-d) on the sides of the portable electronic device 200; and (iii) a customizable bezel 568 on top face 114 of the portable electronic device 200. FIG. 45 shows the top view of the alternate embodiment shown in FIG. 44, and its corresponding cross-sectional view and detailed view of the rotating ring 651 feature. The rotating ring 651 has a generally circular shape and is incorporated in the body 610 of the portable electronic device 200. The circular bezel 568 may attach to the body 610 of the portable device 200 (e.g., threaded fastener) and may constrain the movement of the rotating ring 651 to rotational movements only. A spring element 653 may be positioned between the rotating ring 651 and the body 610 to keep the rotating ring 651 not only centered to prevent undue motion, but may also provide the capability of snappy rotational positioning; an embodiment of this feature is further illustrated in FIG. 46 where the components of the rotating ring feature 651 such as the inside teeth 652 of the rotary ring 651, spring element 653 and the body 610 of the portable electronic device 200 are shown. In one such embodiment, the body of the spring element 653 may be rotationally constrained with an extruding feature 656 of the body 610 of the portable electronic device 200. When the rotating ring 651 is rotated by the user, the head 655 of the spring 654 of the spring element 653 may engage with the teeth 652 of the rotating ring 651 to facilitate movement of the ring from one tooth at a time, thus facilitating snappy motion of the ring 651 when rotating it. The angle of the rotational jumps as well as the stiffness of rotating ring 651 can be controlled by appropriate design of the stiffness of the spring 654 as well as the shape of the inside teeth 653 of the rotating ring 651. A rotation of the rotating ring 651 by the user can serve various functionalities, including one or more of the following: (i) increasing volume of speakers, (ii) scroll between different functionalities of the portable electronic device 200 (e.g., switch from music to walkie-talkie), or (iii) change a setting inside a specific functionality (for example, when in walkie-talkie mode the user can switch the group they want to communicate with). In terms of the side buttons 104 (and top buttons 100), the buttons may be reprogrammed to execute a predetermined functionality as set by the user using the input reassignment or programming. By way of example, in such embodiments one user may assign the top left button to control the location sharing functionality, while another user may assign the same button to control their action camera.

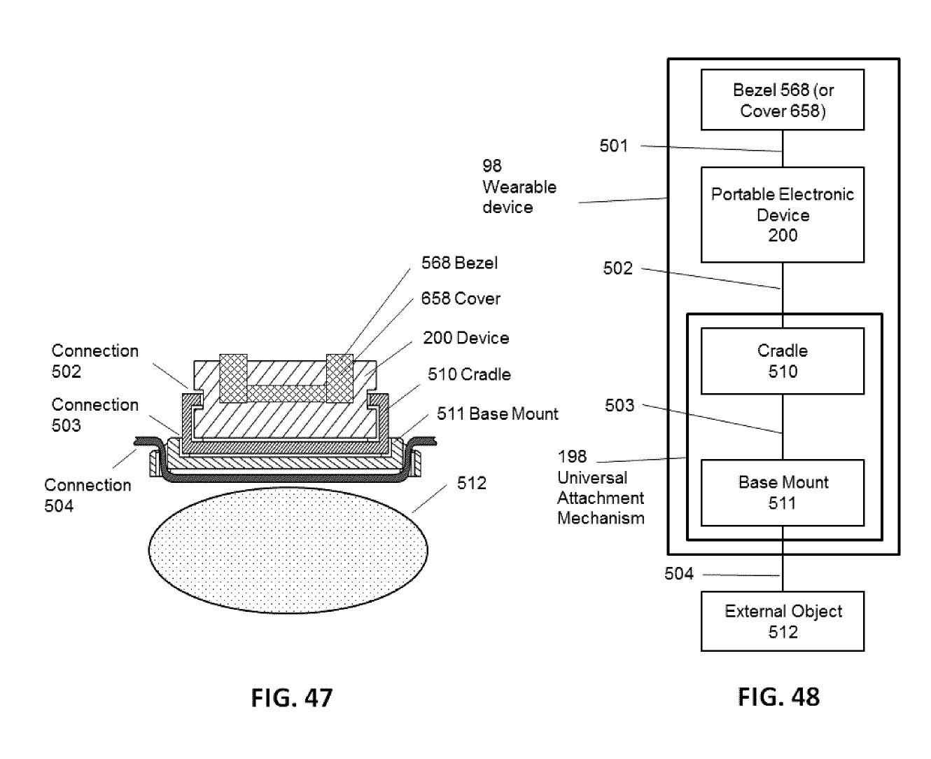

In various embodiments, the portable electronic device 200 can use a different mechanism for universal attachment mechanism 198. FIG. 47 illustrates the various objects that may or may not be attached or connected to the portable electronic device 200; these objects may or may not include one or more of the following: portable electronic device 200, top cover 658, bezel 568, cradle 510, base mount 511, and the connections (501, 502, 503 and 504) between them. FIG. 48 is a schematic diagram of the attachments connected to the portable electronic device 200 as shown in FIG. 47. In various embodiments, the connections 501, 502, 503 and 504 connect two attachments together and can be permanent or temporary. In various embodiments, the connections 501, 502, 503 and 504 may or may not be required to form one or more of the following: wearable device 98, portable electronic device 200, or universal attachment mechanism 198. In various embodiments, the connections 501, 502, 503 and 504 may be one or more of the following: mechanical interlock, friction-based lock, fasteners, adhesives, stitches, snap-fits, clamps, welding (ultrasonic), soldering, hook and loop fasteners, or detachable straps (as in connection 504). In various embodiments two or more attachments may be combined into a single attachment, similar to the universal attachment mechanism 198 described that may be a combination of the cradle 510 and base mount 511. The external object 512 may be the user's glove (similar to FIG. 2), handle bar of mountain bike, a wall, another attachment mechanism not described herein, or any object that the portable electronic device 200 may be attached to. By way of example, in one embodiment, the portable electronic device 200 and various attachments (548, 658, 510 and 511) and connections (501, 502, 503 and 504) may be integrated directly in to a user's glove. By way of example, the embodiment shown in FIG. 2 may be in described as follows: there is no bezel 568 or cover 658 present; the portable electronic device 200 is combined with the cradle 510 and base mount 511 that forms the universal attachment fitting 120; and the external object is the user's glove 108 using connection 504 that is the strap 102.

Some exemplary embodiments of the attachments and connections are provided below.

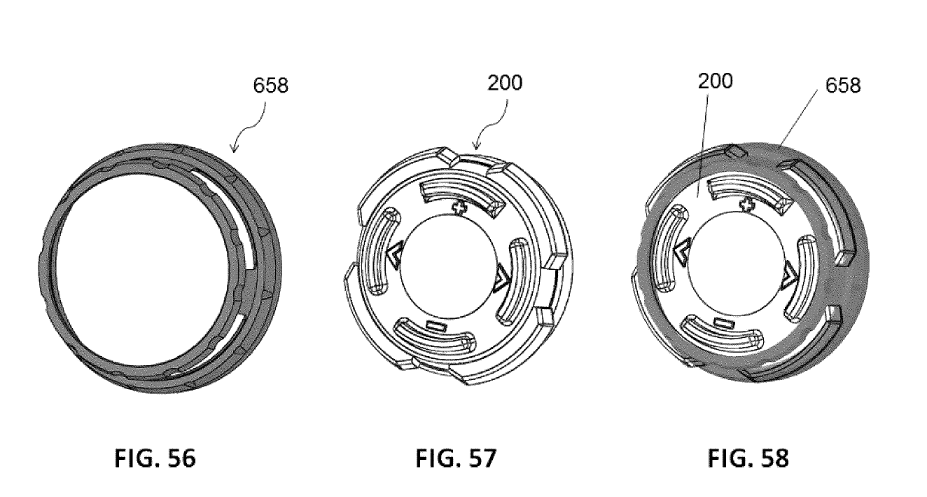

FIGS. 56, 57 and 58 show an exemplary embodiment of the cover 658 that is ruggedized to provide additional protection against damage of the portable electronic device 200. The protection may be against, mechanical damage (scratches, vibrations and shocks), water damage (if the cover is sealed) and cold or extremely cold temperatures. In one such embodiment the cover can be made of elastic or foam-based polymer such that it can absorb mechanical shocks. In one embodiment, the cover 568 may be inserted over the top of the portable electronic device 200 and may remain in place by combination of mechanical interlock and friction; the side buttons of the device 200 may pass through the side holes of the cover 658, thereby locking the cover 658 into place. In various embodiments, the cover may be undersized such that it may be stretched when applied over the top of the device 200.

In various embodiments of the top cover, may be a bezel 568 that can be replaced by the user with another bezel 568 that is customized for them (e.g. shape, color or material). The bezel 568 may be connected directly to the portable electronic device 200 using threaded fasteners.

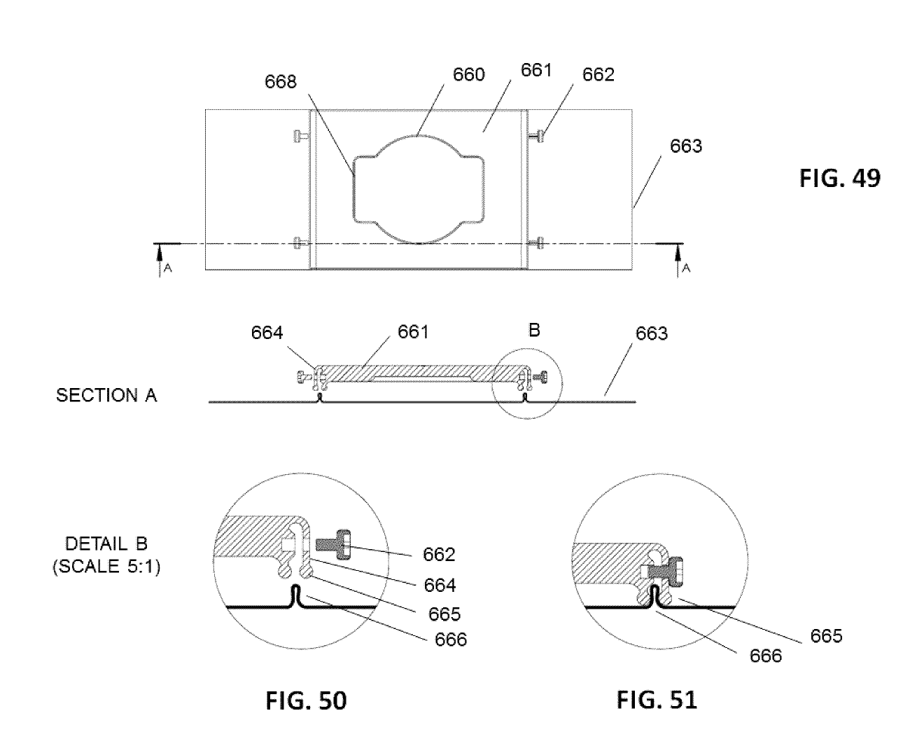

In various embodiments of the connection 504 between the base mount 511 and external object 512 (in this case a garment), one embodiment may be as shown in FIG. 49. This figure shows a top view and corresponding cross-sectional view of the rotational interlock base 661 and a piece of garment 663 (e.g., glove). As shown in the detailed view in FIG. 50, the rotational interlock base 661 comprises of two elongated clamps 664 with friction grips 665 shaped such that they can be detachably attach to folded wrinkles 666 of garment. To make use of this attachment, the user may first intentionally make a wrinkle 666 in desired piece of fabric, may then position the fiction grips 665 onto the wrinkle 666 while the clamps are open as shown in FIG. 50; subsequently, the user may close the clamps shown in FIG. 51 and may apply the threaded fasteners 662 with sufficient torque to ensure adequate grip between the garment 663 and base mount 511.

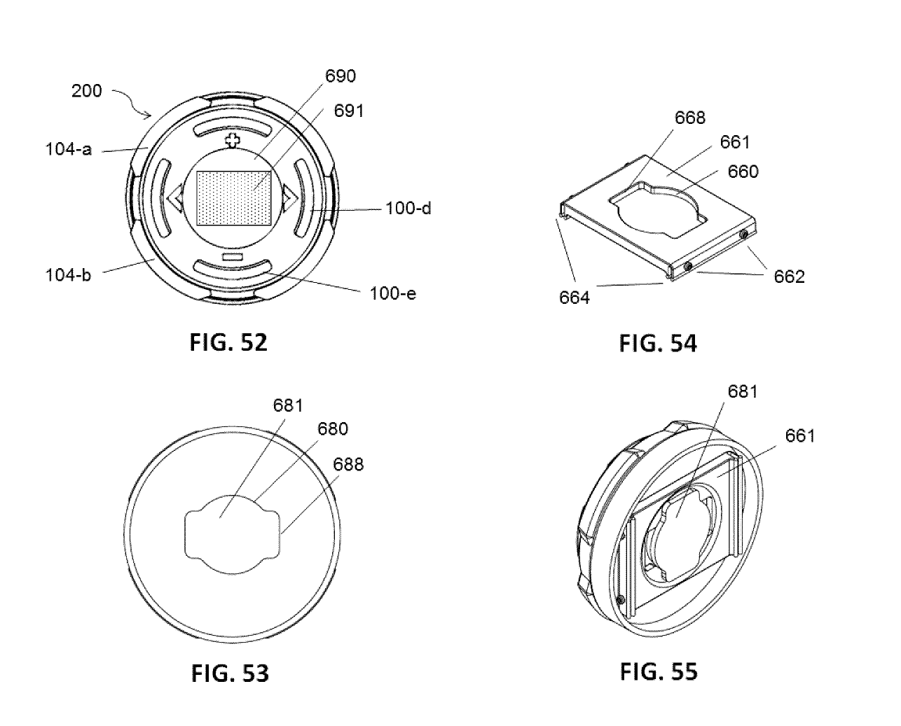

In various embodiments of mechanical interlock connection (connection 503) between the cradle 510 and base mount 511, one embodiment may be as illustrated in FIGS. 52, 53, 54, and 55. FIG. 52 shows a top perspective view of an alternative embodiment of the portable electronic device 200 which may comprise of aforementioned components (top buttons 100(a-e), side buttons 104(a-d), and the like) except with the addition of a front display 691 and a touch sensitive pad 690 in the center of the portable electronic device 200. The bottom of the portable electronic device 200, as shown in FIG. 53, may have an extruding shape for rotational interlocking 681, that comprises of a combination of a generally circular 680 and generally rectangular 688 shapes. The component may fit inside the cavity feature of the rotational interlock base 661 that may have similar (but oversized) generally circular 660 and generally rectangular 668 shapes, as shown in FIG. 54. To use the attachment, the user may center the circular feature of the portable electronic device 200 with the rotational interlock base 661, and may then align the rectangular features 668 and 688. Once the portable electronic device 200 is inserted in the cavity of rotational interlock base 661, the portable electronic device 200 may then be rotated into a lock position as shown in FIG. 55. This procedure may be reversed to detach the portable electronic device 200 from the rotational interlock base 661, where a twist and lift operation by the user may release the portable electronic device 200.

In various embodiment of the attachment, the base mount 511 with universal attachment fitting 120 can use a magnetic coupling or clamping mechanism to detachably couple to mounting adaptor 184.

In various embodiments of connection 504, the diversity and embodiment of the mounting adaptors 184 may not limited to the previously described flat surface mounting adaptor 144 (FIG. 8), cylindrical surface mounting adaptor 184 or elastic strap 102 adaptor. A variety of mounting adaptors 184 facilitates the portable electronic device 200 to be detachably coupled or connected to any object. By way of example, in one embodiment the mounting adaptor 184 can include a carabineer for attachment to a backpack or ice climbing harness. In another exemplary embodiment, the mounting adaptor 184 can include a suction cup for attachment to shower tile, object with a smooth surface, or the windshield of a snowmobile. In yet another exemplary embodiment the cylindrical surface mounting adaptor 184 can incorporate other clamping mechanisms such as one or more of the following: a quick-release clamp, spring clamp, snap-grip clamp, worm-drive clamp, u-bolt clamp, bolt clamp, or alike. In yet another exemplary embodiment the flat surface mounting adaptor can include a number of holes so that it can be stitched to garment. In various embodiments, a mounting adaptor may be designed to be permanently attached to an object. For example, in such embodiments the mounting adaptor can be designed to permanently attach to the back of glove while still proving a mechanism for detachably couple or connect to the portable electronic device 200. Moreover, in various embodiments the elastic strap 102 adaptor can be detachably coupled or connected to the portable electronic device 200 by various other known mechanisms. In various embodiments the portable electronic device 200 may include a cam buckle, snap-in or pin lock mechanism to detachably couple or connect the strap.

In various embodiments, the battery of the portable electronic device may be configured to support a wireless charging mechanism (e.g., Qi wireless charging) to facilitate wireless charging

In various embodiments, the portable electronic device may be configured for enhanced user interaction by way of one or more of the following:

(a) Haptic
a. Buttons: in various embodiment the user may provide an input by pressing one or several buttons in one or more of the following ways: (i) short press and release, (ii) short double press and release, and (iii) long press and hold. In various embodiment the buttons may also be pressed in certain sequence to activate predetermined functionality. In various embodiment the buttons may be pressed or activated at generally the same time, in combination, to activated predetermined functionality. In various embodiment the predetermined functionality that the buttons may activate may be reassigned (reprogrammable buttons); this may facilitate the user to specify via the portable electronic device (or their mobile device) what button may activate a predetermined functionality. In various embodiment of the buttons, the type of the buttons may not be limited to push buttons, and may facilitate user input by various physical input mechanisms including: rotary (e.g. angular encoder, rotary knob), toggle, capacitive or switch mechanisms or the like.
b. Touchscreen: in various embodiments the user may provide an input by interacting with a touch sensitive screen (touching, swiping, clicking, and the like) to activate predetermined functionality.

(b) Audio
a. Voice command: in various embodiments the wearable device may activate or control various functionality on the mobile device or wearable via voice command facilitated by a mobile device. A user may provide a voice command input by speaking into the microphone of the portable electronic device (or the microphone of their mobile connected accessory). In such embodiment the portable electronic device may support various voice commands wherein the user may articulate a command by voice mobile device will interpret. The commands can range from queries such as “what time is it?” to text message commands such as “text John Doe: Hey John, let's meet for lunch at the north peak at noon.”

(c) Movement
a. Motion gesture: in various embodiments the user may provide an input by making one or a series of motions with the portable electronic device. For example, in one such embodiment if the user swings their arm up and twists their forearm it may activate the PTT functionality.

In various embodiment of the outputs of the wearable device, the portable electronic device may be configured for enhanced user interaction by way of one or more of the following:

(a) Haptic
a. Vibration: in various embodiments the user may receive a notification in form of a vibration that may be palpable while wearing many layers of clothing and gloves.

(b) Audio
a. Speaker (or Buzzer): in various embodiments the user may receive a notification in form of an audible cue such a beep, melody or music, for example, when receiving a text message. In one such embodiments the speaker may be integrated in the portable electronic device, a user's mobile device or external wireless headphones (such as a helmet with integrated speakers). In various embodiments the speaker can also be used for the music and communication (call or PTT) functionality.
b. Voice: in various embodiments the user may receive notifications in form of an audible artificial voice (i.e., text to speech or TTS) that speaks to the user to notify them. In one exemplary embodiment the voice output may inform the user how fast they are traveling. In another exemplary embodiment the voice output read out a text message for the user. In yet another exemplary embodiment the voice output facilitate way finding (i.e. navigation) for the user.

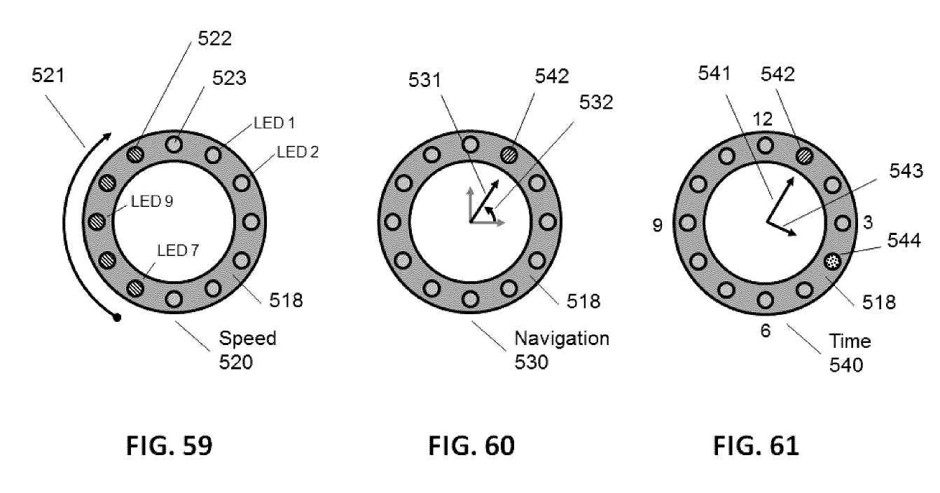

(c) Visual
a. Status light: in various embodiments the user may receive a light notification that is turned on or off in a predetermined sequence, for example, to notify the user of an incoming message. In various embodiments the light may be a multi-colored Light Emitting Diode (LED).
b. Array of lights: in various embodiments an arrangement of a number of lights (LEDs) may be used in one or more of the following ways:
   i. In one exemplary embodiment the array of lights indicates the time of the day to user. By way of example, if the lights are arranged in a circular form with 12 LEDs then by turning on only one light to show the hour, and the other blinking LED to show the minute, the user can infer the time of the day as illustrated in FIG. 61.
   ii. In another exemplary embodiment the light array may indicate the traveling speed of the user. By way of example, turning on a consecutive series of the LEDs as a function of speed, the user may infer the approximate speed they are traveling at. For example in such an embodiment, at low speeds only one LED (LED 7) may be turned on, while at 30 km/h the first three LEDs (e.g., LED 7, 8 and 9) may be turned on as illustrated in FIG. 59.
   iii. In yet another exemplary embodiment the light array guide the direction a user would need to travel to face north, or to reach a friend. By way of example, a plurality of lights arranged in a generally circular may form an array of light to facilitate (e.g., 12 LEDs) the activation of a single LED (e.g., element 542 in FIG. 60) in the direction of the predetermined target such that the user can determine which way to travel to. In such embodiment, if the target (or magnetic north) is approximately in North West, then the LED in position 10:00 or 11:00 (LED 11 or 12) would be activated (assuming numbering of a clock and 12 LEDs).
c. Display: in various embodiments the user may receive notification on graphical dot-matrix screen which facilitates display of various information. By way of example only, in various embodiment the display may show one or more of the following information to the user: text messages, active functionality, name of music title, time of the day, and the like.

In various embodiments, the portable electronic device 200 may be configured to determine and keep track of the user's location (navigation functionality). This functionality of the wearable device 98 may be controlled in an application (machine readable code) that may be executing on the user's mobile device 202 with a user interface (not shown) that provides the following options:
i) The user 194 turns on or off the navigation functionality of the wearable device 98. When this functionality is turned on, the user's three-dimensional geographical location is periodically (e.g., every second) read from the GPS module inside the user's mobile device 202. A map of the surroundings of the user may be requested from a web-based services such as Google Maps, using the user's phone connection 208 to the web (mobile data such as 3G). This map, which may or may not include information regarding paths (for example popular skiing routes), points of interest (e.g. restaurant or view points), and landmarks, may be then shown on the screen integrated in the user's mobile device 202.
ii) The user selects a target location (i.e., destination) or predetermined path on a map shown on the screen of the user's mobile device 202. The processor inside the user's mobile device 202 may then send the user's current geographical location and their destination (or desired path) to a web-based mapping service (such as Google Maps) through the wireless connection 208 of the user's mobile device 202 to the internet (remote server 209), and request suggested routes for the user to take to reach their target.

In various embodiment of the navigation functionality, the application executing on the user's mobile device 202 may the user whether they want to enable route guidance to their selected destination. If the user affirms, one or more than one of the following steps occur:
i) The processor inside the user's mobile device 202 wirelessly (e.g. Bluetooth®) sends information from the wireless module inside the user's mobile device 202 to the processing module 238 of the wearable device 98 using the wireless module 248 inside the portable electronic device 200. This information may include notification of the activation of the navigation functionality (which may instruct the processing module 238 inside the portable electronic device 200 to turn on the status light, for example) and as the navigational feedback to the user (which may instruct the processing module 238 inside the portable electronic device 200 which lights to turn on to indicate to the user the suggested direction they should take to reach their destination).
ii) The processing module inside module 238 inside the portable electronic device 200 may then request from the magnetometer 230 inside the sensors module 220 the direction the user is facing in relation to earth's magnetic poles (angular information). The processing module 238 inside the portable electronic device 200 then send the magnetometer 230 information via the wireless module 248 to the processor and wireless module inside the user's mobile device 202 (e.g. Bluetooth®). If a GPS module 224 exists inside the portable electronic device 200, this information may be wirelessly sent to the user's mobile device 202 in a similar way.
iii) The processor inside the user's mobile device 202 may then use the location (three dimensional geographical coordinates), direction (angular information with respect to the magnetic north pole) and route (the suggested path by the web-based mapping service) information to calculate the direction the user needs to face to reach their target location. Furthermore, the processor inside the user's phone 202 may use the same information to estimate the trip distance and duration (e.g., estimated time of arrival, or ETA).
iv) The processor inside the user's mobile device 202 may wirelessly transmit the aforementioned information (angle and distance) using the wireless module inside the user's mobile device 202 to the processing module 238 inside the portable electronic device 200 using the wireless module 238.
v) When the direction information is received, the processing module 238 inside the portable electronic device 200 may then instruct the corresponding light 542 (see the direction angle 532 in FIG. 60) in the user feedback module 288 to turn on.
vi) The distance information may be used by the processing module 238 inside the portable electronic device 200 to blink the lights 542 at a faster or slower rate based on the distance remaining. By way of example, in such an embodiment if the user is 500 meters away from the destination (or 500 meters from their selected track) then the light 542 turns on and off once every second; but, when the user gets closer, say 50 meters away from the destination (or 50 meters from their selected track), then the light 542 turns on an off three times per second.
vii) The information regarding the distance (or estimated time of arrival based on the current speed of the user) from target may also be provided to the user in an audio format (computer generated voice) that is generated by the processing module inside the user's mobile device 202 based on a text-to-speech computer readable code. This functionality may be activated in response to the user pressing a button (100 or 104) on the portable electronic device 200.
viii) When the user 194 reaches their destination (i.e., user location is within 10 meters of the target location), the processor inside the portable electronic device 200 will turn off the navigation functionality.

In various embodiments, the navigation capability may also provide the user 194 with the possibility to follow the same path a person or a group are traveling so they can join them. This functionality is herein referred to as friends tracking functionality. For example, in such embodiments the portable electronic device 200 may be configured to display to and inform the user which way to travel to reach their friend who is further ahead in a track who just turned left. In one such embodiment this functionality may work when there are at least two users in the following scenarios: (i) the first user is tracking the second user, and (ii) both the users are tracking each other. The following description is provided for the cases that only one of the users are following the other, but it may also valid when both users are tracking each other. This functionality of the wearable device 98 may be controlled in an application (machine readable code) that is executing on the mobile phones of both users that need to use this application (software). The application come with a user interface (not shown) that provides the following options:
i) The user 194 may provide identifying information (such as email, phone number and password) that may be stored in a remote server 209. The information is captured on the user's mobile device 202 and wirelessly sent using cellular network 208 to a remote-server using the user's phone connection to the web (mobile data such as 3G). Both users may need to perform this task for the friend-tracking functionality to work.
ii) The user may turn on or off the friend tracking functionality of the wearable device 98. When this functionality is turned on, the processor inside the mobile device 202 may periodically read (e.g., every second) the three-dimensional geographical location from the GPS module inside the user's mobile device 202. Both users need to turn on this functionality for the friend-tracking functionality to work. The processor inside the user's mobile device 202 then periodically transmits the updated geographical location of the user to the remote server 209 using cellular network 208 and the user's phone connection to the web (mobile data such as 3G).
iii) The first user may need to search for the second user based on identifying information (such as their email or phone number). When the user inputs the search query in the application on their mobile phone, the processor may send this information to the remote server 209 using the cellular network 208 and the user's phone connection to the web (mobile data such as 3G). The remote server 209 may determine whether a user with the supplied identifying information (of the second user) exists or not. If the information exists in the database, the remote server 209 may send a confirmation message to the second user using the cellular network 208 and the user's phone connection to the web (mobile data such as 3G). The second user may receive this information on their mobile phone where the processor may receive and process the confirmation request. An affirmation from the user may be processed by the processor inside the user's mobile device 202 and may be sent back to the remote server 209 using cellular network 208 and the user's phone connection to the web (mobile data such as 3G). A confirmation message may then be sent to the first user to inform them that they are now linked and that they may now track each other's location.
iii) The users can turn on the feature to track each other's location on the application executing on their mobile devices 202. When this feature is turned on the geographical location of both users may be requested by the processing unit inside the mobile device 202 of the first user. The geographical location of the first maybe read from the GPS module inside the mobile device 202 of the first user. The geographical location of the second user may be read from GPS module inside the mobile device 202 of the second user and wirelessly transmitted to the remote server 209 using cellular network 208 and the user's phone connection to the web (mobile data such as 3G), and may subsequently be wirelessly transmitted to the processing unit inside the mobile device 202 of the first user using the cellular network 208 and their phone connection to the web (mobile data such as 3G). Furthermore, the processor inside the mobile device 202 of the second user may request a map of the surroundings of the user from a web-based service such as Google Maps, using the user's phone connection to the web (mobile data such as 3G). This map is displayed to the first user and may also show the current location of the first user as well as the second user.
iv) The processor inside the mobile device 202 of the first user may then use the location of both users (three dimensional geographical coordinates) information to calculate: (i) the distance between the two users, and (ii) the direction the first user may need to face to reach second user.
v) The processor inside the mobile device 202 of the first user may wirelessly transmit the aforementioned information (angle and distance) using the wireless module inside the user's mobile device 202 to the processing module 238 inside the portable electronic device 200 using the wireless module 238.
vi) When the direction information is received, the processing module 238 inside the portable electronic device 200 may then instruct the corresponding light 542 (see the direction angle 532 in FIG. 60) in the user feedback module 288 to turn on.
vii) The distance information may be used by the processing module 238 inside the portable electronic device 200 to blink the lights 542 at a faster or slower rate based on the distance remaining. For example, in such embodiments if the user is 500 meters away from the second user then the light 542 turns on and off once every second; but, when the user gets closer, say 50 meters away from the second user, then the light 542 turns on an off three times per second.
ix) The information regarding the distance from the second user (or estimated time of arrival based on the current speed of the user) may also be provided to the user in an audio format (computer generated voice) that may be generated by the processing module inside the user's mobile device 202 based on a text-to-speech computer readable code. This functionality may be activated in response to the user pressing a button (100 or 104) on the portable electronic device 200.
x) When the first user reaches the second user (i.e., distance between two users is less than about 10 meters), the processor inside the portable electronic device 200 may turn off the friend tracking functionality.

In various embodiments, the portable electronic device 200 may be configured to facilitate RFID capability. By way of example only, the portable electronic device 200 may include an RFID tag which may facilitate access control; the user can be uniquely identified using the information transmitted to an RFID enabled gate (e.g., chairlift) that in turn opens the gate if access is granted. In various embodiments, a RFID transmitter or tag that has a unique identification key that may be integrated inside the wearable device 98; the information can be read using an RFID compatible reader when the two portable electronic devices 200 are within a close proximity of each other; the reader may send the identification key to a remote server that determines whether to grant passage to the user (i.e., whether the user paid for ticket or membership). The server 209 then communicates with the access gate to open it.

In various embodiments, the portable electronic device 200 may or may not be dependent on a mobile device 202 connection 204. The portable electronic device 200 can operate completely stand-alone in various embodiments. However, when connected to a mobile device 202 it can perform an expanded set of functionalities supported by the mobile device 202.

In various embodiments, as a stand-alone portable electronic device 200, the portable electronic device 200 may contain the components necessary for wireless communication with one or more remote servers 209, without depending on the user's mobile device 202. The wireless components may include cellular module that would facilitate communication with the cellular data network, WiFi and other wireless technologies. The stand-alone portable electronic device 200 may also contain a radio-based walkie-talkie that facilitates conventional walkie-talkie communication on dedicated frequency spectrums.

Furthermore, as a stand-alone wearable device 98, the portable electronic device 200 may include other components such as:
a) GPS module: to obtain information of position of the portable electronic device 200;
b) IMU (inertial measurement unit): to obtain information of the orientation and three dimensional linear and rotary motion of the portable electronic device 200; and
c) Headphone jack: to facilitate the user to connect their headphones directly to the wearable device 98.

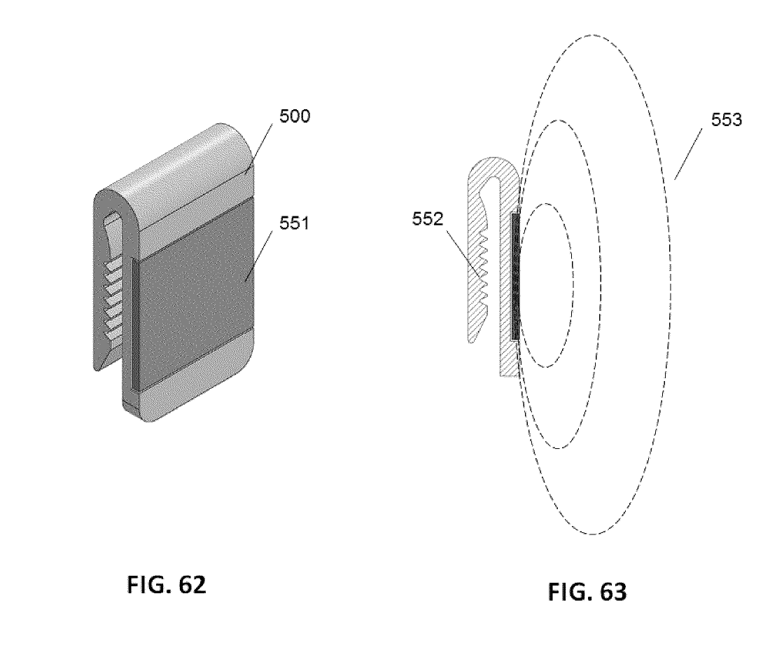

In various embodiments, the proximity actuator 216 can be detachably coupled or permanently attached to an object by methods not limited to embodiments described. It may be attached to an object via a clamp mechanism (similar to FIG. 62), a magnetic coupling mechanism, an adhesive, stitching, a hook and loop fastener or a carabineer. Furthermore, the hands-free PTT can be activated when the proximity actuator 216 moves to and is within close proximity of the portable electronic device 200. For example, in such embodiments the user may attach the proximity actuator 216 to their left glove and the portable electronic device 200 to their snowmobile. This allows the user to operate the portable electronic device 200 with their right hand and to perform hands-free PTT by bringing their left hand into close proximity of the portable electronic device 200.

In various embodiments, the functionalities of the portable electronic device 200 other than PTT can be activated using the hands-free input mechanisms. The hands-free input mechanism may be facilitated by proximity detection, gesture recognition or a combination of both; thus, the user may not need to press any buttons to activate or deactivate various functionalities. For example, in one such embodiment, the hands-free input based on gesture recognition may activate the time functionality. For example, in another embodiment the hands-free input based on gesture recognition may activate the light array of the friend-tracking functionality. In various embodiments the predetermined functionality that the hands-free input mechanism may activate may be reassigned by the user using the input reassignment or programming functionality. For example, in one embodiment, the user may choose to assign the hands-free input mechanism to either the time functionality or the friend tracking functionality.

In various embodiments there is provided a portable electronic device 200 and methods that facilitates remote access to the functionalities and software applications of a mobile device 202 such as a smartphone. The portable electronic device 200 may communicate with the mobile device 202 wireless or using a wired connection. In various embodiments the portable electronic device 200 may be wearable. In various embodiments the portable electronic device 200 may be worn over a user's clothing or outdoor clothing. In various embodiments, the portable electronic device 200 may have a plurality of accessible buttons that are spaced, sized and shaped by a predetermined amount to allow for easy and intuitive operation of the portable electronic device 200 while the user is wearing gloves 108.

In accordance with one aspect, there is provided a wearable portable electronic device comprising:
(a) a housing configured to detachably attach to an item of apparel or another object, the housing comprising one or more buttons for user interaction, the one or more buttons being shaped, sized and positioned on the housing to facilitate user interaction with the portable electronic device while the housing is attached to the item of apparel and the user is using a glove-enclosed hand to interact with and provide input via the buttons; and
(b) a processor circuit contained within the housing, the processor circuit configured to: (i) receive input from the one or more buttons and sensors; and (ii) provide predetermined functionality in response to the input received from the user, the processor circuit configured to facilitate the predetermined functionality in response to user interaction with the one or more buttons or one or more sensors.

In various embodiments, the wearable portable electronic device may operably communicate with a mobile device situated separate and apart from the wearable portable electronic device but within communications range of the wearable portable electronic device.

In various embodiments, the portable electronic device may wirelessly communicate with a mobile device in proximity and facilitate the user to remotely control predetermined functionalities on the mobile device. In various embodiments, the wireless connection may be based on one or more wireless technologies: Bluetooth®, WiFi or another wireless technology.

In various embodiments, the predetermined functionality provided by the processor circuit may comprise controlling one or more applications on the mobile device.

In various embodiments, the portable electronic device may wirelessly communicate with an external device in proximity and facilitate the user to remotely control predetermined functionalities on the external device. In various embodiments, the wireless connection may be based on one or more wireless technologies: Bluetooth®, WiFi, Cellular or another wireless technology.

In various embodiments, the predetermined functionality provided by the processor circuit may comprise controlling one or more applications on the external device.

The processor circuit may be configured to control select functionality on the mobile device or the wearable device in response to at least one of the following:
(a) user interaction with the one or more physical input devices (e.g., button, knob);
(b) motion gestures by the user (e.g. accelerometer);
(c) movement by the user (e.g., global positioning system);
(d) user interaction with the touch screen (e.g., capacitive touch pad);
(e) user interaction with the proximity sensor (e.g., magnetic sensor);
(f) user interaction with one or more sensors supported by the portable electronic device (e.g., altimeter, humidity, infrared, or microphone); and
(g) user interaction with one or more sensors supported by mobile device (e.g., accelerometer, microphone, or GPS).

In various embodiments, the wearable portable electronic device may be configured to perform predetermined functionality provided by the processor circuit controlling at least one of:
(a) call functionality on the mobile device;
(b) remote control of media functionality on the mobile device;
(c) push-to-talk over cellular communications (PTT) on the mobile device;
(d) control applications on the mobile device;
(e) navigation functionality on the mobile device;
(f) friend-tracking functionality on the mobile device;
(g) radio frequency identification (RFID) functionality on the wearable device.
(h) voice control on the mobile device;
(i) text message functionality on the mobile device;
(j) over the air software update functionality on the wearable device;
(k) programmable button functionality on the wearable device;
(l) acquire various sensor data on the wearable device or the mobile device, and transfer the data between the wearable device and mobile device facilitated by a wired or wireless connection;
(m) hands-free PTT functionality on the mobile device;
(n) time functionality on the mobile device or wearable device; and
(o) notification functionality on the wearable device.

In various embodiments there is provided a universal attachment mechanism configured to detachably couple the portable electronic device to a user's garment or winter garment, belongings or object—examples include a glove, jacket, helmet, snowboard, ski pole, or snowmobile. In various embodiments, a strap may be detachably coupled to the portable electronic device and may be handled by the user while wearing gloves and winter garments. In various embodiments, the universal attachment mechanism may be configured to facilitate the following without the need of the user to remove their glove(s) using a single hand: wear the portable electronic device, adjust the position and orientation of the portable electronic device, adjust the grip strength of the attachment, and unhook a strap portion of the universal attachment to remove the portable electronic device.

In various embodiments, the portable electronic device may be configured to detachably couple or connect to a user's current equipment or apparel eliminating the need for purchasing an item the user already owns. In such cases, as winter garments such as gloves and jackets are replaced every few years, the user would be able to re-use portable electronic device on the replacement garments.

In various embodiments, the portable electronic device may be configured by a user to detachably couple to a preferred position on winter garments, equipment, belongings or objects. This facilitates the portable electronic device to be used in different winter activities or under different environmental or activity-based conditions. In one exemplary embodiment a user that may be snowboarding may prefer to wear the portable electronic device on their glove at wrist position while another user who is snowmobiling may prefer the device to be secured on the handlebar of their snowmobile.

In various embodiments, the portable electronic device or an associated universal attachment mechanism may be shaped to form a cavity at a bottom or lower portion to contain (and rest on top of) a glove's buckle, allowing the portable electronic device to be secured onto the wrist position of the glove and be comfortable for the user wearing it.

Push-to-talk over cellular or PTT is an existing communication technology that facilitates two or more individuals to communicate with each other supported by connected devices over the wireless data network (e.g. cellular or WiFi). Currently, PTT facilitates users to communicate using their mobile devices similar to a multi-way radio with a range limited only by cellular coverage provided by a commercial cellular network or other wireless network. A typical PTT provides near instant communication for a talk group. Users can download and run commercially available PTT applications (e.g., Twisted Pair, Wave, Voxer, Talko, Zello or the like) on their mobile phone to enable their mobile phone to support PTT.

Wearing winter gloves may significantly reduce the sense of touch and the ability to press small buttons. In various embodiments, the portable electronic device may include a large user interface that features large buttons and generous spacing between the buttons to facilitate easy operation while wearing gloves. In various embodiments, this facilitates the user to more readily perform a variety of functionalities such as switching between music tracks, adjusting audio volume, performing PTT or calling a friend during an outdoor winter activity. In various embodiments, the portable electronic device may include features on a user interface or buttons to facilitate a tactile feel while wearing gloves to allow a user to generally sense where the buttons are without looking at the portable electronic device.

In various embodiments, the portable electronic device may be configured for outdoor environments including but not limited to use in the rain, snow, high-moisture or cold or extreme cold temperature conditions. In this specification temperatures below about −15 degrees Celsius are treated as extreme low temperatures about −30 degrees Celsius. In various embodiments, a housing of the portable electronic device may be partially or fully waterproof preventing water or moisture ingress such that it may operate in wet and humid environments.

In various embodiments, the portable electronic device may be configured to be rugged and highly tolerant to shock and vibration forces expected in a winter activity such as snowboarding, skiing, ice climbing and the like.

In various embodiments, the portable electronic device is configured to allow a user to have access to their mobile device functionalities while comfortably wearing their glove(s) as they are performing an outdoor winter activity. In such embodiments, the user can secure their mobile device in a safe and dry location such as a jacket Pocket while performing the previously mentioned activities and functionalities via the portable electronic device that is in communication with the mobile device.

In various embodiments, the portable electronic device may wirelessly communicate with a mobile device in proximity and facilitate the user to remotely control a push-to-talk over cellular (PTT) functionality. In various embodiments, a push-to-talk over cellular (PTT) functionality on the portable electronic device may be configured to facilitate users to communicate using their mobile devices similar to a multi-way radio with a range limited only by cellular coverage provided by a commercial cellular network or another wireless network. The portable electronic device may facilitate communication via PTT with a second individual or a group of individuals with the push of a single or plurality of accessible buttons. In various embodiments, instant or near-instant communication via PTT may be supported. This may allow users to have a casual conversation without having to remove their glove(s) thus making group communication more immediate with a push of button(s), even when the user is wearing bulky gloves or other types of gloves that make conventional use of smartphones or other mobile devices difficult when such gloves are worn. In various embodiments, the portable electronic device can facilitate hands-free PTT via proximity detection, gesture recognition or a combination of both—thus, the user may not need to press any buttons to activate to deactivate PTT function. In various embodiments the portable electronic device can recognize a pre-defined gesture or set of gestures (e.g., one motion or a series of motions) to turn the PTT on, allowing a user to communicate via PTT without the need to touch or press a button. In various embodiments the portable electronic device may include a proximity detection system that activates the PTT functionality when a proximity actuator is within a predetermined range, allowing a user to communicate via PTT without the need to touch a button. This can help facilitate casual and effortless communication experience.

In various embodiments, the portable electronic device may facilitate effortless and casual communication over Push-to-talk over cellular (PTT). In various embodiment the PTT provides for a single person to reach an individual or group of individuals with a single button press; thus, the users would not need to make several phone calls to coordinate with a group. It is common for a plurality of people to perform outdoor winter activities together and communicate with one another. PTT performs a function similar to portable multi-way radios, where with the press of a button, a user can broadcast a message to a group of individuals. Various embodiments facilitate communication via PTT while a user is wearing winter gloves, promoting a generally immediate, effortless and casual conversation. Since PTT may be available via wireless data cellular network (including WiFi and other wireless technologies), users can generally communicate anywhere in the world with a data cellular connection. If the network connection is unavailable due to coverage or network failure, the messages may be stored on the portable electronic device, a remote server or user's phone and transmitted once the network connection is re-established.

In various embodiments the portable electronic device may be configured to facilitate hands-free PTT. In such cases, the portable electronic device can recognize a predetermined gesture or set of gestures that activate PTT thus allowing a user to communicate via PTT without the need to touch a button. A proximity detection system may be provided that turns the PTT on when a proximity actuator (may be situated separate from the portable electronic device and worn by the user, on the user's apparel, or on another object) is within a predetermined range (e.g., 10 cm) of the portable electronic device, allowing a user to communicate via PTT without the need to touch a button. When a user wishes to communicate via hands-free PTT, he or she can move the portable electronic device in close proximity (e.g., less than 10 cm) of the proximity actuator and start communicating by speaking into the microphone. When the user is finished communicating, he or she can turn the PTT functionality off by moving the device away from the proximity actuator (e.g., more than 10 cm). For example, in various embodiments the portable electronic device can be configured such that the PTT functionality is activated when the user positions portable electronic device close to their mouth (e.g. within a predetermined distance of a proximity actuator).

In various other embodiments, the portable electronic device may be configured to route audio through its internal microphone, its internal speaker, a mobile device's internal speaker, a mobile device's internal microphone, or mobile device audio accessories. The portable electronic device may route audio to and from any headphone, earphone, headset or speaker that is connected to the mobile device by wire or wirelessly.

In various embodiments, the portable electronic device may wirelessly communicate with a mobile device and allow a user to remotely control the mobile device's media functionality. For example, in such embodiments the user may be listening to music via headphones connected to a mobile device and utilize the portable electronic device to remotely switch tracks or adjust volume.

In various embodiments, the portable electronic device may facilitate the user to remotely perform phone functionalities such as making a call, answering a call, rejecting a call, speed-dialing or selecting and calling a phone contact.

In various other embodiments, the portable electronic device may be configured to route audio through its internal microphone, its internal speaker, a mobile device's internal speaker, a mobile device's internal microphone, or audio accessories connected to mobile device. For example, in such embodiments the user may listen to music via earphones connected to their mobile device; perform a PTT conversation via the portable electronic device's internal microphone and speaker; or have a phone call conversation utilizing the portable electronic device's internal microphone, and a speaker connected to the mobile device.

In various embodiments, the portable electronic device may be configured to detect and keep track of the user's location. In such embodiment, this information may be used to inform the user whether they are on their predetermined path. Furthermore, the portable electronic device may inform the user which way to travel to reach a predetermined target location. This functionality may depend on the global positioning system (GPS) integrated either on the user's mobile phone or inside the portable electronic device.

In various embodiments, the portable electronic device may be configured to support friend-tracking capability and may facilitate a user to follow the same path an individual or a group are traveling on. In an exemplary embodiment the portable electronic device may inform the user which way to travel to reach their friend who is further ahead on a path who just turned left. In various embodiments, the device can facilitate informing distance between two or more users.

In various embodiments, the portable electronic device may be configured to facilitate radio frequency identification (RFID) capability that facilitates convenient short-range communication between electronic devices. In one exemplary embodiment, such capability may be used for access control (e.g., opening gate). In such embodiment the user can be uniquely identified using the information transmitted to an RFID activated gate (e.g., chairlift) that may in turn open the gate if access is granted.

In one embodiment the RFID capability may be used for facilitating payment processing. In such embodiment when the user brings the portable electronic device within range of the RFID activated payment terminal, the payment information may be transmitted from the portable electronic device via RFID to the payment terminal, where payment is subsequently processed. Such embodiment may facilitate purchase of lift tickets for example without the user having to remove their gloves and reaching into their pocket.

In various embodiments, the portable electronic device may be configured to support time functionality. By way of example only, in such embodiment, the portable electronic device may display time.

In various embodiments, the portable electronic device may be configured to support voice control functionality, where it facilitates the user to activate predetermined functionalities on their mobile device (or wearable device).

In various embodiments, the portable electronic device may be configured to support control of external devices (e.g., cameras or drones). In various embodiments, the external device may be controlled (power on/off, or activate/deactivate predetermined functionality of the external device). In various embodiments, notifications form the external device may be indicated on the portable electronic device.

In various embodiments, the battery of the portable electronic device may be configured to support a wireless charging mechanism (e.g., Qi wireless charging) to facilitate wireless charging.

In various embodiments, the portable electronic device may be configured to receive and perform a system update that is known in the art as over the air (OTA) update. OTA facilitates the wearable device to update its computer-readable code (software). OTA provides the ability to modify the procedures (algorithms) and data inside the portable electronic device to be reconfigured to modify existing functionalities or add previously non-existing functionalities to the portable electronic device. The OTA functionality may be facilitated by a wired or wireless connection of the portable electronic device to a mobile phone or a computer.

In various embodiments, the portable electronic device may be configured to acquire and store data from its various sensors and subsequently transfer this data to another connected device (such as a mobile device) using a wired or wireless connection. Similarly, in various embodiments the mobile device of a user may be configured to acquire and store the data from its various sensors and subsequently transferred this data to the portable electronic device using a wired or wireless connection. The data from the portable electronic device and the secondary connected device (e.g., mobile device) may be used in various ways to facilitated predetermined functionalities.

In various embodiments the portable electronic device may be configured to facilitate hands-free PTT. This functionality facilitates the user to activate various pre-determined functionalities of the portable electronic device without having to interact with a physical button. The hands-free PTT functionality is not limited to activating or deactivating PTT and may activate or deactivate other predetermined functionality. In various embodiment of the hands-free PTT, by way of example only, the friend tracking functionality may be activated when a user performs a sequence of motions and gestures while wearing the portable electronic device on their hand. In various embodiments, the hands-free PTT may activate the PTT communication functionality when the user performs a predetermined gesture or proximity (e.g., brings the portable electronic device within proximity of their face).

In various embodiments, the portable electronic device may be configured to support a display capability, touch screen or graphical user interface to allow a user to view information and to interact with the portable electronic device or with the mobile device via the portable electronic device. In various embodiments, the portable electronic device may be configured to display information such as activity performance metrics, local weather condition, snow report, ski lift status, missed calls, battery status, or text messages.

In various embodiments, the portable electronic device may be configured to function as a stand-alone device. In such embodiments, the portable electronic device may support wireless communication to a cellular network or with one or more remote servers, without depending on a mobile device. In such embodiments the portable electronic device may provide at least one of the following functionalities:
(a) call functionality on the wearable device;
(b) carrying out various applications on the wearable device including music player functionality;
(c) notification functionality on the wearable device;
(d) text message functionality on the wearable device;
(e) push to talk over cellular (PTT) functionality on the wearable device;
(f) friend tracking functionality on the wearable device;
(g) navigation functionality on the wearable device;
(h) acquiring various sensor data on the wearable device and optionally storing this data in memory;
(i) over the air software update functionality on the wearable device;
(j) programmable button functionality on the wearable device;
(k) send and receive data from a remote server facilitated by a wireless connection;
(l) time functionality on wearable device;
(m) hands-free PTT functionality on the wearable device;
(n) notification functionality on the wearable device; and
(o) radio frequency identification (RFID) functionality on the wearable device.

More generally, the portable electronic device may include and execute its own stand-alone computer-readable codes or applications and need not be dependent on a mobile device. In various embodiments the stand-alone portable electronic device may be configured to perform any of the aforementioned pre-determined functionalities supported by the embodiment of the portable electronic device that depended on a mobile device, without a mobile device. In various embodiments, the stand-alone portable electronic device may contain all the components necessary to perform the predetermined functionalities, including but not limited to wireless connection to the cellular network (or other wireless networks)., to facilitated connectivity to a remote server.

In various embodiments, the portable electronic device may be configured to function as a stand-alone device and may support an expanded set of functionality when connected to a mobile device. In such embodiments, the wearable device may provide one or more of the aforementioned functionality mentioned in the various embodiments.

In various embodiments, a stand-alone portable electronic device may be configured to acquire and store data from its various sensors and subsequently transfer this data to another connected device (such as a mobile device) using a wired or wireless connection when in proximity.

In various embodiments, a stand-alone portable electronic device may be configured to send and receive data to a remote server facilitated by a wireless connection. The wireless connection may be a cellular network or another wireless network such as WiFi.

Although specific embodiments have been described and illustrated, such embodiments should be considered illustrative only and not as limiting the invention as construed according to the accompanying claims.

1. A wearable portable electronic device comprising:
(a) a housing configured to detachably attach to an item of apparel or another object, the housing comprising one or more buttons for user interaction, the one or more buttons being shaped, sized and positioned on the housing to facilitate user interaction with the wearable portable electronic device while the housing is attached to the item of apparel or other object and the user is using a glove-enclosed hand to interact with and provide input via the one or more buttons; and
(b) a processor circuit contained within the housing, the processor circuit configured to: (i) receive input from the one or more buttons and sensors; and (ii) provide predetermined functionality in response to the input received from the user, the processor circuit configured to facilitate the predetermined functionality in response to user interaction with the one or more buttons or one or more sensors.

2. The wearable portable electronic device according to claim 1, wherein the wearable portable electronic device is configured to facilitate push-to-talk over cellular communications (PTT) via the wearable portable electronic device in response to activation of at least a portion of the predetermined functionality by the user via interaction with the one or more buttons.

3. The wearable portable electronic device according to claim 1, wherein the predetermined functionality provided by the processor circuit further comprises controlling at least one of:
(a) call functionality on the mobile device;
(b) remote control of media functionality on the mobile device;
(c) push-to-talk over cellular communications (PTT) on the mobile device;
(d) control applications on the mobile device;
(e) navigation functionality on the mobile device;
(f) friend-tracking functionality on the mobile device;
(g) radio frequency identification (RFID) functionality on the wearable device.
(h) voice control on the mobile device;
(i) text message functionality on the mobile device;
(j) over the air software update functionality on the wearable device;
(k) programmable button functionality on the wearable device;
(l) acquire various sensor data on the wearable device or the mobile device, and transfer the data between the wearable device and mobile device facilitated by a wireless connection;
(m) hands-free PTT functionality;
(n) time functionality on the mobile device or wearable device; and
(o) notification functionality on the wearable device.

4. The wearable portable electronic device according to claim 1, comprising a fastener mechanism configured to fasten and unfasten the housing to and from the item of apparel or other object.

5. The wearable portable electronic device according to claim 1, wherein the wearable portable electronic device is configured to display one or more notifications in response to user interaction with the one or more buttons.

6. The wearable portable electronic device according to claim 1, wherein the wearable portable electronic device operably communicates with a mobile device situated separate and apart from the wearable portable electronic device but within communications range of the wearable portable electronic device.

7. The wearable portable electronic device according to claim 5, wherein the processor circuit is configured to control select functionality on the mobile device in response to user interaction with the one or more buttons.

8. The wearable portable electronic device according to claim 6, wherein the predetermined functionality provided by the processor circuit further comprises controlling one or more applications on the mobile device.

9. The wearable portable electronic device according to claim 6, wherein the predetermined functionality provided by the processor circuit further comprises controlling at least one of:
(a) call functionality on the mobile device; and
(b) remote control of media functionality on the mobile device.

10. The wearable portable electronic device according to claim 7, wherein the wearable portable electronic device is configured to display a notification in response to user control of the select functionality on the mobile device via interaction with the one or more buttons on the wearable portable electronic device.

11. The wearable portable electronic device according to claim 7, further comprising a display and wherein the wearable portable electronic device is configured to display information on the display that is retrieved from the mobile device in response to user control of the select functionality on the mobile device via interaction with the one or more buttons on the wearable portable electronic device.

12. The wearable portable electronic device according to claim 1, wherein the housing comprises a top exterior circular edge and an exterior top face, which together provide a large user-interface area with a clearly tangible edge to allow the wearable portable electronic device to be readily operated by the user via the gloved-enclosed hand.

13. The wearable portable electronic device according to claim 1, further comprising a sealing ring and an elastic member, wherein the sealing ring and the elastic member are configured and connected to the housing to prevent water ingress into the wearable portable electronic device.

14. The wearable portable electronic device according to claim 1, further comprising a base with universal attachment fitting connected to a lower portion of the housing, the base with universal attachment fitting configured to detachably attach to the item of apparel or other object.

15. The wearable portable electronic device according to claim 13, wherein the base with universal attachment fitting comprises an arched bottom surface shaped and sized to allow the wearable portable electronic device to be securely and comfortably seated on a curved surface of the item of apparel or other object.

16. The wearable portable electronic device according to claim 13, wherein the base with universal attachment fitting comprises an arched bottom surface shaped and sized to allow the wearable portable electronic device to be securely and comfortably seated on a curved surface of a glove generally at wrist position.

17. The wearable portable electronic device according to claim 14, further comprising a mounting adaptor configured to detachably couple to the wearable portable electronic device via a snap fit feature, the mounting adaptor having a curved surface adapted to mate with the corresponding curvature of the arched bottom surface, the snap fit feature adapted to hook the base with universal attachment fitting to the housing.

18. The wearable portable electronic device according to claim 1, wherein the housing further comprises a bottom cavity shaped and sized to partially or fully contain a buckle when sitting on a glove generally at wrist position.

19. The wearable portable electronic device according to claim 1, wherein the one or more buttons comprise:
(a) a first button configured to toggle the power of the wearable portable electronic device on and off;
(b) a second button configured to pick up an incoming call received by the wearable portable electronic device in response to one mode of user input with the second button and configured to reject or decline the call in response to a second mode of user input with the second button; and
(c) a third button configured to turn on and off push-to-talk over cellular communications (PTT).

20. The wearable portable electronic device according to claim 5, wherein the one or more buttons comprise:
(a) a first button configured to toggle the power of the wearable portable electronic device on and off;
(b) a second button configured to pick up an incoming call received by the wearable portable electronic device via the mobile device in response to one mode of user input with the second button and configured to reject or decline the call in response to a second mode of user input with the second button;
(c) a third button configured to turn on and off push-to-talk over cellular communications (PTT);
(d) a fourth button configured to cause a music track to be selected and played from the mobile device;
(e) a fifth button configured to cause the music track to be paused, rewound or fast forward, and to cause another music track to be played from the mobile device; and
(f) a sixth button configured to cause a mute mode to be activated.

21. (canceled)

22. (canceled)

23. (canceled)

24. (canceled)
